(19) United States
(12) Patent Application Publication
(10) Pub. No.: US 2025/0270130 A1
(43) Pub. Date: Aug. 28, 2025

(54) ION-EXCHANGEABLE GLASS-BASED ARTICLES AND METHODS OF MAKING THE SAME

(71) Applicant: CORNING INCORPORATED, CORNING, NY (US)

(72) Inventor: Peter Joseph Lezzi, Corning, NY (US)

(21) Appl. No.: 19/058,379

(22) Filed: Feb. 20, 2025

Related U.S. Application Data
(60) Provisional application No. 63/710,125, filed on Oct. 22, 2024.
(60) Provisional application No. 63/648,360, filed on May 16, 2024.
(60) Provisional application No. 63/558,736, filed on Feb. 28, 2024.

(51) Int. Cl. C03C 3/087; C03C 3/091; C03C 3/097; C03C 21/00; H05K 5/03

(52) U.S. Cl. CPC C03C 3/087; C03C 3/091; C03C 3/097; H05K 5/03; C03C 21/002

(57) ABSTRACT

A glass-based article can have a glass composition including from 60 mol % to 65 mol % SiO₂, from 13.5 mol % to 19 mol % Al₂O₃, from 0 mol % to 3.1 mol % Li₂O, from 14 mol % to 18.5 mol % Na₂O, from 2.0 mol % to 5.0 mol % MgO, and from 0 mol % to 0.5 mol % CaO. A glass-based article can have an elastic modulus of 80 GPa or less and a first compressive stress region extending to a first depth of compressive from a first major surface, where the first compressive stress region comprising a first maximum compressive stress of 800 MegaPascals or more and a CS/E ratio of the first maximum compressive stress (in MegaPascals) to the elastic modulus (in GigaPascals) is 16.0 or more.

This application claims the benefit of priority under 35 U.S.C. § 119 of U.S. Provisional Application Ser. No. 63/710,125, filed on Oct. 22, 2024, U.S. Provisional Application Ser. No. 63/648,360, filed on May 16, 2024, and U.S. Provisional Application Ser. No. 63/558,736, filed on Feb. 28, 2024, the content of all of which is relied upon and incorporated herein by reference in its entirety.

### BACKGROUND

### Field

The present specification generally relates to glass-based articles suitable for use as a cover glass for electronic devices and methods of making the same, and more specifically, the present specification is directed to ion-exchangeable glass-based articles that may be formed into cover glass for electronic devices and methods of making the same.

### Technical Background

The mobile nature of portable devices, such as smart phones, tablets, portable media players, personal computers, and cameras, makes these devices particularly vulnerable to accidental dropping on hard surfaces, such as the ground. These devices typically incorporate cover glasses, which may become damaged upon impact with hard surfaces. In many of these devices, the cover glasses function as display covers, and may incorporate touch functionality, such that use of the devices is negatively impacted when the cover glasses are damaged.

There are two major failure modes of cover glass when the associated portable device is dropped on a hard surface. One of the modes is flexure failure, which is caused by bending of the glass when the device is subjected to dynamic load from impact with the hard surface. The other mode is sharp contact failure, which is caused by introduction of damage to the glass surface. Impact of the glass with rough hard surfaces, such as asphalt, granite, etc., can result in sharp indentations in the glass surface. These indentations become failure sites in the glass surface from which cracks may develop and propagate.

It is also desirable that portable devices be as thin as possible. Accordingly, in addition to strength, it is also desired that glasses used as a cover glass in portable devices be made as thin as possible. Thus, in addition to increasing the strength of the cover glass, it is also desirable for the glass to have mechanical characteristics that allow it to be formed by processes that are capable of making thin glass-based articles, such as thin glass sheets.

Accordingly, a need exists for glasses that can be strengthened, such as by ion exchange, and that have the mechanical properties that allow them to be formed foldable, for example, as thin glass-based articles.

### SUMMARY

There are set forth herein alkali aluminosilicate glasses with good ion exchangeability, good glass quality, and good foldability. Chemical strengthening processes can be used to achieve high strength and high toughness properties in sodium aluminosilicate glasses. By chemical strengthening in a molten salt bath (e.g., KNO₃), glasses with high strength, high toughness, and high indentation cracking resistance can be achieved. The stress profiles achieved through chemical strengthening may have a variety of shapes that increase the drop performance, strength, toughness, and other attributes of the glass-based articles. The compositions disclosed herein are capable of achieving a high maximum compressive stress (e.g., greater than or equal to 800 MPa, from 1,100 MPa to 1,600 MPa, or from 1,300 MPa to less than or equal to 1,450) that can enable foldability, good impact resistance, and/or puncture resistance. Also, the compositions of the present disclosure can provide deeper depth of layer (e.g., DOL_{SP}) than would otherwise be achievable for the same treatment.

The glass-based compositions and/or glass-based articles of the present disclosure can provide improved foldability. Without wishing to be bound by theory, fracture toughness (e.g., caused by a “flaw” near the surface of the glass-based article) is proportional to a glass strength of the glass-based article. The glass strength (e.g., σ_{NET}) can be approximated as a difference between a bend-induced stress (e.g., σ_{BEND} at the surface of the glass-based article) and a compressive stress (e.g., σ_{IOX} from chemically strengthening the glass-based article, the first and/or second maximum compressive stress) (i.e., σ_{NET}≈σ_{BEND}−σ_{IOX}). During bending, the stress on the glass-based article is proportional to a product of the elastic modulus (E). The inventor of the present disclosure has determined that a these expressions can be combined to state the glass strength as σ_{BEND}≈E[Z-CS/E], where Z is a constant for a predetermined bend (e.g., folding) to a predetermined parallel plate distance for a glass-based article having a predetermined thickness. As shown in FIG. 10, there is a linear relationship (indicated by line 1007) between data points 1005 for more than 80 example glass-based articles with different compositions between CS/E (MPa/GPa) on the horizontal axis 1001 (e.g., x-axis) and E(Z−CS/E) on the vertical axis 1003 (e.g., y-axis). Based on this observed linear relationship (and the theoretical prediction of such relationship), the inventor of the present disclosure has unexpectedly discovered glass-based compositions for glass-based articles that are able to achieve higher CS/E ratios than have otherwise been possible. In view of the above, glass-based compositions for glass-based articles that are able to achieve higher CS/E ratios exhibit increased glass strength that can manifest as increased foldability of the glass-based article. Without wishing to be bound by theory, the bend-induced stress increases as the elastic modulus increases for a predetermined strain (e.g., bend or folded configuration), the compressive stress at least offsets the bend-induced stress before failure, and therefore, it is the competition (e.g., ratio) of these values (i.e., CS/E) that controls foldability. Further, it is believed that it has not been possible to achieve a ratio of CS/E (in MPa/GPa) greater than 16.0; however, the inventor of the present disclosure has unexpectedly found that glass-based compositions of the present disclosure can have a ratio of CS/E (in MPa/GPa) exceeding 16.0. In view of the results in Table II, Compositions—25, 31-34, 37-45, 47-48, and 50-67 produced glass-based articles achieved a CS/E ratio of greater than or equal to 16.0 MPa/GPa. Further, as shown in FIGS. 11-12, the glass-based articles of the present disclosure can achieve lower parallel plate distances (e.g., half the effective bend radius) than known articles, and the glass-based articles of present disclosure can unexpectedly tolerate larger flaws than known articles while still achieving lower parallel plate distances (e.g., half the effective bend radius).

Some example aspects of the disclosure are described below with the understanding that any of the features of the various aspects may be used alone or in combination.

Aspect 1. A glass-based article comprising a composition comprising, based on 100 mol % of the glass-based article:
from greater than or equal to 60 mol % to less than or equal to 65 mol % SiO₂;
from greater than or equal to 13.5 mol % to less than or equal to 19 mol % Al₂O₃;
from greater than or equal to 0 mol % to 3.1 mol % Li₂O;
from greater than or equal to 14 mol % to less than or equal to 18.5 mol % Na₂O;
from greater than or equal to 2.0 mol % to less than or equal to 5.0 mol % MgO; and
from greater than or equal to 0 mol % to 0.5 mol % CaO.

Aspect 1A. A glass-based article comprising a composition comprising, based on 100 mol % of the glass-based article:
from greater than or equal to 60 mol % to less than or equal to 64 mol % SiO₂;
from greater than or equal to 13.5 mol % to less than or equal to 19 mol % Al₂O₃;
from greater than or equal to 0 mol % to 3.1 mol % Li₂O;
from greater than or equal to 14 mol % to less than or equal to 18.5 mol % Na₂O;
from greater than or equal to 2.0 mol % to less than or equal to 5.0 mol % MgO; and
from greater than or equal to 0 mol % to 0.5 mol % CaO.

Aspect 2. The glass-based article of aspect 1, further comprising from 1.0 mol % to 3.0 mol % Li₂O.

Aspect 3. The glass-based article of any one of aspects 1-2, comprising from greater than or equal to 18.0 mol % to less than or equal to 18.5 mol % Na₂O.

Aspect 4. The glass-based article of any one of aspects 1-3, wherein the composition comprises R₂O+RO—Al₂O₃>2.0 mol %, where R₂O is a total amount of Li₂O, Na₂O, K₂O, Rb₂O, and Cs₂O, and RO is a total amount of MgO, CaO, BaO, and SrO.

Aspect 5. The glass-based article of aspect 4, wherein 10 mol %≥R₂O+RO—Al₂O₃≥5.0 mol %.

Aspect 6. The glass-based article of any one of aspects 1-5, wherein the composition comprises Al₂O₃+RO≥16.0 mol %, where RO is a total amount of MgO, CaO, BaO, and SrO.

Aspect 7. The glass-based article of any one of aspects 1-6, wherein 16.5 mol %≥ Al₂O₃+RO≥22.1 mol %.

Aspect 8. The glass-based article of any one of aspects 1-7, wherein the composition comprises:
from greater than or equal to 14.0 mol % to less than or equal to 18.0 mol % Al₂O₃; and
from greater than or equal to 0 mol % to less than or equal to 0.5 mol % K₂O.

Aspect 9. The glass-based article of any one of aspects 1-8, wherein the composition comprises: from greater than or equal to 62 mol % to less than or equal to 64.5 mol % SiO₂.

Aspect 9A. The glass-based article of any one of aspects 1-8, wherein the composition comprises from greater than or equal to 62 mol % to less than or equal to 64 mol % SiO₂.

Aspect 10. The glass-based article of any one of aspects 1-9, wherein the composition comprises, and the glass-based article is substantially free of K₂O.

Aspect 11. The glass-based article of any one of aspects 1-10, wherein the composition comprises from greater than or equal to 3.9 mol % to less than or equal to 5.0 mol % MgO.

Aspect 12. The glass-based article of any one of aspects 1-11, wherein the composition comprises from greater than or equal to 17.5 mol % to less than or equal to 19.0 mol % R₂O, where R₂O is a total amount of Li₂O, Na₂O, K₂O, Rb₂O, and Cs₂O.

Aspect 13. The glass-based article of any one of aspects 1-12, wherein the composition is substantially free of BaO, SrO, ZnO, B₂O₃, and P₂O₅.

Aspect 14. The glass-based article of any one of aspects 1-13, wherein the composition further comprises from greater than or equal to 0.05 mol % to less than or equal to 0.50 mol % SnO₂, and the composition is substantially free of Fe₂O₃.

Aspect 15. The glass-based article of any one of aspects 1-14, wherein the glass-based article exhibits a liquidus phase comprising at least one of nepheline, forsterite, feldspar, or combinations thereof.

Aspect 16. The glass-based article of aspect 15, wherein a primary phase of the liquidus phase is nepheline or forsterite.

Aspect 17. The glass-based article of any one of aspects 1-16, wherein the glass-based article exhibits a liquidus viscosity from greater than or equal to 60 kiloPoise to less than or equal to 500 kiloPoise.

Aspect 18. The glass-based article of aspect 17, wherein the liquidus viscosity is from greater than or equal to 100 kiloPoise to less than or equal to 450 kiloPoise.

Aspect 19. The glass-based article of any one of aspects 1-18, further comprising:
a strain point temperature greater than or equal to 530° C. to less than or equal to 685° C.; and
a softening point temperature greater than or equal to 820° C. to less than or equal to 995° C.

Aspect 20. The glass-based article of any one of aspects 1-19, further comprising:
a first compressive stress region extending to a first depth of compressive from a first major surface, the first compressive stress region comprising a first maximum compressive stress greater than or equal to 800 MegaPascals; and
an elastic modulus less than or equal to 80 GigaPascals.

Aspect 21. The glass-based article of aspect 20, wherein a CS/E ratio of the first maximum compressive stress (in MegaPascals) to the elastic modulus (in GigaPascals) is greater than or equal to 16.0.

Aspect 22. The glass-based article of aspect 21, wherein the CS/E ratio is from 16.3 to less than or equal to 18.5.

Aspect 23. The glass-based article of any one of aspects 20-22, further comprising a first depth of layer of an alkali metal ion associated with the first compressive stress region is from greater than or equal to 20 micrometers to less than or equal to 50 micrometers.

Aspect 24. The glass-based article of any one of aspects 20-23, wherein the first maximum compressive stress is from greater than or equal to 1100 MegaPascals to less than or equal to 1600 MegaPascals.

Aspect 25. The glass-based article of aspect 24, wherein the first maximum compressive stress is from greater than or equal to 1300 MegaPascals to less than or equal to 1450 MegaPascals.

Aspect 26. The glass-based article of any one of aspects 20-25, wherein the elastic modulus is from greater than or equal to 72.0 GigaPascals to 74.0 GigaPascals.

Aspect 27. The glass-based article of any one of aspects 20-26, wherein the glass-based article is substantially amorphous.

Aspect 28. A consumer electronic product, comprising:
a housing comprising a front surface, a back surface, and a side surface;
electrical components at least partially within the housing, the electrical components comprising a controller, a memory, and a display, the display at or adjacent the front surface of the housing; and
a cover substrate disposed over the display,
wherein at least one of a portion of the housing comprises the substrate produced by the method of any one of aspects 1-27.

Aspect 29. A glass-based article comprising:
a first compressive stress region extending to a first depth of compressive from a first major surface, the first compressive stress region comprising a first maximum compressive stress greater than or equal to 800 MegaPascals; and
an elastic modulus less than or equal to 80 GigaPascals,
wherein a CS/E ratio of the first maximum compressive stress (in MegaPascals) to the elastic modulus (in GigaPascals) is greater than or equal to 16.0.

Aspect 30. The glass-based article of aspect 29, further comprising a first depth of layer of an alkali metal ion associated with the first compressive stress region is from greater than or equal to 20 micrometers to less than or equal to 50 micrometers.

Aspect 31. The glass-based article of aspect 30, wherein the first maximum compressive stress is from greater than or equal to 1100 MegaPascals to less than or equal to 1600 MegaPascals.

Aspect 32. The glass-based article of aspect 31, wherein the first maximum compressive stress is from greater than or equal to 1300 MegaPascals to less than or equal to 1450 MegaPascals.

Aspect 33. The glass-based article of any one of aspects 29-32, wherein the elastic modulus is from greater than or equal to 72.0 GigaPascals to 74.0 GigaPascals.

Aspect 34. The glass-based article of any one of aspects 29-33, wherein the CS/E ratio is from 16.3 to less than or equal to 18.5.

Aspect 35. The glass-based article of any one of aspects 29-34, wherein the glass-based article exhibits a liquidus viscosity from greater than or equal to 60 kiloPoise to less than or equal to 500 kiloPoise.

Aspect 36. The glass-based article of aspect 35, wherein the liquidus viscosity is from greater than or equal to 100 kiloPoise to less than or equal to 450 kiloPoise.

Aspect 37. The glass-based article of any one of aspects 29-36, further comprising: a strain point temperature greater than or equal to 530° C. to less than or equal to 685° C.; and a softening point temperature greater than or equal to 820° C. to less than or equal to 995° C.

Aspect 38. A glass-based article of any one of aspects 26-37, comprising a composition comprising, based on 100 mol % of the glass-based article:
from greater than or equal to 60 mol % to less than or equal to 65 mol % SiO₂;
from greater than or equal to 13.5 mol % to less than or equal to 19 mol % Al₂O₃;
from greater than or equal to 0 mol % to 3.1 mol % Li₂O;
from greater than or equal to 14 mol % to less than or equal to 18.5 mol % Na₂O; and
from greater than or equal to 2.0 mol % to less than or equal to 5.0 mol % MgO.

Aspect 38A. A glass-based article of any one of aspects 26-37, comprising a composition comprising, based on 100 mol % of the glass-based article:
from greater than or equal to 60 mol % to less than or equal to 64 mol % SiO₂;
from greater than or equal to 13.5 mol % to less than or equal to 19 mol % Al₂O₃;
from greater than or equal to 0 mol % to 3.1 mol % Li₂O;
from greater than or equal to 14 mol % to less than or equal to 18.5 mol % Na₂O; and
from greater than or equal to 2.0 mol % to less than or equal to 5.0 mol % MgO.

Aspect 39. The glass-based article of aspect 38, wherein the composition further comprises from greater than or equal to 0 mol % to 0.5 mol % CaO.

Aspect 40. The glass-based article of any one of aspects 38-39, wherein the composition comprises from 1.0 mol % to 3.0 mol % Li₂O.

Aspect 41. The glass-based article of any one of aspects 38-40, wherein the composition comprises from greater than or equal to 18.0 mol % to less than or equal to 18.5 mol % Na₂O.

Aspect 42. The glass-based article of any one of aspects 38-41, wherein the composition comprises from greater than or equal to 3.9 mol % to less than or equal to 5.0 mol % MgO.

Aspect 43. The glass-based article of any one of aspects 38-42, wherein the composition comprises from greater than or equal to 17.5 mol % to less than or equal to 19.0 mol % R₂O, where R₂O is a total amount of Li₂O, Na₂O, K₂O, Rb₂O, and Cs₂O.

Aspect 44. The glass-based article of any one of aspects 38-43, wherein R₂O+RO—Al₂O₃>2.0 mol %, where R₂O is a total amount of Li₂O, Na₂O, K₂O, Rb₂O, and Cs₂O, and RO is a total amount of MgO, CaO, BaO, and SrO.

Aspect 45. The glass-based article of aspect 44, wherein 10 mol %≥R₂O+RO-Al₂O₃≥5.0 mol %.

Aspect 46. The glass-based article of any one of aspects 38-45, wherein Al₂O₃+RO≥16.0 mol %, where RO is a total amount of MgO, CaO, BaO, and SrO.

Aspect 47. The glass-based article of any one of aspects 38-46, wherein 16.5 mol %≥Al₂O₃+RO≥22.1 mol %,

Aspect 48. The glass-based article of any one of aspects 38-47, wherein the composition comprises:
from greater than or equal to 14.0 mol % to less than or equal to 18.0 mol % Al₂O₃; and
from greater than or equal to 0 mol % to less than or equal to 0.5 mol % K₂O.

Aspect 49. The glass-based article of any one of aspects 38-48, wherein the composition comprises:
from greater than or equal to 62 mol % to less than or equal to 64 mol % SiO₂.

Aspect 50. The glass-based article of any one of aspects 38-49, wherein the composition is substantially free of K₂O.

Aspect 51. The glass-based article of any one of aspects 38-50, wherein the composition is substantially free of BaO, SrO, ZnO, B₂O₃, and P₂O₅.

Aspect 52. The glass-based article of any one of aspects 38-51, wherein the composition comprises from greater than or equal to 0.05 mol % to less than or equal to 0.50 mol % SnO₂, and the composition is substantially free of Fe₂O₃.

Aspect 53. The glass-based article of any one of aspects 38-52, wherein the glass-based article exhibits a liquidus phase comprising at least one of nepheline, forsterite, feldspar, or combinations thereof.

Aspect 54. The glass-based article of aspect 53, wherein a primary phase of the liquidus phase is nepheline or forsterite.

Aspect 55. A consumer electronic product, comprising:
a housing comprising a front surface, a back surface, and a side surface;
electrical components at least partially within the housing, the electrical components comprising a controller, a memory, and a display, the display at or adjacent the front surface of the housing; and
a cover substrate disposed over the display,
wherein at least one of a portion of the housing comprises the substrate produced by the method of any one of aspects 29-54.

Aspect 56. The glass-based article of any one of aspects 1-27 or 29-54 inclusive, wherein a thickness defined between the first major surface a second major surface opposite the first major surface is from greater than or equal to 25 micrometers to less than or equal to 5 millimeters.

Aspect 57. The glass-based article of aspect 56, wherein the substrate thickness is from greater than or equal to 25 micrometers to less than or equal to 500 micrometers.

Aspect 58. The glass-based article of aspect 56, wherein the substrate thickness is from greater than or equal to 600 micrometers to less than or equal to 3 millimeters.

Aspect 59. A method of making a glass-based article comprising:
heating raw materials to form a melt;
forming the melt into a ribbon;
cooling the ribbon to form a glass-based article; and
chemically strengthening the glass-based article in a molten salt solution maintained at temperature from 350° C. to 530° C. for a period of time from greater than or equal to 30 minutes to less than or equal to 8 hours, the chemically strengthening forms a first compressive stress region extending to a first depth of compressive from a first major surface, the first compressive stress region comprising a first maximum compressive stress greater than or equal to 800 MegaPascals,
wherein the glass-based article comprises an elastic modulus less than or equal to 80 GigaPascals, and a CS/E ratio of the first maximum compressive stress (in MegaPascals) to the elastic modulus (in GigaPascals) is greater than or equal to 16.0, and
wherein a composition of the glass-based article comprises a composition, based on 100 mol % of the glass-based article:
from greater than or equal to 60 mol % to less than or equal to 65 mol % SiO₂;
from greater than or equal to 13.5 mol % to less than or equal to 19 mol % Al₂O₃;
from greater than or equal to 0 mol % to 3.1 mol % Li₂O;
from greater than or equal to 14 mol % to less than or equal to 18.5 mol % Na₂O; and
from greater than or equal to 2.0 mol % to less than or equal to 5.0 mol % MgO.

Aspect 59A. A method of making a glass-based article comprising:
heating raw materials to form a melt;
forming the melt into a ribbon;
cooling the ribbon to form a glass-based article; and
chemically strengthening the glass-based article in a molten salt solution maintained at temperature from 350° C. to 530° C. for a period of time from greater than or equal to 30 minutes to less than or equal to 8 hours, the chemically strengthening forms a first compressive stress region extending to a first depth of compressive from a first major surface, the first compressive stress region comprising a first maximum compressive stress greater than or equal to 800 MegaPascals,
wherein the glass-based article comprises an elastic modulus less than or equal to 80 GigaPascals, and a CS/E ratio of the first maximum compressive stress (in MegaPascals) to the elastic modulus (in GigaPascals) is greater than or equal to 16.0, and
wherein a composition of the glass-based article comprises a composition, based on 100 mol % of the glass-based article:
from greater than or equal to 60 mol % to less than or equal to 64 mol % SiO₂;
from greater than or equal to 13.5 mol % to less than or equal to 19 mol % Al₂O₃;
from greater than or equal to 0 mol % to 3.1 mol % Li₂O;
from greater than or equal to 14 mol % to less than or equal to 18.5 mol % Na₂O; and
from greater than or equal to 2.0 mol % to less than or equal to 5.0 mol % MgO.

Aspect 60. The method of aspect 59, further comprising annealing the glass-based article before chemically strengthening the glass-based article.

Aspect 61. The method of any one of aspects 59-60, wherein the molten salt solution is maintained at a temperature from 380° C. to 430° C. and contains at least one potassium salt.

Aspect 62. The method of any one of aspects 59-61, wherein forming the melt into a ribbon comprising rolling the melt when the melt has a viscosity from greater than or equal to 1000 Poise to less than or equal to 2000 Poise.

Aspect 63. The method of any one of aspects 59-62, further comprising a first depth of layer of an alkali metal ion associated with the first compressive stress region is from greater than or equal to 20 micrometers to less than or equal to 50 micrometers.

Aspect 64. The method of any one of aspects 59-63, wherein the first maximum compressive stress is from greater than or equal to 1100 MegaPascals to less than or equal to 1600 MegaPascals.

Aspect 65. The method of aspect 64, wherein the first maximum compressive stress is from greater than or equal to 1300 MegaPascals to less than or equal to 1450 MegaPascals.

Aspect 66. The method of any one of aspects 59-65, wherein the elastic modulus is from greater than or equal to 72.0 GigaPascals to 74.0 GigaPascals.

Aspect 67. The method of any one of aspects 59-66, wherein the CS/E ratio is from 16.3 to less than or equal to 18.5.

Aspect 68. The method of any one of aspects 59-67, wherein the glass-based article exhibits a liquidus viscosity from greater than or equal to 60 kiloPoise to less than or equal to 500 kiloPoise.

Aspect 69. The method of aspect 68, wherein the liquidus viscosity is from greater than or equal to 100 kiloPoise to less than or equal to 450 kiloPoise.

Aspect 70. The method of any one of aspects 59-69, wherein the glass-based article exhibits:
a strain point temperature greater than or equal to 530° C. to less than or equal to 685° C.; and
a softening point temperature greater than or equal to 820° C. to less than or equal to 995° C.

Aspect 71. The method of any one of aspects 59-70, wherein the composition further comprises from greater than or equal to 0 mol % to 0.5 mol % CaO.

Aspect 72. The method of any one of aspects 59-71, wherein the composition comprises from 1.0 mol % to 3.0 mol % Li₂O.

Aspect 73. The method of any one of aspects 59-72, wherein the composition comprises from greater than or equal to 18.0 mol % to less than or equal to 18.5 mol % Na₂O.

Aspect 74. The method of any one of aspects 59-73, wherein the composition comprises from greater than or equal to 3.9 mol % to less than or equal to 5.0 mol % MgO.

Aspect 75. The method of any one of aspects 59-74, wherein the composition further comprises from greater than or equal to 17.5 mol % to less than or equal to 19.0 mol % R₂O, where R₂O is a total amount of Li₂O, Na₂O, K₂O, Rb₂O, and Cs₂O.

Aspect 76. The method of any one of aspects 59-75, wherein the composition comprises R₂O+RO—Al₂O₃>2.0 mol %, where R₂O is a total amount of Li₂O, Na₂O, K₂O, Rb₂O, and Cs₂O, and RO is a total amount of MgO, CaO, BaO, and SrO.

Aspect 77. The method of aspect 76, wherein the composition comprises10 mol %≥R₂O+RO—Al₂O₃≥5.0 mol %.

Aspect 78. The method of any one of aspects 59-77, wherein the composition comprises Al₂O₃+RO≥16.0 mol %, where RO is a total amount of MgO, CaO, BaO, and SrO.

Aspect 79. The method of any one of aspects 59-78, wherein the composition comprises 16.5 mol %≥Al₂O₃+RO≥22.1 mol %,

Aspect 80. The method of any one of aspects 59-79, wherein the composition comprises:
from greater than or equal to 14.0 mol % to less than or equal to 18.0 mol % Al₂O₃; and
from greater than or equal to 0 mol % to less than or equal to 0.5 mol % K₂O.

Aspect 81. The method of any one of aspects 59-80, wherein the composition comprises:
from greater than or equal to 62 mol % to less than or equal to 64.5 mol % SiO₂.

Aspect 81A. The method of any one of aspects 59-80, wherein the composition comprises:
from greater than or equal to 62 mol % to less than or equal to 64 mol % SiO₂.

Aspect 82. The method of any one of aspects 59-81, wherein the composition is substantially free of K₂O.

Aspect 83. The method of any one of aspects 59-82, wherein the glass-based article is substantially free of BaO, SrO, ZnO, B₂O₃, and P₂O₅.

Aspect 84. The glass-based article of any one of aspects 38-51, wherein the composition comprises from greater than or equal to 0.05 mol % to less than or equal to 0.50 mol % SnO₂, and the composition is substantially free of Fe₂O₃.

Aspect 85. The method of any one of aspects 59-84, wherein the glass-based article exhibits a liquidus phase comprising at least one of nepheline, forsterite, feldspar, or combinations thereof.

Aspect 86. The method of aspect 85, wherein a primary phase of the liquidus phase is nepheline or forsterite.

Aspect 87. A glass composition comprising: SiO₂; Al₂O₃; from greater than or equal to 0 mol % to 3.1 mol % Li₂O; from greater than or equal to 14 mol % to less than or equal to 18.5 mol % Na₂O; from greater than or equal to 2.0 mol % to less than or equal to 5.0 mol % MgO; from greater than or equal to 0 mol % to 0.5 mol % CaO; from greater than or equal to 0 mol % to 2 mol % B₂O₃; from greater than or equal to 0 to 2.5 mol % P₂O₅; and a combined amount of P₂O₅ and B₂O₃ that is less than or equal to 2.5 mol %, wherein an R value of the composition is greater than or equal to 0.665, the R value being computed

$$R = \frac{( 2.003 * {SiO}_{2} ) + ( 56.649 * {Al}_{2} {O}_{3} ) + ( 22.146 * MgO ) + ( 16.751 * {Na}_{2} O )}{1143.675 + ( 5.225 * {SiO}_{2} ) + ( 17.15 * {Al}_{2} {O}_{3} ) + ( 19.375 * MgO ) + ( 26.65 * CaO ) + ( 7.425 * {K}_{2} O )} ,$$

where each component refers to a concentration in mol % of the constituent on an oxide basis.

Aspect 88. The glass composition of aspect 87, further comprising a combined amount of B₂O₃, Al₂O₃ and ZrO₂ that is greater than or equal to 10.5 mol % and less than or equal to 19 mol %.

Aspect 89. The glass composition of any of the aspects 87-88, wherein Al₂O₃ is present in an amount that is greater than or equal to 13.5 mol % and less than or equal to 19 mol %.

Aspect 90. The glass composition of any of the aspects 87-89, wherein the R value is greater than or equal to 0.71.

Aspect 91. The glass composition of aspect 90, wherein the R value is greater than or equal to 0.75 and less than or equal to 0.9.

Aspect 92. The glass composition of any of the aspects 87-91, wherein SiO₂ is present in an amount that is greater than or equal to 60 mol % and less than or equal to 65 mol %

Aspect 93. The glass composition of any of the aspects 87-92, wherein the combined amount of P₂O₅ and B₂O₃ that is less than or equal to 0.4 mol %.

Aspect 94. The glass composition of any of the aspects 87-93, wherein neither of P₂O₅ and B₂O₃ are present in an amount that is greater than or equal to 0.1 mol %.

Additional features and advantages will be set forth in the detailed description which follows, and in part will be readily apparent to those skilled in the art from that description or recognized by practicing the aspects and/or embodiments described herein, including the detailed description which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects and are incorporated into and constitute a part of this specification. The drawings illustrate the various aspects described herein, and together with the description serve to explain the principles and operations of the claimed subject matter.

### BRIEF DESCRIPTION OF THE DRAWINGS

FIG. 1 schematically depicts a cross section of a glass-based article having compressive stress regions according to aspects described and disclosed herein;

FIG. 2 is a plan view of an exemplary electronic device incorporating any of the glass-based articles disclosed herein;

FIG. 3 is a perspective view of the exemplary electronic device of FIG. 2;

FIG. 4 is a schematic perspective view of a foldable consumer electronic product;

FIG. 5 schematically illustrates example aspects of a glass forming apparatus that can be used in methods of making a glass-based article in accordance with aspects of the disclosure;

FIG. 6 illustrates a perspective cross-sectional view of the glass forming apparatus along line 6-6 of FIG. 5 in accordance with aspects of the disclosure;

FIG. 7 illustrates a schematic end view of another example glass forming apparatus that can be used in methods of making a glass-based article in accordance with aspects of the disclosure;

FIG. 8 schematically illustrates a step of ion-exchanging the glass-based substrate to form a glass-based article;

FIG. 9 schematically illustrates a step of etching the glass-based article in accordance with some aspects of the present disclosure;

FIG. 10 is a plot of a ratio of compressive stress (in MPa) to elastic modulus (in GPa) on the horizontal axis (i.e., x-axis) versus net stress at an outer surface of the glass-based article being bent on the vertical axis (i.e., y-axis);

FIG. 11 is a plot of liquidus viscosity (in kiloPoise) on the horizontal axis (i.e., x-axis) versus a ratio of compressive stress (in MPa) to elastic modulus (in GPa) on the vertical axis (i.e., y-axis);

FIG. 12 schematically illustrates a relationship between substrate thickness in micrometers on the horizontal axis (i.e., x-axis) and parallel plate distance (e.g., double an effective bend radius) in millimeters on the vertical axis (i.e., y-axis) for simulations of various glass-based articles; and

FIG. 13 schematically shows a relationship between parallel plate distance (e.g., double the effective bend radius) in millimeters on the horizontal axis (i.e., x-axis) and a flaw size in micrometers on the vertical axis (i.e., y-axis) that the glass-based article can withstand while achieving the parallel plate distance (e.g., double the effective bend radius) for simulations of various glass-based articles having a substrate thickness of 90 μm.

Throughout the disclosure, the drawings are used to emphasize certain aspects. It should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

Reference will now be made in detail to alkali aluminosilicate glasses (e.g., sodium aluminosilicate glasses) according to various aspects. Alkali aluminosilicate glasses have good ion exchangeability, and chemical strengthening processes have been used to achieve high strength and high toughness properties in alkali aluminosilicate glasses. Sodium aluminosilicate glasses are highly ion-exchangeable glasses with high glass quality. By chemical strengthening in a molten salt bath (e.g., KNO₃), glasses with high strength, high toughness, and high indentation cracking resistance can be achieved. The stress profiles achieved through chemical strengthening may have a variety of shapes that increase the drop performance, strength, toughness, and other attributes of the glass-based articles.

Therefore, alkali aluminosilicate glasses with good physical properties, chemical durability, and ion exchangeability have drawn attention for use as a cover glass. In particular, alkali-containing aluminosilicate glasses, which have higher fracture toughness (e.g., at least 0.75 MPa√m) and reasonable raw material costs, are provided herein. The glasses described herein can achieve these fracture toughness values without the inclusion of additives, such as ZrO₂, Ta₂O₅, TiO₂, HfO₂, La₂O₃, and Y₂O₃, that increase the fracture toughness but are expensive and may have limited commercial availability. In this respect, the glasses disclosed herein provide comparable or improved performance with reduced manufacturing costs. Through different ion-exchange processes, greater central tension (CT), depth of compression (DOC), and high compressive stress (CS) can be achieved.

In aspects of glass-based compositions described herein, the concentration of constituent components (e.g., SiO₂, Al₂O₃, Na₂O, and the like) are given in mole percent (mol %) on an oxide basis, unless otherwise specified. Components of the alkali aluminosilicate glass-based composition according to aspects are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits. Throughout the disclosure, the composition of glass-based articles and/or glass-based substrates refers to the composition of the formed article or substrate as determined in wt % by: X-ray fluorescence and comparison with standard samples for alumina, phosphorous, alkaline earth metals, transition metals (e.g., ZnO, TiO₂, Fe₂O₃, SnO₂), sodium oxide, and potassium oxide; an amount of B₂O₃ is measured using inductively coupled plasma (ICP) methods; an amount of lithium oxide (Li₂O) is measured using flame emission spectroscopy; and an amount of SiO₂ is taken as the balance of material (i.e., 100%-materials measured using X-ray fluorescence, ICP, and flame emission spectroscopy), and then the composition is converted from wt % to mol %, as reported herein. The composition refers to the composition of the formed article or substrate—not the raw materials added to form the glass-based article and/or glass-based substrate.

As used herein, a “glass-based substrate” refers to a glass-based piece that has not been ion exchanged. Similarly, a “glass-based article” refers to a glass-based piece that has been ion exchanged and is formed by subjecting a glass-based substrate to an ion-exchange process. A “glass-based substrate” and a “glass-based article” are defined accordingly and include glass-based substrates and glass-based articles as well as substrates and articles that are made wholly or partly of a glass-based material, such as glass-based substrates that include a surface coating. While glass-based substrates and glass-based articles may generally be referred to herein for the sake of convenience, the descriptions of glass-based substrates and glass-based articles should be understood to apply equally to glass-based substrates and glass-based articles. Likewise, the claims are not necessarily limited to either an ion-exchanged glass-based article or a glass-based substrate that has not been ion exchanged.

As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. In aspects, the glass-based material of glass-based articles in accordance with the present disclosure can be free of crystallites (e.g., completely amorphous).

In the glass-based compositions described herein, SiO₂ is the largest constituent and, as such, SiO₂ is the primary constituent of the glass network formed from the glass-based composition. Pure SiO₂ has a relatively low CTE and a high melting point. Accordingly, if the concentration of SiO₂ in the glass-based composition is too high, the formability of the glass-based composition may be diminished as higher concentrations of SiO₂ increase the difficulty of melting the glass, which, in turn, adversely impacts the formability of the composition. If the concentration of SiO₂ in the glass-based composition is too low the chemical durability of the glass-based material may be diminished, and the glass-based material may be susceptible to surface damage during post-forming treatments. In aspects, the composition comprises SiO₂ in an amount of greater than or equal to 60 mol %, greater than or equal to 60.5 mol %, greater than or equal to 61 mol % (e.g., 61.0 mol %), greater than or equal to 61.5 mol %, greater than or equal to 62 mol % (e.g., 62.0 mol %), greater than or equal to 62.5 mol %, greater than or equal to 63 mol % (e.g., 63.0 mol % or more), greater than or equal to 63.5 mol %, greater than or equal to 64 mol % (e.g., 64 mol %), less than or equal to 65 mol % (e.g., 65.0 mol % or 65.00 mol %), less than or equal to 64.5 mol %, less than or equal to 64.2 mol %, less than or equal to 64 mol % (e.g., 64.0 mol %), less than or equal to 63.5 mol %, less than or equal to 63 mol % (e.g., 63.0 mol %), less than or equal to 62.5 mol %, or less than or equal to 62 mol % (e.g., 62.0 mol %). In aspects, the composition can comprise SiO₂ in a range from greater than or equal to 60 mol % to less than or equal to 65.0 mol %, from greater than or equal to 60 mol % to less than or equal to 64.5 mol %, from greater than or equal to 60 mol % to less than or equal to 64.2 mol %, from greater than or equal to 60 mol % to less than or equal to 64 mol %, from greater than or equal to 61 mol % to less than or equal to 64 mol %, from greater than or equal to 61.5 mol % to less than or equal to 63.5 mol %, from greater than or equal to 62 mol % to less than or equal to 63.5 mol %, from greater than or equal to 62.5 mol % to less than or equal to 63 mol %, or any range or subrange therebetween. In aspects, the composition comprises SiO₂ in an amount of from greater than or equal to 60 mol % to less than or equal to 65.0 mol %, from greater than or equal to 60 mol % to less than or equal to 64.5 mol %, from greater than or equal to 60 mol % to less than or equal to 64.2 mol %, from greater than or equal to 60 mol % to less than or equal to 64.0 mol %, from greater than or equal to 61.0 mol % to less than or equal to 64.0 mol %, from greater than or equal to 61.5 mol % to than or equal to 64.0 mol %, from greater than or equal to 62.0 mol % to less than or equal to 64.0 mol %, from greater than or equal to 62.5 mol % to less than or equal to 64.0 mol %, from greater than or equal to 63.0 mol % to less than or equal to 63.5 mol %, or any range or subrange therebetween. In aspects, the comp composition comprises SiO₂ in an amount of from greater than or equal to 62.0 mol % to less than or equal to 65.0 mol %, from greater than or equal to 62.5 mol % to less than or equal to 64.5 mol %, from greater than or equal to 63.0 mol % to less than or equal to 64.5 mol %, from greater than or equal to 63.5 mol % to less than or equal to 64.2 mol %, from greater than or equal to 64.0 mol % to less than or equal to 64.2 mol %, or any range or subrange therebetween. In preferred aspects, the composition comprises SiO₂ in an amount from greater than or equal to 60 mol % to less than or equal to 64 mol %, from greater than or equal to 62.0 mol % to less than or equal to 64.0 mol %, or from greater than or equal to 62.5 mol % to less than or equal to 63.5 mol %.

The glass-based compositions include Al₂O₃. Al₂O₃ may serve as a glass network former, similar to SiO₂. Al₂O₃ may increase the viscosity of the glass-based composition due to its tetrahedral coordination in a glass melt formed from a glass-based composition, decreasing the formability of the glass-based composition when the amount of Al₂O₃ is too high. However, when the concentration of Al₂O₃ is balanced against the concentration of SiO₂ and the concentration of alkali oxides in the glass-based composition, Al₂O₃ can reduce the liquidus temperature of the glass melt, thereby enhancing the liquidus viscosity and improving the compatibility of the glass-based composition with certain forming processes. In aspects, the composition comprises Al₂O₃ in a concentration of greater than or equal to 13.5 mol %, greater than or equal to 14 mol % (e.g., 14.0 mol %), greater than or equal to 14.5 mol %, greater than or equal to 15 mol % (e.g., 15.0 mol %), greater than or equal to 15.5 mol %, greater than or equal to 16 mol % (e.g., 16.0 mol %), greater than or equal to 16.5 mol %, greater than or equal to 17 mol %, less than or equal to 19 mol % (e.g., 19.0 mol %), less than or equal to 18.5 mol %, less than or equal to 18 mol % (e.g., 18.0 mol %), less than or equal to 17.5 mol %, less than or equal to 17 mol % (e.g., 17.0 mol %), less than or equal to 16.5 mol %, less than or equal to 16 mol % (e.g., 16.0 mol %), less than or equal to 15.5 mol %, less than or equal to 15 mol % (e.g., 15.0 mol %), less than or equal to 14.5 mol %, less than or equal to 14 mol % (e.g., 14.0 mol %), or less than or equal to 13.5 mol %. In aspects, the composition can comprise an amount of Al₂O₃ in a range from greater than or equal to 13.5 mol % to less than or equal to 19 mol %, from greater than or equal to 13.5 mol % to less than or equal to 18.5 mol %, from greater than or equal to 14 mol % to less than or equal to 18 mol %, from greater than or equal to 14.5 mol % to less than or equal to 17.5 mol %, from greater than or equal to 15 mol % to less than or equal to 17 mol %, from greater than or equal to 15.5 mol % to less than or equal to 16.5 mol %, or any range or subrange therebetween. In aspects, the composition can comprise an amount of Al₂O₃ in a range from greater than or equal to 13.5 mol % to less than or equal to 19.0 mol %, from greater than or equal to 14.0 mol % to less than or equal to 18.0 mol %, from greater than or equal to 14.5 mol % to less than or equal to 18.0 mol %, from greater than or equal to 15.0 mol % to less than or equal to 17.5 mol %, from greater than or equal to 15.0 mol % to less than or equal to 17.0 mol %, from greater than or equal to 15.0 mol % to less than or equal to 16.0 mol %, or any range or subrange therebetween. In preferred aspects, the composition comprises Al₂O₃ in an amount from greater than or equal to 13.5 mol % to less than or equal to 19 mol %, from greater than or equal to 14.0 mol % to less than or equal to 18.0 mol %, or from greater than or equal to 14.5 mol % to less than or equal to 17.0 mol %.

In aspects, the glass-based compositions can optionally include Li₂O. The inclusion of Li₂O in the glass-based composition allows for better control of an ion-exchange process and further reduces the softening point of the composition, thereby increasing the manufacturability of the composition. The presence of Li₂O in the glass-based compositions also allows the formation of a stress profile with a parabolic shape. However, if the amount of Li₂O is too high (e.g., greater than 3.1 mol %), the softening point of the glass may increase undesirably, which can limit forming techniques that the glass is compatible with. Also, if the amount of Li₂O is too high (e.g., greater than 3.1 mol %), the elastic modulus can increase and that can impair foldability of the resulting glass-based article, as discussed below with reference to the CS/E (MPa/GPa) ratio. In aspects, the composition can be substantially free and/or free of Li₂O. As used herein, the term “substantially free” means that the component is not purposefully added as a component of the batch material even though the component may be present in the final glass-based composition in very small amounts as a contaminant, such as less than 0.1 mol %. Alternatively, in aspects, the composition comprises Li₂O in an amount of greater than 0.0 mol %, greater than or equal to 0.5 mol %, greater than or equal to 1.0 mol %, greater than or equal to 1.1 mol %, greater than or equal to 1.4 mol % greater than or equal to 1.7 mol %, greater than or equal to 2.0 mol %, greater than or equal to 2.3 mol %, greater than or equal to 2.6 mol %, greater than or equal to 2.9 mol %, greater than or equal to 3.0 mol %, less than or equal to 3.1 mol %, less than or equal to 3.0 mol %, less than or equal to 2.7 mol %, less than or equal to 2.4 mol %, less than or equal to 2.1 mol %, less than or equal to 1.9 mol %, less than or equal to 1.6 mol %, less than or equal to 1.2 mol %, less than or equal to 1.1 mol %, or less than or equal to 1.0 mol %. In aspects, the composition comprises an amount of Li₂O from greater than or equal to 0.0 mol % to less than or equal to 3.1 mol %, from greater than 0.0 mol % to less than or equal to 3.1 mol %, from greater than or equal to 0.5 mol % to less than or equal to 3.1 mol %, from greater than or equal to 1.0 mol % to less than or equal to 3.0 mol %, from greater than or equal to 1.1 mol % to less than or equal to 2.7 mol %, from greater than or equal to 1.4 mol % to less than or equal to 2.4 mol %, from greater than or equal to 1.7 mol % to less than or equal to 2.1 mol %, from greater than or equal to 2.0 mol % to less than or equal to 2.1 mol %, or any range or subrange therebetween. In aspects, the composition can comprise greater than or equal to 1.0 mol % Li₂O and less than or equal to 3.1 mol %, for example, in a range from greater than or equal to 1.1 mol % to less than or equal to 3.0 mol %, from greater than or equal to 1.4 mol % to less than or equal to 3.0 mol %, from greater than or equal to 1.7 mol % to less than or equal to 3.0 mol %, from greater than or equal to 2.0 mol % to less than or equal to 2.7 mol %, greater than or equal to 2.3 mol % to less than or equal to 2.4 mol %, or any range or subrange therebetween. In preferred aspects, the composition comprises Li₂O in an amount from greater than or equal to 0.0 mol % to less than or equal to 3.1 mol %, from greater than or equal to 1.0 mol % to less than or equal to 3.0 mol %, or from than or equal to 1.1 mol % to less than or equal to 2.4 mol %.

The glass-based compositions described herein include Na₂O. Na₂O may aid in the ion-exchangeability of the glass-based composition, and improve the formability, and thereby manufacturability, of the glass-based composition. However, if too much Na₂O is added to the glass-based composition, the CTE may be too low, and the melting point may be too high. In aspects, Na₂O (e.g., sodium ions) can be the primary species in an ion-exchange process with potassium (e.g., from a molten salt solution), especially when the composition is substantially free of Li₂O. In aspects, the composition comprises Na₂O in an amount of greater than or equal to 14 mol % (e.g., 14.0 mol %), greater than or equal to 14.5 mol %, greater than or equal to 15 mol % (e.g., 15.0 mol %), greater than or equal to 15.5 mol %, greater than or equal to 16 mol % (e.g., 16.0 mol %), greater than or equal to 16.5 mol %, greater than or equal to 17 mol % (e.g., 17.0 mol %), greater than or equal to 17.5 mol %, greater than or equal to 17.8 mol %, greater than or equal to 18 mol % (e.g., 18.0 mol %), greater than or equal to 18.1 mol %, greater than or equal to 18.2 mol %, greater than or equal to 18.3 mol %, greater than or equal to 18.4 mol %, less than or equal to 18.5 mol %, less than or equal to 18.4 mol %, less than or equal to 18.3 mol %, less than or equal to 18.2 mol %, less than or equal to 18.1 mol %, less than or equal to 18 mol % (e.g., 18.0 mol %), less than or equal to 17.8 mol %, less than or equal to 17.5 mol %, less than or equal to 17.0 mol %, less than or equal to 16.5 mol %, less than or equal to 16 mol %, or less than or equal to 15 mol %. In aspects, the composition comprises an amount of Na₂O in a range from greater than or equal to 14 mol % to less than or equal to 18.5 mol %, from greater than or equal to 15 mol % to less than or equal to 18.5 mol %, from greater than or equal to 16 mol % to less than or equal to 18.5 mol %, from greater than or equal to 17 mol % to less than or equal to 18.5 mol %, from greater than or equal to 17.5 mol % to less than or equal to 18.5 mol %, from greater than or equal to 17.8 mol % to less than or equal to 18.5 mol %, from greater than or equal to 18.0 mol % to less than or equal to 18.5 mol, from greater than or equal to 18.1 mol % to less than or equal to 18.4 mol %, from greater than or equal to 18.2 mol % to less than or equal to 18.3 mol %, or any range or subrange therebetween. In aspects, the composition comprises an amount of Na₂O in a range from greater than or equal to 14.5 mol % to less than or equal to 18.5 mol %, from greater than or equal to 15.5 mol % to less than or equal to 18.4 mol %, from greater than or equal to 16.5 mol % to less than or equal to 18.3 mol %, from greater than or equal to 17.0 mol % to less than or equal to 18.2 mol %, from greater than or equal to 17.5 mol % to less than or equal to 18.1 mol %, from greater than or equal to 17.8 mol % to less than or equal to 18.0 mol %, or any range or subrange therebetween. In preferred aspects, the composition comprises Na₂O in an amount from greater than or equal to 14 mol % to less than or equal to 18.5 mol % Na₂O, greater than or equal to 15.0 mol % to less than or equal to 18.0 mol %, or from greater than or equal to 18.0 mol % to less than or equal to 18.5 mol %.

In aspects, the glass-based compositions may optionally include K₂O. Including K₂O in the glass-based composition increases the potassium diffusivity in the glass-based material, enabling a deeper depth of a compressive stress spike (DOL_{SP}) to be achieved in a shorter amount of ion-exchange time. If too much K₂O is included, the compressive stress imparted during an ion-exchange process may be reduced. In aspects, the composition can be substantially free and/or free of K₂O. Alternatively, the composition can comprise K₂O in an amount of greater than or equal to 0 mol %, greater than 0.0 mol %, greater than or equal to 0.1 mol %, greater than or equal to 0.2 mol %, greater than or equal to 0.3 mol % or more, less than or equal to 0.5 mol %, less than or equal to 0.4 mol %, less than or equal to 0.3 mol %, less than or equal to 0.2 mol %, or less than or equal to 0.1 mol %. In aspects, the composition can comprise an amount of K₂O in a range from greater than or equal to 0 mol % to less than or equal to 0.5 mol %, from greater than 0.0 mol % to less than or equal to 0.5 mol %, greater than or equal to 0.1 mol % to less than or equal to 0.4 mol %, from greater than or equal to 0.2 mol % to less than or equal to 0.3 mol %, or any range or subrange therebetween. In aspects, the composition can comprise an amount of K₂O in a range from greater than or equal to 0 mol % to less than or equal to 0.5 mol %, from greater than or equal to 0.0 mol % to less than or equal to 0.4 mol %, from greater than or equal to 0.0 mol % to less than or equal to 0.3 mol %, from greater than or equal to 0.0 mol % to less than or equal to 0.2 mol %, from greater than or equal to 0.0 mol % to less than or equal to 0.1 mol %, or any range or subrange therebetween. In preferred aspects, the composition can comprise an amount of K₂O in a range from greater than or equal to 0 mol % to less than or equal to 0.5 mol %, from greater than or equal to 0.0 mol % to less than or equal to 0.2 mol %, or 0.0 mol % (e.g., substantially free of K₂O).

Throughout the disclosure, “R₂O” refers to a total amount of alkali metal oxides, meaning a total amount of Li₂O, Na₂O, K₂O, Rb₂O, and Cs₂O. Providing a high amount of R₂O can enable the formation of high compressive stress, which can improve foldability of the resulting glass-based article, as discussed below with reference to the CS/E (MPa/GPa) ratio. In aspects, the composition can comprise R₂O in an amount of greater than or equal to 15.5 mol %, greater than or equal to 16.0 mol %, greater than or equal to 16.5 mol %, greater than or equal to 17.0 mol %, greater than or equal to 17.5 mol %, greater than or equal to 17.8 mol %, greater than or equal to 18.0 mol %, greater than or equal to 18.2 mol %, greater than or equal to 18.5 mol %, less than or equal to 20.0 mol %, less than or equal to 19.5 mol %, less than or equal to 19.0 mol %, less than or equal to 18.8 mol %, less than or equal to 18.5 mol %, less than or equal to 18.3 mol %, less than or equal to 18.0 mol %, or less than or equal to 17.8 mol %. In aspects, the composition can comprise R₂O in a range from greater than or equal to 15.5 mol % to less than or equal to 20.0 mol %, greater than or equal to 16.0 mol % to less than or equal to 20.0 mol %, from greater than or equal to 16.5 mol % to less than or equal to 19.5 mol %, from greater than or equal to 17.0 mol % to less than or equal to 19.5 mol %, from greater than or equal to 17.5 mol % to less than or equal to 19.0 mol %, from greater than or equal to 17.8 mol % to less than or equal to 19.0 mol %, from greater than or equal to 18.0 mol % to less than or equal to 18.8 mol %, from greater than or equal to 18.2 mol % to 18.5 mol %, or any range or subrange therebetween. In preferred aspects, can comprise an amount of R₂O in a range from greater than or equal to 15.5 mol % to less than or equal to 20.0 mol %, from greater than or equal to 16.5 mol % to less than or equal to 19.5 mol %, or from greater than or equal to 17.5 mol % to less than or equal to 19.0 mol %.

Throughout the disclosure, “RO” refers to a total amount of alkaline earth oxides. “RO” can refer to a total amount of MgO, CaO, SrO, and BaO. In aspects, divalent cation oxides (e.g., alkaline earth oxides) can improve the melting behavior of glass-based compositions. In aspects, divalent cation oxides can improve stress relaxation. In aspects, alkaline earth oxides can charge balance tetrahedral alumina. Providing some RO (e.g., greater than or equal to 2.0 mol %) can actually facilitate the formation of high compressive stress that can increase foldability of the resulting glass-based article, as discussed below with reference to the CS/E (MPa/GPa) ratio. However, if the amount of RO is too high (e.g., greater than 5 mol %), a mobility of alkali metal ions can decrease that can impair ion-exchangability, for example, because of the relatively high field strength of alkaline earth metal ions. Also, if the amount of RO is too high, the liquidus viscosity can increase undesirably. Additionally, if the amount of RO is too high (e.g., greater than 5.0 mol %), the elastic modulus can increase and that can impair foldability of the resulting glass-based article, as discussed below with reference to the CS/E (MPa/GPa) ratio. In aspects, the composition can comprise RO in an amount of greater than or equal to 2.0 mol %, greater than or equal to 2.5 mol %, greater than or equal to 3.0 mol % or more, greater than or equal to 3.2 mol %, greater than or equal to 3.4 mol %, greater than or equal to 3.6 mol %, less than or equal to 5.0 mol %, less than or equal to 4.8 mol %, less than or equal to 4.5 mol %, less than or equal to 4.2 mol %, less than or equal to 4.0 mol %, less than or equal to 3.8 mol %, less than or equal to 3.5 mol %, less than or equal to 3.3 mol %, or less than or equal to 3.0 mol %. In aspects, the composition can comprise an amount of RO in a range from greater than or equal to 2.0 mol % to less than or equal to 5.0 mol %, from greater than or equal to 2.5 mol % to less than or equal to 5.0 mol %, from greater than or equal to 3.0 mol % to less than or equal to 5.0 mol %, from greater than or equal to 3.0 mol % to less than or equal to 4.8 mol %, from greater than or equal to 3.2 mol % to less than or equal to 4.8 mol %, from greater than or equal to 3.4 mol % to less than or equal to 4.5 mol %, from greater than or equal to 3.6 mol % to less than or equal to 4.2 mol %, from greater than or equal to 3.8 mol % to less than or equal to 4.0 mol %, or any range or subrange therebetween. In preferred aspects, the composition comprises RO in an amount from greater than or equal to 2.0 mol % to less than or equal to 5.0 mol %, from 3.0 mol % to 5.0 mol %, or from 3.2 mol % to 4.8 mol %.

The glass-based compositions described herein include MgO. MgO may lower the viscosity of a glass, which enhances the formability and manufacturability of the composition. The inclusion of MgO may also improve the strain point and the Young's modulus of the glass-based composition. However, if too much MgO is added, the liquidus viscosity may be too low for compatibility with desirable forming techniques. The addition of too much MgO may also increase the density and the CTE of the glass-based composition to undesirable levels. In aspects, the composition can comprise MgO in an amount greater than or equal to 2.0 mol %, greater than or equal to 2.5 mol %, greater than or equal to 3.0 mol %, greater than or equal to 3.2 mol %, greater than or equal to 3.5 mol %, greater than or equal to 3.7 mol %, greater than or equal to 3.9 mol %, greater than or equal to 4.2 mol %, greater than or equal to 4.5 mol %, less than or equal to 5.0 mol %, less than or equal to 4.8 mol, less than or equal to 4.6 mol %, less than or equal to 4.5 mol %, less than or equal to 4.4 mol %, less than or equal to 4.3 mol %, less than or equal to 4.2 mol %, less than or equal to 4.1 mol %, less than or equal to 4.0 mol %, less than or equal to 3.8 mol %, less than or equal to 3.6 mol %, less than or equal to 3.4 mol %, less than or equal to 3.2 mol %, or less than or equal to 3.0 mol %. In aspects, the composition can comprise an amount of MgO in a range from greater than or equal to 2.0 mol % to less than or equal to 5.0 mol %, from greater than or equal to 2.5 mol % to less than or equal to 5.0 mol %, from greater than or equal to 3.0 mol % to less than or equal to 5.0 mol %, from greater than or equal to 3.2 mol % to less than or equal to 4.8 mol %, from greater than or equal to 3.5 mol % to less than or equal to 4.6 mol %, from greater than or equal to 3.7 mol % to less than or equal to 4.4 mol %, from greater than or equal to 3.9 mol % to less than or equal to 4.2 mol %, or any range or subrange therebetween. In aspects, the composition can comprise an amount of MgO in a range from greater than or equal to 2.0 mol % to less than or equal to 5.0 mol %, from greater than or equal to 3.9 mol % to less than or equal to 5.0 mol %, from greater than or equal to 4.2 mol % to less than or equal to 4.8 mol %, from greater than or equal to 4.5 mol % to less than or equal to 4.6 mol %, or any range or subrange therebetween. In preferred aspects, the composition comprises MgO in an amount from greater than or equal to 2.0 mol % to less than or equal to 5.0 mol %, from greater than or equal to 3.9 mol % to less than or equal to 5.0 mol %, or from greater than or equal to 4.2 mol % to less than or equal to 4.8 mol %.

In aspects, the glass-based compositions described herein may include CaO. CaO may lower the viscosity of a glass, which may enhance the formability, the strain point, and the Young's modulus. However, if too much CaO is added, the density and the CTE of the glass-based composition may increase to undesirable levels and the ion exchangeability of the glass-based substrate may be undesirably impeded. The inclusion of CaO in the glass-based composition also helps to achieve the high fracture toughness values described herein. In aspects, the composition can be substantially free and/or free of CaO. Alternatively, in aspects, the composition can comprise CaO in an amount greater than or equal to 0 mol %, greater than 0.0 mol %, greater than or equal to 0.02 mol %, greater than or equal to 0.04 mol %, greater than or equal to 0.10 mol %, greater than or equal to 0.5 mol %, greater than or equal to 1 mol %, greater than or equal to 2 mol %, greater than or equal to 3 mol %, less than or equal to 5 mol %, less than or equal to 4 mol %, less than or equal to 3 mol %, less than or equal to 2 mol %, less than or equal to 1 mol %, less than or equal to 0.5 mol %, less than or equal to 0.2 mol %, less than or equal to 0.1 mol %, less than or equal to 0.08 mol %, or less than or equal to 0.05 mol %. In aspects, the composition can comprise an amount of CaO in a range from greater than or equal to 0 mol % to less than or equal to 5 mol %, from greater than or equal to 0 mol % to less than or equal to 4 mol %, from greater than or equal to 0 mol % to less than or equal to 3 mol %, from greater than or equal to 0 mol % to less than or equal to 2 mol %, from greater than or equal to 0 mol % to less than or equal to 1 mol %, from greater than 0.0 mol % to less than or equal to 0.5 mol %, from greater than or equal to 0.02 mol % to less than or equal to 0.2 mol %, from greater than or equal to 0.02 mol % to less than or equal to 0.1 mol %, from greater than or equal to 0.04 mol % to less than or equal to 0.08 mol %, from greater than or equal to 0.04 mol % to less than or equal to 0.05 mol %, or any range or subrange therebetween. In preferred aspects, the composition comprises CaO in an amount from greater than or equal to 0 mol % to less than or equal to 5 mol % or from greater than 0.0 mol % to less than or equal to 0.5 mol, or from greater than or equal to 0.02 mol % to less than or equal to 0.08 mol %.

In aspects, the glass-based composition may comprise a value of Al₂O₃+RO greater than or equal to 16.0 mol %, greater than or equal to 16.5 mol %, greater than or equal to 17.0 mol %, greater than or equal to 17.5 mol %, greater than or equal to 18.0 mol %, greater than or equal to 18.2 mol %, greater than or equal to 18.5 mol %, greater than or equal to 18.7 mol %, greater than or equal to 19.0 mol %, greater than or equal to 19.2 mol %, greater than or equal to 19.5 mol %, greater than or equal to 19.7 mol %, greater than or equal to 20.0 mol %, greater than or equal to 21.0 mol %, greater than or equal to 22.0 mol %, greater than or equal to 23.0 mol %, greater than or equal to 24.0 mol %, less than or equal to 25.0 mol %, less than or equal to 24.0 mol %, less than or equal to 23.5 mol %, less than or equal to 23.0 mol %, less than or equal to 22.5 mol %, less than or equal to 22.1 mol %, less than or equal to 21.8 mol %, less than or equal to 21.5 mol %, less than or equal to 21.3 mol %, less than or equal to 21.0 mol %, less than or equal to 20.8 mol %, less than or equal to 20.5 mol %, less than or equal to 20.3 mol %, less than or equal to 20.0 mol %, less than or equal to 19.8 mol %, less than or equal to 19.5 mol %, less than or equal to 19.3 mol %, less than or equal to 19.0 mol %, less than or equal to 18.8 mol %, less than or equal to 18.5 mol %, less than or equal to 18.0 mol %, less than or equal to 17.5 mol %, or less than or equal to 17.0 mol %. In aspects, the glass-based composition may comprise a value of Al₂O₃+RO in a range from greater than or equal to 16.0 mol % to less than or equal to 25.0 mol %, from greater than or equal to 16.0 mol % to less than or equal to 24.0 mol %, from greater than or equal to 16.0 mol % to less than or equal to 23.5 mol %, from greater than or equal to 16.0 mol % to less than or equal to 23.0 mol %, from greater than or equal to 16.5 mol % to less than or equal to 22.5 mol %, from greater than or equal to 16.5 mol % to less than or equal to 22.1 mol %, from greater than or equal to 17.0 mol % to less than or equal to 21.8 mol %, from greater than or equal to 17.5 mol % to less than or equal to 21.5 mol %, from greater than or equal to 18.0 mol % to less than or equal to 21.2 mol %, from greater than or equal to 18.2 mol % to less than or equal to 21.0 mol %, from greater than or equal to 18.5 mol % to less than or equal to 20.8 mol %, from greater than or equal to 18.7 mol % to less than or equal to 20.5 mol %, from greater than or equal to 19.0 mol % to less than or equal to 20.2 mol %, from greater than or equal to 19.2 mol % to less than or equal to 20.0 mol %, from greater than or equal to 19.5 mol % to less than or equal to 19.7 mol %, or any range or subrange therebetween. In preferred aspects, the glass-based composition may comprise a value of Al₂O₃+RO in a range from greater than or equal to 16.0 mol % to less than or equal to 25.0 mol %, from greater than or equal to 16.5 mol % to less than or equal to 22.1 mol %, or from greater than or equal to 18.0 mol % to less than or equal to 21.5 mol %.

In aspects, the glass-based composition can be per-alkaline (i.e., R₂O+RO>Al₂O₃), which can improve the meltability and/or melting performance of the melted glass. In further aspects, the glass-based composition may comprise a value of R₂O+RO—Al₂O₃ greater than 2.0 mol %, greater than or equal to 2.5 mol %, greater than or equal to 3.0 mol %, greater than or equal to 3.5 mol %, greater than or equal to 4.0 mol %, from greater than or equal to 4.5 mol %, from greater than or equal to 5.0 mol %, greater than or equal to 5.5 mol %, greater than or equal to 6.0 mol %, greater than or equal to 6.2 mol %, greater than or equal to 6.5 mol %, greater than or equal to 6.7 mol %, greater than or equal to 7.0 mol %, greater than or equal to 7.2 mol %, greater than or equal to 7.5 mol %, greater than or equal to 7.7 mol %, greater than or equal to 8.0 mol %, greater than or equal to 8.5 mol %, less than or equal to 10.0 mol %, less than or equal to 9.5 mol %, less than or equal to 9.0 mol %, less than or equal to 8.8 mol %, less than or equal to 8.5 mol %, less than or equal to 8.3 mol %, less than or equal to 8.0 mol %, less than or equal to 7.8 mol %, less than or equal to 7.5 mol %, less than or equal to 7.3 mol %, less than or equal to 7.0 mol %, less than or equal to 6.8 mol %, less than or equal to 6.5 mol %, less than or equal to 6.3 mol %, less than or equal to 6.0 mol %, less than or equal to 5.5 mol %, less than or equal to 5.0 mol %, less than or equal to 4.5 mol %, less than or equal to 4.0 mol %, less than or equal to 3.5 mol %, or less than or equal to 3.0 mol %. In further aspects, the glass-based composition may comprise a value of R₂O+RO—Al₂O₃ in a range from greater than 2.0 mol % to less than or equal to 10.0 mol %, from greater than or equal to 2.5 mol % to less than or equal to 10.0 mol %, from greater than or equal to 3.0 mol % to less than or equal to 9.5 mol %, from greater than or equal to 3.5 mol % to less than or equal to 9.5 mol %, from greater than or equal to 4.0 mol % to less than or equal to 9.0 mol %, from greater than or equal to 4.5 mol % to less than or equal to 9.0 mol %, from greater than or equal to 5.0 mol % to less than or equal to 8.8 mol %, from greater than or equal to 5.5 mol % to less than or equal to 8.5 mol %, from greater than or equal to 6.0 mol % to less than or equal to 8.3 mol %, from greater than or equal to 6.2 mol % to less than or equal to 8.0 mol %, from greater than or equal to 6.5 mol % to less than or equal to 7.8 mol %, from greater than or equal to 6.7 mol % to less than or equal to 7.5 mol %, from greater than or equal to 7.0 mol % to less than or equal to 7.2 mol %, or any range or subrange therebetween. In preferred aspects, the glass-based composition may comprise a value of R₂O+RO—Al₂O₃ in a range from greater than 2.0 mol % or less than or equal to 10.0 mol %, from greater than or equal to 5.0 mol % to less than or equal to 9.0 mol %, or from greater than or equal to 6.0 mol % to less than or equal to 8.3 mol %.

As discussed above, “RO” refers to a total amount of MgO, CaO, SrO, and BaO; and “R₂O” refers to a total amount of Li₂O, Na₂O, K₂O, Rb₂O, and Cs₂O. Providing a high amount of R₂O+RO (e.g., greater than 18 mol %) can improve the meltability and/or melting performance of the melted glass. In aspects, the glass-based composition can comprise a value of R₂O+RO of greater than 18.0 mol %, greater than or equal to 18.5 mol %, greater than or equal to 19.0 mol %, greater than or equal to 19.5 mol %, greater than or equal to 19.7 mol %, from greater than or equal to 20.0 mol %, from greater than or equal to 20.2 mol %, greater than or equal to 20.5 mol %, greater than or equal to 20.7 mol %, greater than or equal to 21.0 mol %, greater than or equal to 21.2 mol %, greater than or equal to 21.5 mol %, greater than or equal to 22.0 mol %, less than or equal to 25.0 mol %, less than or equal to 24.5 mol %, less than or equal to 24.0 mol %, less than or equal to 23.5 mol %, less than or equal to 23.0 mol %, less than or equal to 22.8 mol %, less than or equal to 22.5 mol %, less than or equal to 22.2 mol %, less than or equal to 20.0 mol %, less than or equal to 19.8 mol %, less than or equal to 19.5 mol %, less than or equal to 19.2 mol %, or less than or equal to 19.0 mol %. In further aspects, the glass-based composition may comprise a value of R₂O+RO can be in a range from greater than 18.0 mol % to less than or equal to 25.0 mol %, from greater than or equal to 18.0 mol % to less than or equal to 24.5 mol %, from greater than or equal to 18.5 mol % to less than or equal to 24.0 mol %, from greater than or equal to 19.0 mol % to less than or equal to 23.5 mol %, from greater than or equal to 19.5 mol % to less than or equal to 23.0 mol %, from greater than or equal to 19.8 mol % to less than or equal to 22.8 mol %, from greater than or equal to 20.0 mol % to less than or equal to 22.5 mol %, from greater than or equal to 20.2 mol % to less than or equal to 22.2 mol %, from greater than or equal to 20.5 mol % to less than or equal to 22.0 mol %, from greater than or equal to 20.7 mol % to less than or equal to 21.8 mol %, from greater than or equal to 21.0 mol % to less than or equal to 21.5 mol %, or any range or subrange therebetween. In preferred aspects, the glass-based composition may comprise a value of R₂O+RO in a range from greater than 18.0 mol % or less than or equal to 25.0 mol %, from greater than or equal to 19.5 mol % to less than or equal to 23.0 mol %, or from greater than or equal to 20.5 mol % to less than or equal to 22.5 mol %.

In aspects, the glass-based composition can comprise a value of (R₂O+RO)/(Al₂O₃) of greater than 1.10, greater than or equal to 1.15, greater than or equal to 1.20, greater than or equal to 1.25, greater than or equal to 1.30 from greater than or equal to 1.35, from greater than or equal to 1.40, greater than or equal to 1.42, greater than or equal to 1.45, greater than or equal to 1.47 greater than or equal to 1.50, greater than or equal to 1.52, greater than or equal to 1.55, greater than or equal to 1.60, less than or equal to 1.65, less than or equal to 1.63 less than or equal to 1.60, less than or equal to 1.58 less than or equal to 1.55, less than or equal to 1.52, less than or equal to 1.50, less than or equal to 1.48, less than or equal to 1.45, less than or equal to 1.42, less than or equal to 1.40, less than or equal to 1.35, less than or equal to 1.30, less than or equal to 1.25, or less than or equal to 1.20. In further aspects, the glass-based composition may comprise a value of (R₂O+RO)/(Al₂O₃) can be in a range from greater than 1.10 to less than or equal to 1.65, from greater than or equal to 1.15 to less than or equal to 1.65, from greater than or equal to 1.20 to less than or equal to 1.63, from greater than or equal to 1.25 to less than or equal to 1.63, from greater than or equal to 1.30 to less than or equal to 1.60, from greater than or equal to 1.35 to less than or equal to 1.60, from greater than or equal to 1.40 to less than or equal to 1.57, from greater than or equal to 1.42 to less than or equal to 1.57, from greater than or equal to 1.45 to less than or equal to 1.55, from greater than or equal to 1.47 to less than or equal to 1.52, from greater than or equal to 1.50 to less than or equal to 1.52, or any range or subrange therebetween. In preferred aspects, the glass-based composition may comprise a value of (R₂O+RO)/(Al₂O₃) in a range from greater than 1.10 or less than or equal to 1.65, from greater than or equal to 1.30 to less than or equal to 1.60, or from greater than or equal to 1.40 to less than or equal to 1.57.

The glass-based compositions may optionally include one or more fining agents. In aspects, the fining agent may include, for example, SnO₂. In aspects, SnO₂ may be present in the glass-based composition in an amount less than or equal to 0.2 mol %, such as from greater than or equal to 0 mol % to less than or equal to 0.2 mol %, greater than or equal to 0 mol % to less than or equal to 0.1 mol %, greater than or equal to 0 mol % to less than or equal to 0.05 mol %, greater than or equal to 0.1 mol % to less than or equal to 0.2 mol %, and all ranges and sub-ranges between the foregoing values. In some aspects, the glass-based composition may be substantially free or free of SnO₂. In aspects, the glass-based composition may be substantially free or free of one or both of arsenic and antimony. In preferred aspects, the composition comprises SnO₂ in an amount from greater than or equal to 0 mol % to less than or equal to 0.2 mol % or from greater than or equal to 0 mol % to less than or equal to 0.1 mol %.

In aspects, the composition can be substantially free and/or free of one or more of SrO, BaO, ZnO, and/or TiO₂. In further aspects, the composition can be substantially free and/or free of all of SrO, BaO, ZnO, and TiO₂. SrO may lower the viscosity of a glass, increase the density and CTE of the glass, and impede the ion exchangability of the glass-based substrate. ZnO may lower the viscosity of a glass and increase the density and the CTE. TiO₂ can increase a susceptibility of the glass to devitrification and/or exhibiting an undesirable coloration as well as undesirably changing the liquidus. In aspects, the composition can be substantially and/or free of one or more of B₂O₃, P₂O₅, ZrO₂, and/or Fe₂O₃. For example, the composition can be substantially free and/or free of both B₂O₃ and P₂O₅. P₂O₅ may reduce a maximum compressive stress that can be developed in an ion-exchange process. B₂O₃ may reduce a maximum compressive stress that can be developed in an ion-exchange process. ZrO₂ may result in the formation of undesirable zirconia inclusions in the glass-based material, due at least in part to the low solubility of ZrO₂ in the glass-based material. In aspects, the glass-based composition may be substantially free and/or free of at least one of Ta₂O₅, HfO₂, La₂O₃, and Y₂O₃. In aspects, the glass-based composition may be substantially free or free of Ta₂O₅, HfO₂, La₂O₃, and Y₂O₃. While these components may increase the fracture toughness of the glass-based when included, there are cost and supply constraints that make using these components undesirable for commercial purposes. Stated differently, the ability of the glass-based compositions described herein to achieve high fracture toughness values within the inclusion of Ta₂O₅, HfO₂, La₂O₃, and Y₂O₃ provides a cost and manufacturability advantage.

The glass-based compositions described herein may be formed primarily from (i.e., containing 0.5 mol % or more of each) SiO₂, Al₂O₃, Na₂O, MgO, CaO, and optionally Li₂O and/or K₂O. In aspects, the glass-based compositions are substantially free or free of components other than SiO₂, Al₂O₃, Li₂O, Na₂O, K₂O, MgO, CaO, and/or a fining agent (e.g., SnO₂). In aspects, the glass-based compositions are substantially free and/or free of one or more of Li₂O, K₂O, MgO, SrO, BaO, P₂O₅, B₂O₃, TiO₂, ZrO₂, and/or Fe₂O₃.

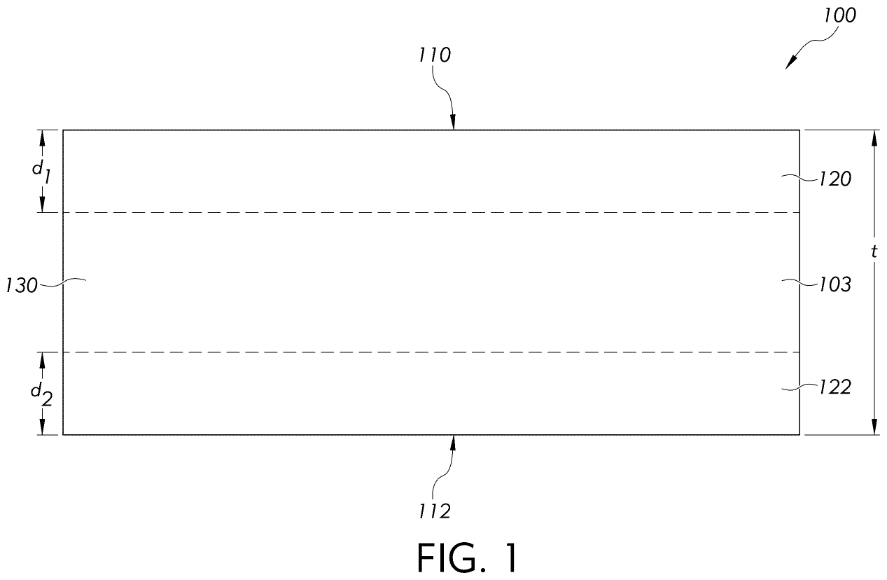

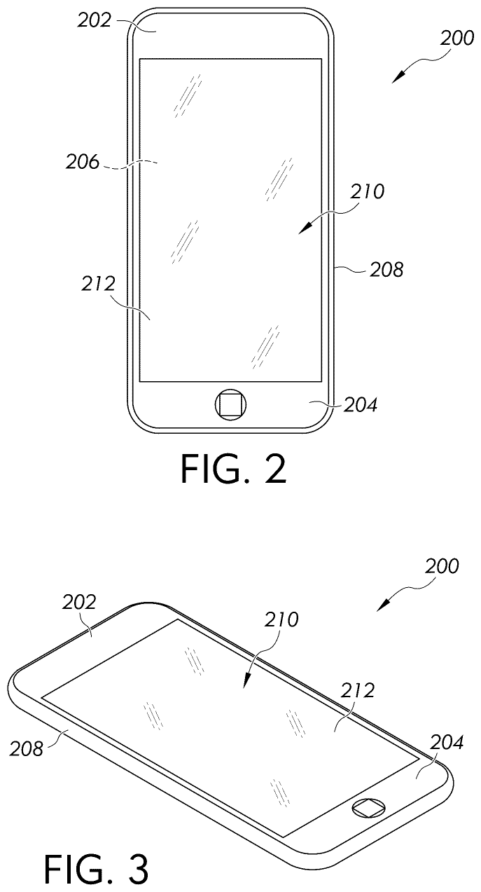

The glass-based compositions described herein have liquidus viscosities that are compatible with manufacturing processes that are especially suitable for forming thin glass sheets. For example, as discussed below with reference to FIGS. 1-2, the glass-based compositions are compatible with down draw processes such as fusion-draw processes or slot draw processes. Embodiments of the glass-based substrates may be described as fusion-formable (i.e., formable using a fusion-draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass-based article. The fusion of the glass films produces a fusion line within the glass-based substrate, and this fusion line allows glass-based substrates that were fusion formed to be identified without additional knowledge of the manufacturing history. The fusion-draw method offers the advantage that, because the two glass films flowing over the channel fuse together, neither of the outside surfaces of the resulting glass-based article comes in contact with any part of the apparatus. Thus, the surface properties of the fusion-drawn glass-based article are not affected by such contact. The glass-based compositions described herein may be selected to have liquidus viscosities that are compatible with fusion-draw processes and/or slot draw processes. Thus, the glass-based compositions described herein are compatible with existing forming methods, increasing the manufacturability of glass-based articles formed from the glass-based compositions. Alternatively or additionally, as discussed below with reference to FIG. 3, the glass-based compositions can be compatible with rolling processes. For example, molten material can be delivered to a pair of rollers that form a glass ribbon with a predetermined thickness. Compared to most fusion-draw processes, rolling processes can form glass ribbons at a higher temperature and/or a lower viscosity.

As used herein, “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed herein is determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point”. As used herein, the “Vogel-Fulcher-Tamman” (VFT) relation describes the temperature dependence of the viscosity and is represented by the following equation:

$$log 𝔫 = A + \frac{B}{T - {T}_{o}}$$

where η is viscosity. To determine VFT A, VFT B, and VFT T₀, the viscosity of the glass-based composition is measured over a given temperature range. The raw data of viscosity versus temperature is then fit with the VFT equation by least-squares fitting to obtain A, B, and T₀. With these values, a viscosity point (e.g., 200 Poise (P) Temperature, 35,000 P Temperature, and 200,000 P Temperature) at any temperature above softening point may be calculated. Unless otherwise specified, the liquidus viscosity and temperature of a glass-based composition or article is measured before the composition or article is subjected to any ion-exchange process or any other strengthening process. In particular, the liquidus viscosity and temperature of a glass-based composition or article is measured before the composition or article is exposed to an ion-exchange solution, for example before being immersed in an ion-exchange solution. As reported in the Examples below, the “liquidus viscosity” discussed herein corresponds to the “internal” Liquidus Viscosity (kP) reported in Table I.

In aspects, the liquidus viscosity of the glass-based composition can be 30 kiloPoise (kP) or more, 40 kP or more, 50 kP or more, 60 kP or more, 75 kP or more, 90 kP or more, 100 kiloPoise kP or more, 125 kP or more, 150 kP or more, 175 kP or more, 200 kP or more, 225 kP or more, 250 kP or more, 500 kP or less, 450 kP or less, 400 kP or less, 350 kP or less, 325 kP or less, 300 kP or less, or 275 kP or less. In aspects, the liquidus viscosity of the glass-based compositions can be in a range from greater than or equal to 30 kP to less than or equal to 500 kP, from greater than or equal to 40 kP to less than or equal to 450 kP, from greater than or equal to 50 kP to less than or equal to 400 kP, from greater than or equal to 60 kP to less than or equal to 350 kP, from greater than or equal to 75 kP to less than or equal to 350 kP, from greater than or equal to 100 kP to less than or equal to 350 kP, from greater than or equal to 125 kP to less than or equal to 350 kP, from greater than or equal to 150 kP to less than or equal to 325 kP, from greater than or equal to 175 kP to less than or equal to 325 kP, from greater than or equal to 200 kP to less than or equal to 300 kP, from greater than or equal to 225 kP to less than or equal to 300 kP, or any range or subrange therebetween. In preferred aspects, the liquidus viscosity of the glass-based composition is in a range from greater than or equal to 30 kP to less than or equal to 500 kP, from greater than or equal to 60 kP to less than or equal to 450 kP, or greater than or equal to 100 kP to less than or equal to 350 kP.

Without wishing to be bound by theory, it is believed that compositions of the present disclosure produced a different structure of the glass network (e.g., liquidus phase) than is associated with a non-spodumene crystal phase when the composition is crystalized, as discussed below. As used herein a liquidus phase is determined after holding molten material corresponding to the glass-based material at the liquidus temperature (determined as described above) for at least 24 hours. In aspects, a liquidus phase associated with the glass-based material can comprise one or more of nepheline, forsterite, feldspar, spinel, or combinations thereof. As used herein, a “primary” liquidus phase refers to the largest (by vol %) of the crystal phases observed. In further aspects, a primary liquidus phase can be nepheline or forsterite. In further aspects, a primary and/or sole liquidus phase can be nepheline.

In aspects, the glass-based compositions described herein may form glass-based articles that exhibit an amorphous microstructure and may be substantially free of crystals or crystallites. In other words, the glass-based articles formed from the glass-based compositions described herein may exclude glass-ceramic materials. Alternatively, in aspects, the glass-based articles can form glass-ceramics. In further aspects, the glass-ceramic can be formed by heating an amorphous glass-based article to nucleate and/or grow crystallites. In further aspects, the glass-ceramics can comprise a crystal phase comprising nepheline, forsterite, feldspar, spinel, or combinations thereof. In even further aspects, the glass-ceramics can comprise nepheline and/or forsterite. In even further aspects, a primary crystal phase (i.e., the crystal phase with the greatest vol % of the glass-ceramic) can be nepheline and/or forsterite. In aspects, the composition, glass-based substrate, and/or glass-based article can be crystallized by heating it at 1050° C. for 24 hours to form a nepheline and/or forsterite. In further aspects, the primary crystal phase (i.e., the crystal phase with the greatest vol % of the glass-ceramic) when after the composition, glass-based substrate, and/or glass-based article is heated at 1050° C. for 24 hours can be nepheline and/or forsterite.

As used herein, a “strain point temperature” refers to the temperature at which the viscosity of the glass-based composition is 1×10^{14.68} poise. Unless otherwise indicated, the strain point temperature is determined using the fiber elongation method of ASTM C336-71 (2015). In aspects, the strain point temperature can be greater than or equal to 530° C., greater than or equal to 550° C., greater than or equal to 570° C., greater than or equal to 600° C., greater than or equal to 610° C., greater than or equal to 620° C., greater than or equal to 650° C., less than or equal to 685° C., less than or equal to 660° C., less than or equal to 645° C., less than or equal to 630° C., less than or equal to 615° C., less than or equal to 600° C., less than or equal to 585° C., or less than or equal to 570° C. In aspects, the strain point temperature can be in a range from greater than or equal to 530° C. to less than or equal to 685° C., from greater than or equal to 550° C. to less than or equal to 660° C., from greater than or equal to 570° C. to less than or equal to 645° C., from greater than or equal to 600° C. to less than or equal to 630° C., from greater than or equal to 610° C. to less than or equal to 615° C., or any range or subrange therebetween. In preferred aspects, the strain point temperature can be in a range from greater than or equal to 530° C. to less than or equal to 685° C., from greater than or equal to 600° C. to less than or equal to 660° C., or from greater than or equal to 610° C. to less than or equal to 645° C.

As used herein, the term “softening point temperature” refers to the temperature at which the viscosity of the glass-based composition is 1×10^{7.6} poise. Unless otherwise indicated, the softening point temperature of the glass-based composition was determined using the fiber elongation method of ASTM C336-71 (2015). In aspects, the softening point temperature can be greater than or equal to 820° C., greater than or equal to 840° C., greater than or equal to 860° C., greater than or equal to 880° C., greater than or equal to 900° C., greater than or equal to 920° C., greater than or equal to 940° C., greater than or equal to 960° C. less than or equal to 995° C., less than or equal to 980° C., less than or equal to 965° C., less than or equal to 950° C., less than or equal to 935° C., less than or equal to 920° C., less than or equal to 910° C., less than or equal to 895° C., less than or equal to 880° C., less than or equal to 865° C., or less than or equal to 850° C. In aspects, the softening point temperature can be in a range from greater than or equal to 820° C. to less than or equal to 995° C., from greater than or equal to 840° C. to less than or equal to 980° C., from greater than or equal to 860° C. to less than or equal to 980° C., from greater than or equal to 880° C. to less than or equal to 965° C., from greater than or equal to 900° C. to less than or equal to 950° C., from greater than or equal to 920° C. to less than or equal to 935° C., or any range or subrange therebetween. In preferred aspects, the softening point temperature can be in a range from greater than or equal to 820° C. to less than or equal to 995° C., from greater than or equal to 840° C. to less than or equal to 980° C., or from greater than or equal to 880° C. to less than or equal to 965° C.

Throughout the disclosure, the Young's modulus of glass-based material is measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, the glass-based composition can have an elastic modulus (e.g., Young's modulus) of less than or equal to 80 GigaPascals (GPa), less than or equal to 77 GPa, less than or equal to 75.0 GPa, less than or equal to 74.0 GPa, less than or equal to 73.8 GPa, less than or equal to 73.5 GPa, less than or equal to 73.3 GPa, less than or equal to 73.0 GPa, less than or equal to 72.8 GPa, less than or equal to 72.5 GPa, greater than or equal to 70.0 GPa, greater than or equal to 71.0 GPa, greater than or equal to 71.5 GPa, greater than or equal to 72.0 GPa, greater than or equal to 72.1 GPa, greater than or equal to 72.3 GPa, greater than or equal to 72.5 GPa, greater than or equal to 72.7 GPa, greater than or equal to 73.0 GPa, or greater than equal to 73.5 GPa. In aspects, the glass-based composition can have an elastic modulus (e.g., Young's modulus) in a range from greater than or equal to 70.0 GPa to less than or equal to 80 GPa, from greater than or equal to 71.0 GPa to less than or equal to 77 GPa, from greater than or equal to 71.5 GPa to less than or equal to 75.0 GPa, from greater than or equal to 72.0 GPa to less than or equal to 74.0 GPa, from greater than or equal to 72.1 GPa to less than or equal to 73.8 GPa, from greater than or equal to 72.3 GPa to less than or equal to 73.5 GPa, from greater than or equal to 72.5 GPa to less than or equal to 73.3 GPa, from greater than or equal to 72.7 GPa to less than or equal to 73.0 GPa, or any range or subrange therebetween. In preferred aspects, the glass-based composition can have an elastic modulus (e.g., Young's modulus) in a range from greater than or equal to 70.0 GPa to less than or equal to 80.0 GPa, from greater than or equal to 72.0 GPa to less than or equal to 74.0 GPa, or from greater than or equal to 72.1 GPa to less than or equal to 73.8 GPa.

Glass-based compositions according to aspects have a high fracture toughness. Without wishing to be bound by theory, the high fracture toughness may impart improved drop performance to the glass-based compositions. The high fracture toughness of the glass-based compositions described herein increases the resistance to damage and allows a higher degree of stress to be imparted to the resulting glass-based articles through ion exchange (e.g., higher central tension) without becoming frangible. As used herein, “fracture toughness” refers to the K_{IC} value as measured by the chevron-notched short bar (CNSB) method. The CNSB method is disclosed in Reddy, K. P. R. et al., “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Additionally, the K_{IC} values are measured on non-strengthened glass-based samples, such as measuring the K_{IC} value prior to ion exchanging a glass-based substrate to form a glass-based article. The K_{IC} values discussed herein are reported in MPa√m, unless otherwise noted. In aspects, the glass-based compositions exhibit a K_{IC} value of greater than or equal to 0.60 MPa√m, such as greater than or equal to 0.70 MPa√m, greater than or equal to 0.72 MPa√m, greater than or equal to 0.74 MPa√m, or more. In aspects, the glass-based compositions exhibit a K_{IC} value of from greater than or equal to 0.60 MPa√m to less than or equal to 0.8 MPa√m, such as from greater than or equal to 0.70 MPa√m to less than or equal to 0.76 MPa√m, from greater than or equal to 0.72 to less than or equal to 0.74 MPa√m or any range or sub-range therebetween. The high compressive stress in the glass-based articles can increase the fracture toughness. The high fracture toughness values of the glass-based compositions described herein also may enable improved performance. The frangibility limit of the glass-based articles produced utilizing the glass compositions described herein is dependent at least in part on the fracture toughness. For this reason, the high fracture toughness of the glass compositions described herein allows for a large amount of stored strain energy to be imparted to the glass-based articles formed therefrom without becoming frangible. The increased amount of stored strain energy that may then be included in the glass-based articles allows the glass-based articles to exhibit increased fracture resistance, which may be observed through the drop performance of the glass-based articles.

As shown in FIG. 1, a glass-based article 100 comprises a first major surface 110 and a second major surface 112 opposite the first major surface. In aspects, the first major surface 110 and/or the second major surface 112 can comprise a planar surface. In further aspects, the first major surface 110 can be parallel to the second major surface 112. As shown, a substrate thickness t of the glass-based article 100 is defined between the first major surface 110 and the second major surface 112 as the average thickness therebetween. In aspects, the substrate thickness t can be 10 μm or more, 20 μm or more, 40 μm or more, 60 μm or more, 75 μm or more, 100 μm or more, 150 μm or more, 200 μm or more, 400 μm or more, 600 μm or more, 1 mm or more, 2 mm or more, 5 mm or less, 3 mm or less, 2 mm or less, 1.5 mm or less, 1 mm or less, 0.9 mm or less, 0.8 mm or less, 0.7 mm or less, 0.5 mm or less, 0.3 mm or less, 0.2 mm or less, or 0.1 mm or less. In aspects, the substrate thickness t can be in a range from greater than or equal to 10 μm to less than or equal to 5 mm, from greater than or equal to 25 μm to less than or equal to 3 mm, from greater than or equal to 40 μm to less than or equal to 2 mm, from greater than or equal to 60 μm to less than or equal to 1.5 mm, from greater than or equal to 75 μm to less than or equal to 1.5 mm, from greater than or equal to 100 μm to less than or equal to 1 mm, from greater than or equal to 150 μm to less than or equal to 1 mm, from greater than or equal to 200 μm to less than or equal to 1 mm, from greater than or equal to 400 μm to less than or equal to 0.9 mm, from greater than or equal to 600 μm to less than or equal to 0.8 mm, or any range or subrange therebetween. In aspects, the substrate thickness can be 1 mm or less, for example, in a range from greater than or equal to 10 μm to less than or equal to 1.0 mm, from greater than or equal to 25 μm to less than or equal to 0.8 mm, from greater than or equal to 40 μm to less than or equal to 0.5 mm, from greater than or equal to 60 μm to less than or equal to 0.3 mm, from greater than or equal to 75 μm to less than or equal to 0.1 mm, or any range or subrange therebetween. In preferred aspects, the substrate thickness t of the glass-based article can be in a range from greater than or equal to 10 μm to less than or equal to 5 mm, from greater than or equal to 25 μm to less than or equal to 1 mm, or from greater than or equal to 40 μm to less than or equal to 0.3 mm. The glass-based substrate utilized to form the glass-based article may have the same thickness as the thickness desired for the glass-based article.

As mentioned above, in aspects, the glass compositions (e.g., glass-based substrate) described herein can be strengthened, such as by ion exchange, making a glass-based article that is damage resistant for applications such as, but not limited to, display covers. As shown in FIG. 1, the glass-based article 100 comprises a glass-based substrate 103 having a first compressive stress region 120 extending from the first major surface 110 to a first depth of compression d1, and/or the glass-based article 100 has a second compressive stress region 122 extending from the second major surface 112 to a second depth of compression d2. The first compressive stress region and/or the second compressive stress region is under compressive stress (e.g., as a result of ion exchange). In further aspects, as shown in FIG. 1, the glass-based article 100 can comprise a central tension region 130 under tensile stress (e.g., central tension (CT)) and positioned between the first compressive stress region 120 and the second compressive stress region 122 (e.g., extending between the first depth of compression d1 from the first major surface 110 and the second depth of compression d2 from the second major surface 112). As used herein, “depth of compression” (DOC) refers to the depth at which the stress within the glass-based article changes from compressive to tensile. At the DOC, the stress crosses from a positive (compressive) stress to a negative (tensile) stress and thus exhibits a stress value of zero. Throughout this description, however, CS and CT are both expressed as positive or absolute values—i.e., as recited herein, CS=|CS|. The compressive stress (CS) has a maximum at or near the surface of the glass-based article, and the CS varies with distance d from the surface according to a function.

In aspects, the compressive stress region(s) may be created by chemically strengthening a glass-based substrate to form the glass-based article 100. Chemically strengthening may comprise an ion-exchange process, where ions in a surface layer are replaced by—or exchanged with—larger ions having the same valence or oxidation state. Methods of chemically strengthening will be discussed later. Without wishing to be bound by theory, chemically strengthening the substrate can enable small (e.g., smaller than 10 mm or less) bend radii and/or parallel plate distances because the compressive stress from the chemical strengthening can counteract the bend-induced tensile stress on the outermost surface of the substrate (e.g., first major surface 110, or second major surface 112). Depth of compression (DOC) may be measured by a surface stress meter or a scattered light polariscope (SCALP, wherein values reported herein were made using SCALP-5 made by Glasstress Co., Estonia) depending on the ion-exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure a depth of compression. Unless specified otherwise, compressive stress (including surface CS) is measured by a surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than 75 μm, SCALP is used to measure the depth of compression and central tension (CT). Where the stress in the substrate is generated by exchanging both potassium and sodium ions into the glass, and the article being measured is thicker than 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than 75 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the first depth of compression and/or second depth of compression, as a percentage of the substrate thickness t, can be 17% or more, 18% or more, 19% or more, 20% or more, 21% or more, 22% or more, 23% or more, 24% or more, 25% or more, 25% or less, 24% or less, or 23% or less. In even further aspects, the first depth of compression and/or the second depth of compression, as a percentage of the substrate thickness t, can be in a range from 17% to 25%, from 18% to 25%, from 19% to 25%, from 20% to 25%, from 21% to 24%, from 22% to 23%, or any range or subrange therebetween. In aspects, the first depth of compression and/or the second depth of compression can be 10 μm or more, 30 μm or more, 50 μm or more, 100 μm or more, 150 μm or more, 200 μm or more, 250 μm or more, 500 μm or less, 400 μm or less, 300 μm or less, 250 μm or less, 200 μm or less, 150 μm or less, or 100 μm or less. In aspects, the first depth of compression and/or the second depth of compression can be in a range from greater than or equal to 10 μm to less than or equal to 500 μm, from greater than or equal to 30 μm to less than or equal to 400 μm, from greater than or equal to 50 μm to less than or equal to 300 μm, from greater than or equal to 100 μm to less than or equal to 250 μm, from greater than or equal to 150 μm to less than or equal to 200 μm, or any range or subrange therebetween. In aspects, the first depth of compression and/or the second depth of compression can be 150 μm or more, for example, in a range from greater than or equal to 150 μm to less than or equal to 500 μm, from greater than or equal to 200 μm to less than or equal to 400 μm, or any range or subrange therebetween. In aspects, the first depth of compression can be greater than, less than, or substantially the same as the second depth of compression. By providing a glass-based substrate and/or a ceramic-based substrate comprising a first depth of compression and/or a second depth of compression in a range from 20% to 25% of the substrate thickness, good impact and/or puncture resistance can be enabled.

The first compressive stress region 120 comprises a maximum first compressive stress, and/or the second compressive stress region 122 comprises a maximum second compressive stress. In aspects, a location of the maximum first compressive stress and/or the maximum second compressive stress can be at (e.g., within 1 μm) of the corresponding major surface, although the corresponding maximum compressive stress can be located more than 1 μm from the corresponding major surface. In aspects, the maximum first compressive stress and/or the maximum second compressive stress can be greater than or equal to 500 MegaPascals (MPa), greater than or equal to 700 MPa, greater than or equal to 800 MPa, greater than or equal to 900 MPa, greater than or equal to 1,000 MPa, greater than or equal to 1,050 MPa, greater than or equal to 1,100 MPa, greater than or equal to 1,150 MPa, greater than or equal to 1,200 MPa, greater than or equal to 1,250 MPa, greater than or equal to 1,300 MPa, greater than or equal to 1,350 MPa, less than or equal to 1,800 MPa, less than or equal to 1,700 MPa, less than or equal to 1,600 MPa, less than or equal to 1,550 MPa, less than or equal to 1,500 MPa, less than or equal to 1,450 MPa, less than or equal to 1,400 MPa, less than or equal to 1,350 MPa, or less than or equal to 1,300 MPa. In aspects, the maximum first compressive stress and/or the maximum second compressive stress can be in a range from greater than or equal to 500 MPa to less than or equal to 1,800 MPa, from greater than or equal to 700 MPa to less than or equal to 1,800 MPa, from greater than or equal to 800 MPa to less than or equal to 1,700 MPa, from greater than or equal to 900 MPa to less than or equal to 1,700 MPa, from greater than or equal to 1,000 MPa to less than or equal to 1,600 MPa, from greater than or equal to 1,050 MPa to less than or equal to 1,600 MPa, from greater than or equal to 1,100 MPa to less than or equal to 1,600 MPa, from greater than or equal to 1,150 MPa to less than or equal to 1,550 MPa, from greater than or equal to 1,200 MPa to less than or equal to 1,550 MPa, from greater than or equal to 1,250 MPa to less than or equal to 1,500 MPa, from greater than or equal to 1,300 MPa to less than or equal to 1,450 MPa, from greater than or equal to 1,350 MPa to less than or equal to 1,400 MPa, or any range or subrange therebetween. In preferred aspects, the maximum first compressive stress and/or the maximum second compressive stress can be in a range from greater than or equal to 800 MPa to less than or equal to 1,800 MPa, from greater than or equal to 1,100 MPa to less than or equal to 1,600 MPa, or from greater than or equal to 1,300 MPa to less than or equal to 1,450 MPa. The compositions disclosed herein can achieve a high maximum compressive stress (e.g., greater than or equal to 800 MPa, from 1,100 MPa to 1,600 MPa, or from 1,300 MPa to less than or equal to 1,450) that can enable foldability, good impact resistance, and/or puncture resistance.

In aspects, Na⁺ and/or K⁺ ions can be exchanged into the glass-based article, and the Na⁺ ions diffuse to a deeper depth into the glass-based article than the K⁺ ions. In further aspects, compressive stress can be developed primarily by or entirely by the ion-exchange of potassium into the glass-based article. The depth of penetration of K⁺ ions (“Potassium DOL” or “DOL” herein) is distinguished from DOC because it represents the depth of potassium penetration as a result of an ion-exchange process. The Potassium DOL is typically less than the DOC for the articles described herein. Potassium DOL is measured using a surface stress meter such as the commercially available FSM-6000 surface stress meter, manufactured by Orihara Industrial Co., Ltd. (Japan), which relies on accurate measurement of the stress optical coefficient (SOC), as described above with reference to the CS measurement. The potassium DOL may define a depth of a compressive stress spike (DOL_{SP}), where a stress profile transitions from a steep spike region to a less steep, deep region. The deep region extends from the bottom of the spike to the depth of compression. In aspects, the depth of layer of one or more of the alkali metal ions associated with the corresponding compressive stress region (e.g., DOL_{SP}) of the glass-based article can be 5 μm or more, 6 μm or more, 7 μm or more, 8 μm or more, 9 μm or more, 10 μm or more, 13 μm or more, 15 μm or less, 17 μm or less, 20 μm or more, 22 μm or more, 25 μm or more, 27 μm or more, 30 μm or more, 35 μm or more, 40 μm or more, 50 μm or less, 45 μm or less, 40 μm or less, 35 μm or less, 30 μm or less, 25 μm or less, 20 μm or less, 18 μm or less, 15 μm or less, 12 μm or less, 10 μm or less, 9 μm or less, or 8 μm or less. In aspects, the depth of layer of one or more of the alkali metal ions associated with the corresponding compressive stress region (e.g., DOL_{SP}) can be in a range from 5 μm to 50 μm, from 6 μm to 45 μm, from 7 μm to 40 μm, from 8 μm to 35 μm, from 9 μm to 30 μm, from 10 μm to 25 μm, from 13 μm to 20 μm, from 15 μm to 17 μm, or any range or subrange therebetween. In aspects, the depth of layer of one or more of the alkali metal ions associated with the corresponding compressive stress region (e.g., DOL_{SP}) can be greater than or equal to 20 μm, for example, in a range from 20 μm to 50 μm, from 25 μm to 45 μm, from 30 μm to 40 μm, from 35 μm to 40 μm, or any range or subrange therebetween. In aspects, the depth of layer of one or more of the alkali metal ions associated with the corresponding compressive stress region (e.g., DOL_{SP}) can be less than or equal to 17 μm, for example, in a range from 5 μm to 17 μm, from 6 μm to 15 μm, from 7 μm to 12 μm, from 8 μm to 10 μm, from 9 μm to 10 μm, or any range or subrange therebetween. The compositions of the present disclosure can provide deeper depth of layer (e.g., DOL_{SP}) than would otherwise be achievable for the same chemical strengthening treatment.

The central tension region can comprise a maximum central tension (CT). The measurement of a maximum CT value is an indicator of the total amount of stress stored in the strengthened articles. For this reason, the ability to achieve higher CT values correlates to the ability to achieve higher degrees of strengthening and increased performance. In aspects, the maximum CT can be 50 MPa or more, 60 MPa or more, 70 MPa or more, 75 MPa or more, 80 MPa or more, 85 MPa or more, 120 MPa or less, 100 MPa or less, 95 MPa or less, 90 MPa or less, 85 MPa or less, or 80 MPa or less. In aspects, the maximum CT can be in a range from greater than or equal to 50 MPa to less than or equal to 120 MPa, from greater than or equal to 50 MPa to less than or equal to 100 MPa, from greater than or equal to 50 MPa to less than or equal to 95 MPa, from greater than or equal to 60 MPa to less than or equal to 90 MPa, from greater than or equal to 70 MPa to less than or equal to 90 MPa, from greater than or equal to 75 MPa to less than or equal to 85 MPa, from greater than or equal to 80 MPa to less than or equal to 85 MPa, or any range or subrange therebetween. In preferred aspects, the maximum CT can be in a range from greater than 50 MPa to less than or equal to 120 MPa, from greater than or equal to 50 MPa to less than or equal to 100 MPa, or from greater than or equal to 70 MPa to less than or equal to 100 MPa.

As used herein, “foldable” includes complete folding, partial folding, bending, flexing, or multiple capabilities. As used herein, the terms “fail,” “failure,” and the like refer to breakage, destruction, delamination, or crack propagation. A foldable apparatus achieves a parallel plate distance of “X,” or withstands a parallel plat distance of “X”, or has a parallel plate distance of “X” if it resists failure when the foldable apparatus is held at parallel plate distance of “X” for 60 minutes at 25° C. and 50% relative humidity. In aspects, the foldable substrate and/or the foldable apparatus can be rollable. As used herein, a foldable substrate or a foldable apparatus is “rollable” if it can achieve a threshold parallel plate distance over a length of the corresponding foldable substrate and/or foldable apparatus that is the greater of 10 mm or 10% of the length of the corresponding foldable substrate and/or foldable apparatus.

As used herein, the “parallel plate distance” of a glass-based substrate and/or a glass-based article is measured with the following test configuration and process using a parallel plate apparatus that comprises a pair of parallel rigid stainless-steel plates. When measuring the “parallel plate distance”, the glass-based substrate and/or a glass-based article is placed between the pair of parallel rigid stainless-steel plates as-is (without modification). For example, the glass-based article 100 shown in FIG. 1 is placed between the pair of parallel rigid stainless-steel plates without modification with the second major surface 112 of the glass-based article 100 contacting the pair of parallel rigid stainless-steel plates. For determining a “parallel plate distance”, the distance between the parallel plates is reduced at a rate of 1 millimeter per second (mm/sec) until the parallel plate distance is equal to the “parallel plate distance” to be tested. Then, the parallel plates are held at the “parallel plate distance” to be tested for 60 minutes at 25° C. and 50% relative humidity. As used herein, the “minimum parallel plate distance” is the smallest parallel plate distance that the foldable apparatus can withstand without failure under the conditions and configuration described above. In aspects, the glass-based substrate and/or a glass-based article can achieve a parallel plate distance of 20 mm or less, 10 mm or less, 7 mm or less, 5 mm or less, 3 mm or less, 2 mm or less, or 1 mm or less. In aspects, a glass-based substrate and/or a glass-based article can comprise a minimum parallel plate distance of 5 mm or less, 4 mm or less, 3 mm or less, 2 mm or less, or 1 mm or less. In aspects, a glass-based substrate and/or a glass-based article can comprise a minimum parallel plate distance ranging from 0.5 mm to 5 mm, from 0.5 mm to 4 mm, from 0.5 mm to 3 mm, from 0.5 mm to 2 mm, from 1 mm to 2 mm, or any range or subrange therebetween.

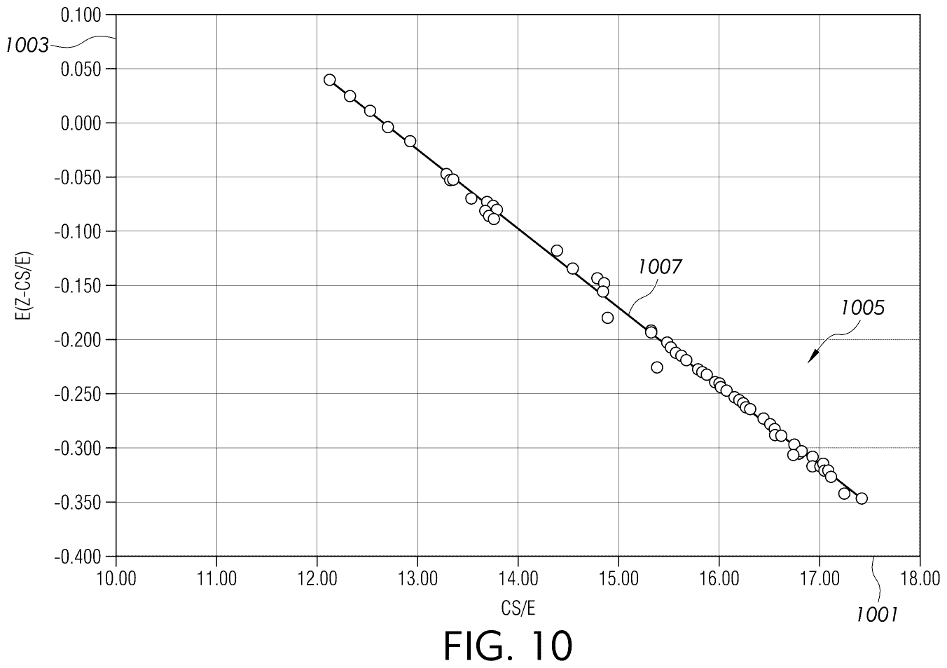

The glass-based compositions and/or glass-based articles of the present disclosure can provide improved foldability. Without wishing to be bound by theory, fracture toughness (e.g., caused by a “flaw” near the surface of the glass-based article) is proportional to a glass strength of the glass-based article. The glass strength (e.g., σ_{NET}) can be approximated as a difference between a bend-induced stress (e.g., σ_{BEND} at the surface of the glass-based article) and a compressive stress (e.g., σ_{IOX} from chemically strengthening the glass-based article, the first and/or second maximum compressive stress) (i.e., σ_{NET}≈σ_{BEND}−σ_{IOX}). During bending, the stress on the glass-based article is proportional to a product of the elastic modulus (E). The inventor of the present disclosure has determined that these expressions can be combined to state the glass strength as σ_{BEND}≈E[Z-CS/E], where Z is a constant for a predetermined bend (e.g., folding to a predetermined parallel plate distance for a glass-based article having a predetermined thickness. As used herein, the CS value is measured using the FSM-6000 and refers to the maximum value (i.e., greatest absolute value) of the compressive stress measured (e.g., usually at the surface of the glass-based article). As shown in FIG. 10, there is a linear relationship (indicated by line 1007) between data points 1005 for more than 80 example glass-based articles with different compositions between CS/E (MPa/GPa) on the horizontal axis 1001 (e.g., x-axis) and E(Z-CS/E) on the vertical axis 1003 (e.g., y-axis). Based on this observed linear relationship (and the theoretical prediction of such relationship), the inventor of the present disclosure has unexpectedly discovered glass-based compositions for glass-based articles that are able to achieve higher CS/E ratios than have otherwise been possible. In view of the above, glass-based compositions for glass-based articles that are able to achieve higher CS/E ratios exhibit increased glass strength that can manifest as increased foldability of the glass-based article.

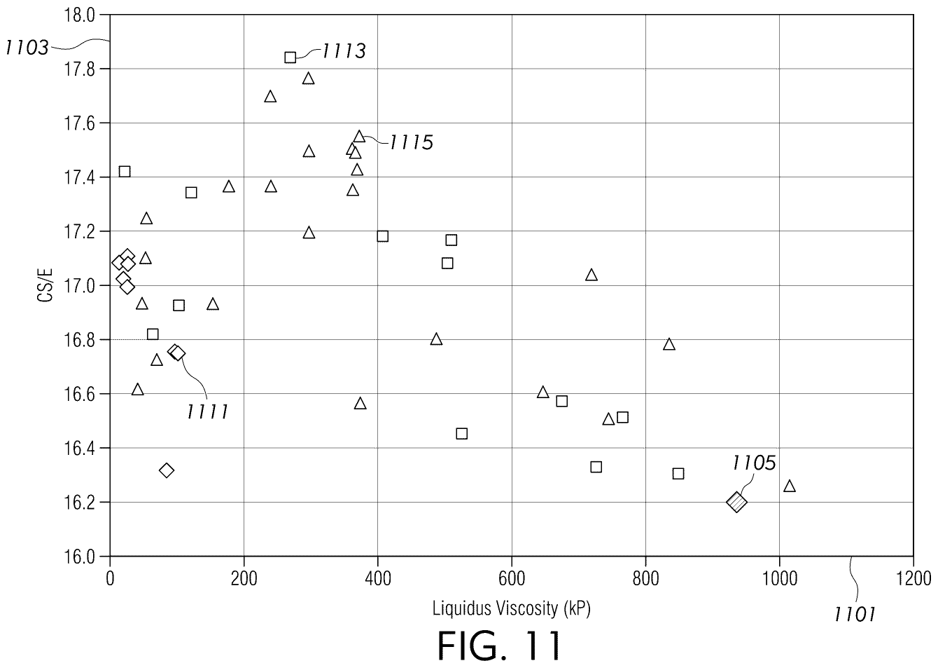

Throughout the disclosure, the ratio of compressive stress to elastic modulus of the glass-based article (CS/E) refers to the maximum compressive stress (in MPa) at a major surface of the glass-based article to the elastic modulus (e.g., Young's modulus) (in GPa) of the glass-based article. As used herein, the Young's modulus (E) of the glass-based article is measured by a resonant ultrasonic spectroscopy technique in accordance with ASTM E2001-13. As used herein, the CS value is measured using the FSM-6000 and refers to the maximum value (i.e., greatest absolute value) of the compressive stress measured (e.g., usually at the surface of the glass-based article). Consequently, the CS value changes based on the chemically strengthening treatment. However, as shown in the Example below, CS/E (in MPa/GPa) can be obtained for chemical strengthening treatments of 15 minutes or less in a 100 wt % KNO₃ molten salt solution maintained at 410° C. and/or 4 hours or more in a 100 wt % KNO₃ molten salt solution maintained at 410° C. Consequently, the measured CS/E ratio (in MPa/GPa) (e.g., greater than 16.0 or any of the ranges discussed below in this paragraph) for the compositions of the present disclosure can be obtained for other chemical strengthening treatments beyond the treatments reported in the Examples. Unless otherwise indicated, the CS in the ratio CS/E for the examples reported herein is measured for glass-based articles that were chemically strengthened in a 100 wt % KNO₃ molten salt solution maintained at 410° C., and the glass-based substrate was fictivated at 1011 Poise before being chemically strengthened to form the glass-based article. Without wishing to be bound by theory, the bend-induced stress increases as the elastic modulus increases for a predetermined strain (e.g., bend or folded configuration), the compressive stress at least offsets the bend-induced stress before failure, and therefore, it is the competition (e.g., ratio) of these values (i.e., CS/E) that controls foldability. Further, without wishing to be bound by theory, it is believed that it has not been possible to achieve a ratio of CS/E (in MPa/GPa) greater than 16.0; however, the inventor of the present disclosure has unexpectedly found that glass-based compositions of the present disclosure can have a ratio of CS/E (in MPa/GPa) exceeding 16.0 (e.g., see results presented in Table II). In aspects, the ratio CS/E (in MPa/GPa) of the glass-based article can be greater than 16.0, greater than or equal to 16.1, greater than or equal to 16.2, greater than or equal to 16.3, greater than or equal to 16.4, greater than or equal to 16.5, greater than or equal to 16.6, greater than or equal to 16.7, greater than or equal to 16.8, greater than or equal to 16.9, greater than or equal to 17.0, greater than or equal to 17.1, greater than or equal to 17.2, greater than or equal to 17.3, greater than or equal to 17.4, greater than or equal to 17.5, greater than or equal to 17.6, greater than or equal to 17.7, greater than or equal to 17.8, greater than or equal to 17.9, greater than or equal to 18.0, greater than or equal to 18.2, less than or equal to 19.0, less than or equal to 18.8, less than or equal to 18.5, less than or equal to 18.3, less than or equal to 18.0, less than or equal to 17.8, less than or equal to 17.6, less than or equal to 17.5, less than or equal to 17.4, less than or equal to 17.3, less than or equal to 17.2, less than or equal to 17.1, less than or equal to 17.0, less than or equal to 16.9, less than or equal to 16.8, less than or equal to 16.7, less than or equal to 16.6, less than or equal to 16.5, or less than or equal to 16.4. In aspects, the ratio CS/E (in MPa/GPa) of the glass-based article can be in a range from greater than 16.0 to less than or equal to 19.0, from greater than or equal to 16.1 to less than or equal to 19.0, from greater than or equal to 16.2 to less than or equal to 18.5, from greater than or equal to 16.3 to less than or equal to 18.0, from greater than or equal to 16.4 to less than or equal to 17.8, from greater than or equal to 16.5 to less than or equal to 17.6, from greater than or equal to 16.6 to less than or equal to 17.5, from greater than or equal to 16.7 to less than or equal to 17.4, from greater than or equal to 16.8 to more than or equal to 17.3, from greater than or equal to 16.9 to less than or equal to 17.2, from greater than or equal to 17.0 to less than or equal to 17.1, or any range or subrange therebetween. In aspects, the ratio CS/E (in MPa/GPa) of the glass-based article can be greater than or equal to 16.3, for example, in a range from greater than or equal to 19.0, from greater than or equal to 16.3 to less than or equal to 17.8, from greater than or equal to 16.3 to less than or equal to 17.5, from greater than or equal to 16.3 to less than or equal to 17.2, from greater than or equal to 16.3, to less than or equal to 16.4 to less than or equal to 17.0, from greater than or equal to 16.4 to less than or equal to 16.9, from greater than or equal to 16.5 to less than or equal to 16.8, from greater than or equal to 16.6 to less than or equal to 16.7, or any range or subrange therebetween. In preferred aspects, the ratio CS/E (in MPa/GPa) of the glass-based article can be in a range from greater than or equal to 16.0 to less than or equal to 19.0, from greater than or equal to 16.3 to less than or equal to 18.5, or from greater than or equal to 16.6 to less than or equal to 17.5. For example, FIG. 11 presents the ratio CS/E (in MPa/GPa) on the vertical axis 1103 (e.g., y-axis—for glass-based articles chemically strengthened in a 100 wt % KNO₃ molten salt solution maintained at 410° C.) and liquidus viscosity (in kiloPoise) on the horizontal axis 1101 (e.g., x-axis) for glass compositions indicated by points (e.g., shapes 1105, 1111, 1113, and 1115). As shown, points shown in shapes 1111, 1113, and 1115 exhibit the ratio CS/E (in MPa/GPa) greater than 16.2 (e.g., from 16.3 to 18.5, from 16.3 to 18.0). Also, points with shape 1111 (diamonds) have liquidus viscosities of from 30 kP to 120 kP.

The coated article and/or coating disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion-resistance or a combination thereof. An exemplary article incorporating any of the coated articles disclosed herein is shown in FIGS. 2 and 3. Specifically, FIGS. 2 and 3 show a consumer electronic device 200 including a housing 202 having a front surface 204, a back surface 206, and a side surface 208. The consumer electronic device 200 can comprise electrical components (not shown) that are at least partially inside or entirely within the housing and including at least a controller, a memory, and a display 210 at or adjacent to the front surface of the housing. The consumer electronic device 200 can comprise a cover substrate 212 at or over the front surface of the housing such that it is over the display. In aspects, at least one of the cover substrate 212 or a portion of housing 202 may include a substrate with the first major surface and/or the coated article disclosed herein. The display can comprise a liquid crystal display (LCD), an electrophoretic display (EPD), an organic light-emitting diode (OLED) display, or a plasma display panel (PDP). In aspects, the consumer electronic product can be a portable electronic device, for example, a smartphone, a tablet, a wearable device, or a laptop.

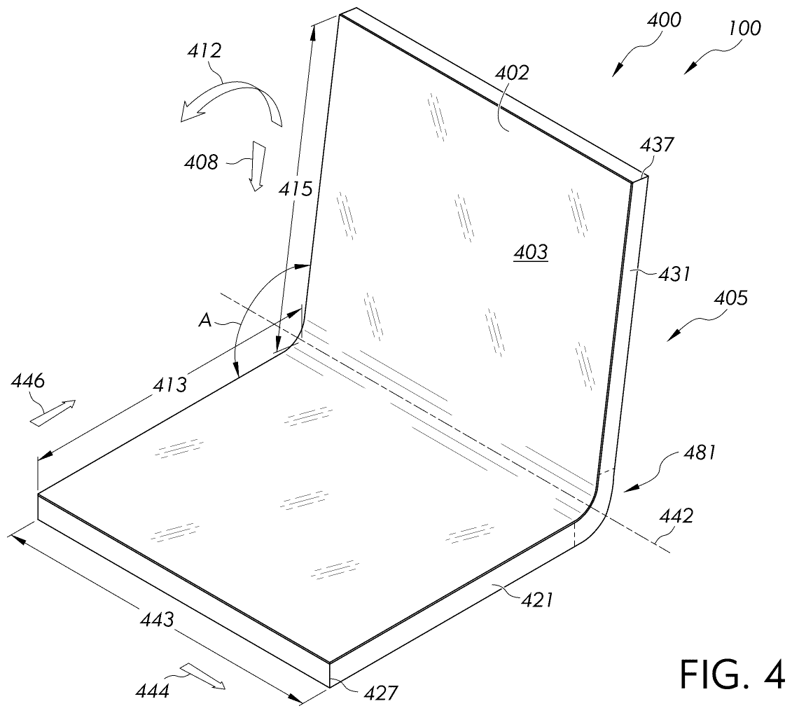

Also, FIG. 4 schematically shows a perspective view of a consumer electronic product 400 that is foldable. The consumer electronic product 400 can include the glass-based article 100 in accordance with aspects of the present disclosure. As shown, the consumer electronic product 400 can include a front surface 403 and a side surface 405. The consumer electronic product 400 can include electronic components, including a display 402 that can be viewed through the front surface 403 and/or at the front surface 403. In aspects, as shown, the consumer electronic product 400 can be folded in a direction 412 to form a folded configuration that brings a first end 427 and a second end 437 (opposite the first end 427) closer together (than in the unfolded configuration). Additionally, as shown, the consumer electronic product 400 can be folded so that the front surface 403 and/or display 402 faces itself, although the consumer electronic product could be folded opposite the direction 412 so that the front surface 403 is on the outside of the consumer electronic product in the folded configuration. In aspects, the consumer electronic product 400 shown in FIG. 4 can be folded about the fold axis 442, where a central portion 481 is located. As shown in FIG. 4, the central portion is positioned between a first portion 421 including the first end 427 and a second portion 431 including the second end 437. A location of the fold axis 442 can determine a first distance 413 between the first end 427 and the fold axis 442 (e.g., in direction 446) relative to a second distance 415 between the second end 437 and the fold axis 442 (e.g., in direction 408). A total length of the consumer electronic product can be the sum of the first distance 413 and the second distance 415). Also, as shown, the consumer electronic product is depicted as being in a folded or partially folded configuration with an angle A formed by front surface 403 about the fold axis 442. As shown in FIG. 4, the consumer electronic product 400 can comprise a width 443 in a direction 444 (perpendicular to a thickness direction and direction 446) that can be substantially equal to a corresponding dimension of the glass-based article, although the glass-based article can be smaller than the width of the consumer electronic product in other aspects.

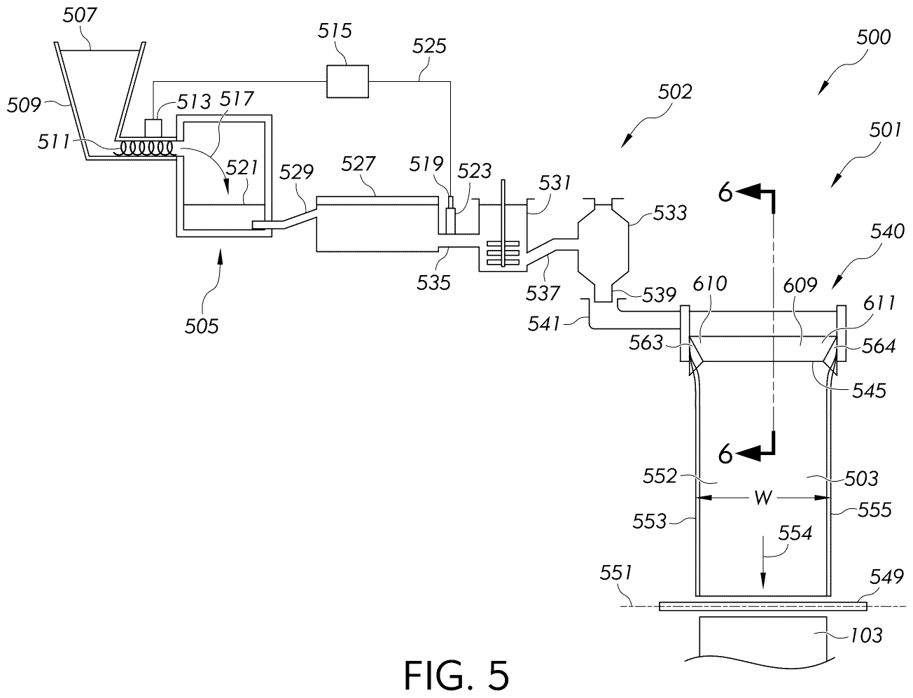

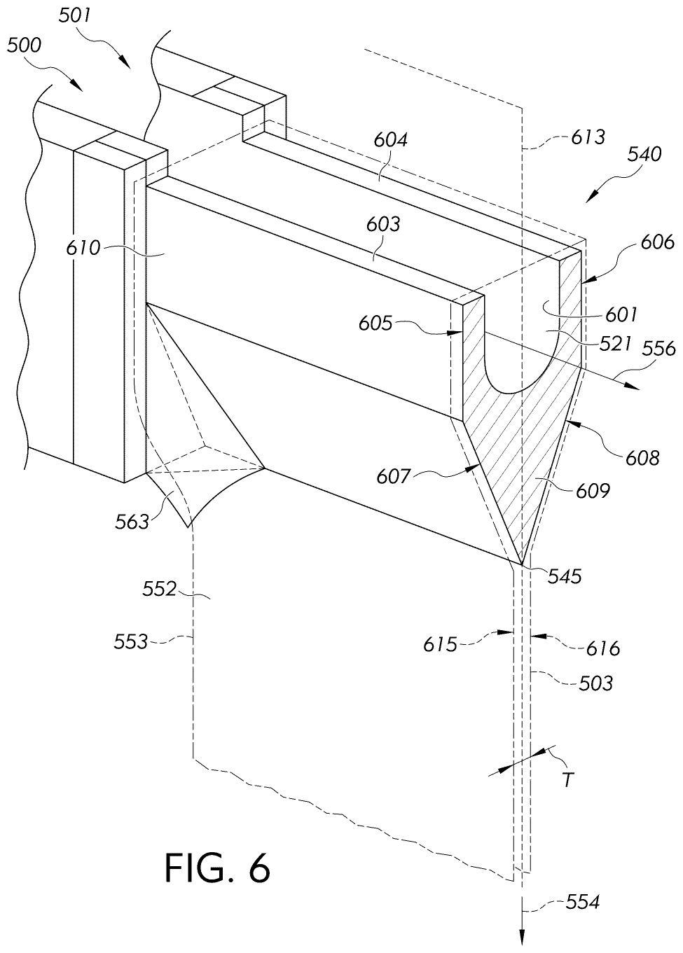

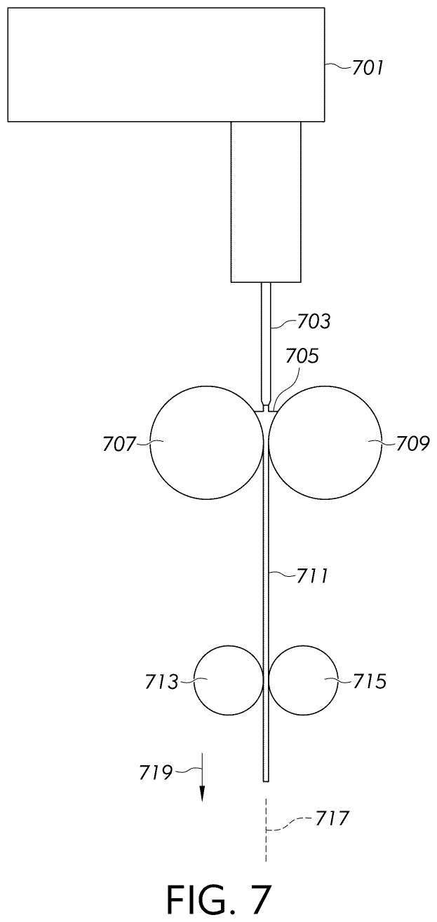

Methods of making glass-based article of the present disclosure will now be discussed with reference to FIGS. 5-9. Glass-based substrates comprising compositions in accordance with the present disclosure can be obtained by forming them with a variety of ribbon forming processes, for example, slot draw, down-draw, fusion down-draw, up-draw, rolling (e.g., press roll), redraw, or float. For example, FIG. 6 illustrates forming a glass ribbon by fusion down-draw while FIG. 7 illustrates forming a glass ribbon by rolling. In aspects, the glass-based substrate can be an amorphous substrate or a glass-ceramic. Glass-ceramics can be formed by heating a glass-based substrate to nucleate and/or grow crystals. In aspects, glass-ceramics can comprise anorthoclase or a feldspar solid solution crystal phase (e.g., primary).

The present disclosure relates to a viscous ribbon processing apparatus and methods of processing a viscous ribbon. Methods and apparatus for processing a viscous ribbon will now be described by way of example aspects for forming a viscous ribbon from a quantity of molten material. In aspects, as schematically illustrated in FIG. 5, a glass manufacturing apparatus 500 can comprise a glass melting and delivery apparatus 502 and a forming apparatus 501 comprising a supply vessel 540 designed to produce a ribbon 503 from a quantity of molten material 521. In aspects, the ribbon 503 can comprise a central portion 552 positioned between opposite edge portions (e.g., edge beads) formed along a first outer edge 553 and a second outer edge 555 of the ribbon 503, wherein a thickness of the edge beads can be greater than a thickness of the central portion. Additionally, in aspects, a separated glass ribbon (e.g., glass-based substrate 103) can be separated from the ribbon 503 along a separation path 551 by a glass separator 549 (e.g., scribe, score wheel, diamond tip, laser, etc.). In aspects, before or after separation of the separated glass ribbon (e.g., glass-based substrate 103) from the ribbon 503, the edge beads formed along the first outer edge 553 and the second outer edge 555 can be removed to provide the central portion 552 as a high-quality separated glass ribbon (e.g., glass-based substrate 103) having a uniform thickness.

In aspects, the glass melting and delivery apparatus 502 can comprise a melting vessel 505 oriented to receive batch material 507 from a storage bin 509. The batch material 507 can be introduced by a batch delivery device 511 powered by a motor 513 (e.g., activated by optional controller 515 to introduce the batch material 507 into the melting vessel 505, as indicated by arrow 517). The melting vessel 505 can heat the batch material 507 to provide molten material 521. In aspects, a melt probe 519 can be employed to measure a level of molten material 521 within a standpipe 523 and communicate the measured information to the controller 515 by way of a communication line 525. Additionally, in aspects, the glass melting and delivery apparatus 502 can comprise a fining vessel 527 located downstream from the melting vessel 505. In aspects, the molten material 521 can be gravity fed from the melting vessel 505 to the fining vessel 527 by a first connecting conduit 529. Additionally, bubbles can be removed from the molten material 521 within the fining vessel 527 by various techniques. In aspects, the glass melting and delivery apparatus 502 can further comprise a mixing chamber 531 located downstream from the fining vessel 527. The mixing chamber 531 can provide a homogenous composition of molten material 521, thereby reducing or eliminating inhomogeneity that may otherwise exist within the molten material 521 exiting the fining vessel 527. In aspects, molten material 521 can be gravity fed from the fining vessel 527 to the mixing chamber 531 by a second connecting conduit 535. Additionally, in aspects, the glass melting and delivery apparatus 502 can comprise a delivery vessel 533 located downstream from the mixing chamber 531. In aspects, the delivery vessel 533 can condition the molten material 521 to be fed into an inlet conduit 541. For example, the delivery vessel 533 can function as an accumulator and/or flow controller to adjust and provide a consistent flow of molten material 521 to the inlet conduit 541. In aspects, molten material 521 can be gravity fed from the mixing chamber 531 to the delivery vessel 533 by way of a third connecting conduit 537. As further illustrated, in aspects, a delivery pipe 539 can be positioned to deliver molten material 521 to forming apparatus 501, for example the inlet conduit 541 of the supply vessel 540.

Forming apparatus can comprise various aspects of supply vessels in accordance with aspects of the disclosure. For example, as shown in FIGS. 5-7, forming apparatus 501 can comprise a supply vessel with a wedge for fusion drawing the ribbon, a supply vessel with a slot to slot draw the ribbon, or a supply vessel 701 provided with rollers 707, 709 (e.g., to press roll the ribbon from the supply vessel). As shown in FIGS. 5-6, the supply vessel 540 shown and disclosed below can be provided to fusion draw molten material (e.g., molten material 521) off a bottom edge, defined as a root 545, of a forming wedge 609 to produce a ribbon of molten material 521 that can be drawn into the ribbon 503. For example, in aspects, the molten material 521 can be delivered from the inlet conduit 541 to the supply vessel 540. The molten material 521 can then be formed into the ribbon 503 based on the structure of the supply vessel 540. For example, as shown, the molten material 521 can be drawn off the bottom edge (e.g., root 545) of the supply vessel 540 along a draw path extending in a draw direction 554 of the glass manufacturing apparatus 500. In aspects, edge directors 563, 564 can direct the molten material 521 off the supply vessel 540 and define, in part, a width “W” of the ribbon 503. In aspects, the width “W” of the ribbon 503 extends between the first outer edge 553 of the ribbon 503 and the second outer edge 555 of the ribbon 503.

FIG. 6 shows a cross-sectional perspective view of the forming apparatus 501 (e.g., supply vessel 540) along line 6-6 of FIG. 5. In aspects, the supply vessel 540 can comprise a trough 601 oriented to receive the molten material 521 from the inlet conduit 541. For illustrative purposes, cross-hatching of the molten material 521 is removed from FIG. 6 for clarity. The supply vessel 540 can further comprise the forming wedge 609 comprising a pair of downwardly inclined converging surface portions 607, 608 extending between opposed ends 610, 611 (See FIG. 5) of the forming wedge 609. The pair of downwardly inclined converging surface portions 607, 608 of the forming wedge 609 can converge along the draw direction 554 to intersect along the root 545 of the supply vessel 540. A draw plane 613 of the glass manufacturing apparatus 500 can extend through the root 545 along the draw direction 554. In aspects, the ribbon 503 can be drawn in the draw direction 554 along the draw plane 613. As shown, the draw plane 613 can bisect the forming wedge 609 through the root 545 although, in aspects, the draw plane 613 can extend at other orientations relative to the root 545.

Additionally, in aspects, the molten material 521 can flow in a direction 556 into and along the trough 601 of the supply vessel 540. The molten material 521 can then overflow from the trough 601 by simultaneously flowing over corresponding weirs 603, 604 and downward over the outer surfaces 605, 606 of the corresponding weirs 603, 604. Respective streams of molten material 521 can then flow along the downwardly inclined converging surface portions 607, 608 of the forming wedge 609 to be drawn off the root 545 of the supply vessel 540, where the flows converge and fuse into the ribbon 503. The ribbon 503 of molten material can then be drawn off the root 545 in the draw plane 613 along the draw direction 554. In aspects, the ribbon 503 comprises one or more states of material based on a vertical location of the ribbon 503. For example, at one location, the ribbon 503 can comprise the viscous molten material (e.g., molten material 521), such that the ribbon 503 comprises a viscous ribbon, and at another location, the ribbon 503 can comprise an amorphous solid in a glassy state (e.g., a glass ribbon). The ribbon 503 comprises a first major surface 615 and a second major surface 616 facing opposite directions and defining a thickness “T” (e.g., average thickness) of the ribbon 503. In aspects, the thickness “T” of the ribbon 503 can be within one or more of the ranges discussed above for the substrate thickness t of the glass-based substrate 103.

Alternatively, (instead of the supply vessel 540 having the forming wedge 609 comprising the downwardly inclined converging surface portions 607, 608 and the root 545, where the molten material 521 can overflow and run down the downwardly inclined converging surface portions 607, 608 to be formed into the ribbon 503 from the root 145 as shown in FIGS. 5-6), FIG. 7 illustrates another method of forming the glass ribbon by rolling the molten material, where the glass-manufacturing apparatus 500 or 501 shown in FIG. 5 can provide the molten material 521 or 703. In aspects, the ribbon can be formed from a supply vessel 701 with a slot to slot draw the ribbon. For example, the supply vessel 701 may be hollow and can contain molten material. In aspects, an outlet tube 703 can be coupled to the supply vessel 701 and may define a passageway through which molten material 705 can exit the supply vessel 701. For example, the molten material 705 can flow from the supply vessel 701 and through the outlet tube 703, wherein the outlet tube 703 can comprise a slot (e.g., an opening, a hole, etc.) through which the molten material 705 can exit the outlet tube 703. In aspects, the outlet tube 703 can be oriented along a direction of gravity, such that the molten material 705 can flow downwardly along the direction of gravity through the outlet tube 703. The outlet tube 703 can be positioned above a pair of forming rolls 707, 709. The forming rolls 707, 709 can be spaced apart from each other to form a gap between the forming rolls 707, 709. In aspects, the forming rolls 707, 709 can rotate counter to each other. For example, in the orientation shown in FIG. 7, one forming roll 707 can rotate in a clockwise direction while the other forming roll 709 can rotate in a counter-clockwise direction. In aspects, the molten material 705 may be delivered from the outlet tube 703 to a location between the forming rolls 707, 709. The molten material 705 can accumulate between the forming rolls 707, 709, whereupon the forming rolls 707, 709 can rotate to flatten, thin, and smooth the stream of molten material 705 into a ribbon 711. In this way, the forming rolls 707, 709 can direct the molten material 705 from the outlet tube 703 and through the gap. The ribbon 711 can exit the forming rolls 707, 709 and may be delivered to a pair of pulling rolls 713, 715. The pulling rolls 713, 715 can pull downwardly on the ribbon 711 and, in aspects, can generate a tension in the ribbon 711 to stabilize and/or stretch the ribbon 711. In aspects, the pulling rolls 713, 715 can rotate counter to each other. For example, in the orientation shown in FIG. 7, one pulling roll 713 can rotate in a clockwise direction while the other pulling roll 715 can rotate in a counter-clockwise direction. In aspects, the ribbon 711 can move along a travel path 717 in a travel direction 719. In aspects, the ribbon 711 can comprise one or more states of material based on the vertical location of the ribbon 711. For example, at one location (e.g., directly below the forming rolls 707, 709), the ribbon 711 can comprise the viscous molten material (e.g., molten material 705), such that the ribbon 711 comprises a viscous ribbon. At another location (e.g., directly above the pulling rolls 713, 715), the ribbon 711 can comprise an amorphous solid in a glassy state.

In aspects, as discussed above with reference to FIG. 5, methods of making the glass-based substrate 103 and/or the glass-based article 100 (see FIG. 1) can comprise heating raw materials (e.g., batch material 507) in a melting vessel 505 to form a melt comprising the molten material 521. In aspects, as shown in FIGS. 5-7, the melt comprising the molten material 521 or 703 can be formed into a ribbon 503 or 711. In further aspects, as shown in FIGS. 5-6, the ribbon 503 can be formed using fusion down-draw. In even further aspects, a liquidus viscosity of the molten material can be within one or more of the ranges discussed above (e.g., greater than or equal to 40 kP or greater than or equal to 100 kP). Alternatively, the ribbon 711 can be formed by rolling the molten material 703 (e.g., with rollers 707, 709). In further aspects, a viscosity of the molt material supplied to the rollers 707, 709 can be from 1000 Poise to 100,000 Poise, from 1,000 Poise to 50,000 Poise, from 1,000 Poise to 10,000 Poise, from 1,000 Poise to 2,000 Poise, or any range or subrange therebetween. In aspects, the ribbon 503 or 711 can be cooled to form a ribbon (e.g., glass ribbon 503) that can, in further aspects, be separated into glass-based substrates (e.g., glass-based substrate 103). In aspects, the glass-based substrate can be annealed before being chemically strengthened.

In aspects, the glass-based substrate can be chemically strengthened by exposing the glass-based substrate to one or more ion-exchange medium(s) (e.g., molten salt solutions). The exchange medium(s) can include a molten nitrate salt (e.g., KNO₃, NaNO₃, or combinations thereof), for example, as a molten salt solution, although other sodium salts and/or potassium salts may be used in the ion-exchange medium, such as, for example sodium or potassium nitrites, phosphates, or sulfates. The ion-exchange medium may additionally include additives commonly included when ion exchanging glass, such as silicic acid. In aspects, the ion-exchange medium may include a mixture of sodium and potassium (e.g., including both NaNO₃ and KNO₃). Alternatively, the molten salt solution can be substantially free of sodium salts and/or consist essentially of potassium salts. In aspects, the ion-exchange medium comprises KNO₃. In aspects, the ion-exchange medium may include KNO₃ in an amount of 95 wt % or less, 90 wt % or less, 80 wt % or less, 70 wt % or less, 60 wt % or less, 50 wt % or less, 40 wt % or less, 30 wt % or less, 20 wt % or less, 10 wt % or less, 5 wt % or more, 10 wt % or more, 20 wt % or more, 30 wt % or more, 40 wt % or more, 50 wt % or more, 60 wt % or more, 70 wt % or more, 80 wt % or more, or 90 wt % or more. In aspects, the ion-exchange medium may include KNO₃ in an amount from 0 wt % to 100 wt %, from greater than or equal to 10 wt % to less than or equal to 90 wt %, from greater than or equal to 20 wt % to less than or equal to 80 wt %, from greater than or equal to 30 wt % to less than or equal to 70 wt %, from greater than or equal to 40 wt % to less than or equal to 60 wt %, or any range or subrange therebetween. In aspects, the molten ion-exchange medium includes 98 wt % KNO₃, 99 wt % KNO₃, or 100 wt % KNO₃.

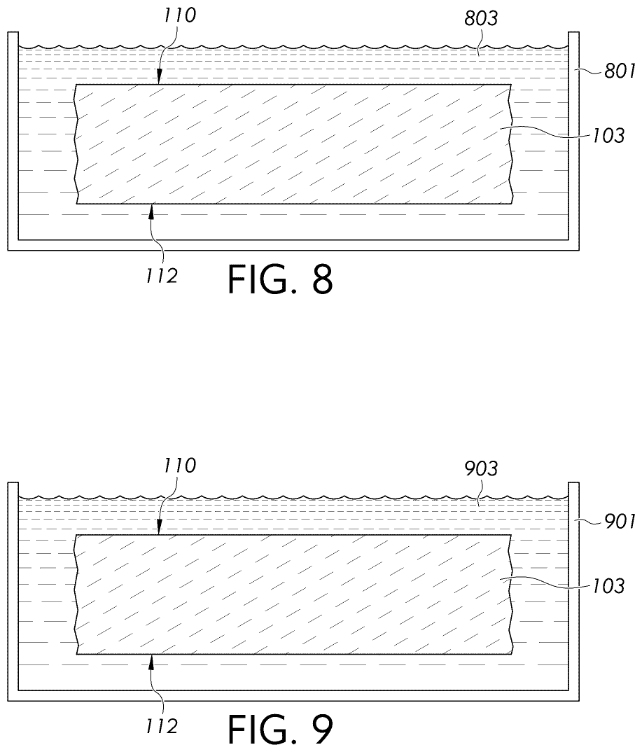

In aspects, as shown in FIG. 8, the glass-based substrate 103 can be exposed to a molten salt solution 803 (e.g., contained in a salt bath 801), for example, by immersing the glass-based substrate 103 in the molten salt solution 803. Alternatively, although not shown, can comprise spraying the ion-exchange medium onto a glass substrate made from the glass composition or otherwise physically applying the ion-exchange medium to the glass-based to form the ion-exchanged glass-based article. In further aspects, the ion-exchange medium (e.g., molten salt solution 803) can be maintained at a predetermined temperature and/or the glass-based substrate 103 can be in contact with the ion-exchange medium (e.g., molten salt solution 803) for a predetermined period of time. In further aspects, the predetermined temperature can be 350° C. or more, 370° C. or more, 380° C. or more, 390° C. or more, 400° C. or more, 410° C. or more, 420° C. or more, 430° C. or more, 440° C. or more, 530° C. or less, 500° C. or less, 480° C. or less, 460° C. or less, 440° C. or less, or 430° C. or less. In further aspects, the predetermined temperature can be in a range from greater than or equal to 350° C. to less than or equal to 530° C., from greater than or equal to 370° C. to less than or equal to 500° C., from greater than or equal to 380° C. to less than or equal to 480° C., from greater than or equal to 390° C. to less than or equal to 460° C., from greater than or equal to 400° C. to less than or equal to 440° C., from greater than or equal to 410° C. to less than or equal to 430° C., or any range or subrange therebetween. In further aspects, the predetermined period of time can be 5 minutes or more, 10 minutes or more, 0.25 hours or more, 0.5 hours or more, 1 hour or more, 2 hours or more, 4 hours or more, 24 hours or less, 8 hours or less, 4 hours or less, 3 hours or less, or 2 hours or less. In aspects, the predetermined period of time can be in a range from greater than or equal to 5 minutes to less than or equal to 24 hours, from greater than or equal to 10 minutes to less than or equal to 24 hours, from greater than or equal to 0.25 hours to less than or equal to 8 hours, from greater than or equal to 0.5 hours to less than or equal to 8 hours, from greater than or equal to 1 hour to less than or equal to 4 hours, or any range or subrange therebetween. In aspects, after chemically strengthening the glass-based substrate to form the glass-based article, the compressive stress region(s) of the glass-based article can be within one or more of the ranges discussed above for the first and/or second maximum compressive stress region (e.g., greater than or equal to 800 MPa, from 1,100 MPa to 1,600 MPa, or from 1,300 MPa to 1,450 MPa).

In aspects, the ion-exchange process may include a second ion-exchange treatment. In further aspects, the second ion-exchange treatment may include ion exchanging the glass-based article in a second molten salt bath. The second ion-exchange treatment may utilize any of the ion-exchange mediums described herein. In aspects, the second ion-exchange treatment utilizes a second molten salt bath that includes KNO₃. Alternatively, in aspects, the glass-based article may be chemically strengthened in a single molten salt solution.

The ion-exchange process may be performed in an ion-exchange medium under processing conditions that provide an improved compressive stress profile as disclosed, for example, in U.S. Patent Application Publication No. 2016/0102011, which is incorporated herein by reference in its entirety. In aspects, the ion-exchange process may be selected to form a parabolic stress profile in the glass-based articles, such as those stress profiles described in U.S. Patent Application Publication No. 2016/0102014, which is incorporated herein by reference in its entirety. After an ion-exchange process is performed, it should be understood that a composition at the surface of an ion-exchanged glass-based article can be different than the composition of the as-formed glass substrate (i.e., the glass substrate before it undergoes an ion-exchange process). This results from one type of alkali metal ion in the as-formed glass substrate, such as, for example Li⁺ or Na⁺, being replaced with larger alkali metal ions, such as, for example Na⁺ or K⁺, respectively. However, the glass composition at or near the center of the depth of the glass-based article will, in aspects, still have the composition of the as-formed non-ion-exchanged glass substrate used to form the glass-based article. As used herein, the center of the glass-based article refers to any location in the glass-based article that is a distance of about 0.5t from every surface thereof, where t is the corresponding thickness.

In aspects, after being chemically strengthened, the glass-based article 103 can be etched by being contacted with an etchant 903, as shown in FIG. 9. In further aspects, as shown, the etchant 903 can be contained in an etchant bath 901, and the glass-based article 103 can be immersed in the etchant 903 in the etchant batch 901, although etching can occur by other processes, for example, spraying etchant on one or more surfaces of the glass-based article 103, in further aspects. In further aspects, a temperature of the etchant 903 can be 20° C. or more, 22° C. or more, 25° C. or more 28° C. or more, 30° C. or more, 40° C. or less, 35° C. or less, 30° C. or less, 28° C. or less, or 25° C. or less. In aspects, the second temperature of the etchant 903 can range from 20° C. to 40° C., from 20° C. to 35° C., from 20° C. to 30° C., from 20° C. to 28° C., from 22° C. to 25° C., or any range or subrange therebetween. In further aspects, the etchant can be an alkaline solution or an acidic solution. In even further aspects, the glass-based article can be contacted with an alkaline solution before being contacted by an acidic solution. As used herein, a pH of a solution is measured in accordance with ASTM E70-90 at 25° C. with standard solutions extending to a pH of at least 14.

In even further aspects, the alkaline solution (e.g., etchant 903) can comprise an alkaline detergent and/or a pH of 11 or more, 12 or more, 12.5 or more, 12.8 or more, 14 or less, 13.5 or less, or 13.2 or less. In aspects, the alkaline solution (e.g., etchant 903) can comprise a pH ranging from 11 to 14, from 12 to 14, from 12.5 to 13.5, from 12.8 to 13.2, or any range or subrange therebetween. In aspects, the alkaline solution (e.g., etchant 903) can comprise an alkaline detergent in a concentration from 0.5 wt % or more, 1 wt % or more, 1.5 wt % or more, 2 wt % or more, 4 wt % or less, 3 wt % or less, or 2.5 wt % or less. In aspects, the alkaline solution (e.g., etchant 903) can comprise an alkaline detergent in a concentration ranging from 0.5 wt % to 4 wt %, from 1 wt % to 4 wt %, from 1.5 wt % to 3 wt %, from 2 wt % to 3 wt %, from 2.5 wt % to 3 wt %, or any range or subrange therebetween. An exemplary aspect of an alkaline detergent solution includes SemiClean KG (Yokohama Oils & Fats Industry Co.). Alternatively or additionally, the alkaline solution can comprise an alkaline hydroxide (e.g., KOH, NaOH). Providing the alkaline solution may selectively act on surface flaws (e.g., removing, rounding, blunting) before removing material from other parts of the surface, which can increase the impact resistance of the substrate without removing a substantial thickness from the surface of the foldable substrate.

In even further aspects, a pH of the acidic solution (e.g., etchant 903) can be 1.0 or more, 2.0 or more, 3.5 or more, 3.6 or more, 3.7 or more, 3.8 or more, 4.5 or less, 4.3 or less, 4.0 or less, 3.9 or less, 3.8 or less, or 3.7 or less. In aspects, a pH of acidic solution (e.g., etchant 903) can be in a range from 1.0 to 4.5, from 2.0 to 4.3, from 3.0 to 4.0, from 3.5 to 3.9, from 3.6 to 3.8, from 3.7 to 3.8, or any range or subrange therebetween. Providing the acidic solution (e.g., etchant) can uniformly remove material from the surface to produce a relatively uniform compressive stress and thickness across the foldable substrate.

### EXAMPLES

Embodiments will be further clarified by the following examples. It should be understood that these examples are not limiting to the aspects described above. Glass compositions were prepared and analyzed. The analyzed glass compositions included the components listed in Table I below and were prepared by conventional glass forming methods. As mentioned above, the compositions reported herein (including Table I) refer to the composition of the resulting glass-based substrate in mol %. The Poisson's ratio (v), the Young's modulus (E), and the shear modulus (G) of the glass compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.” The refractive index at 589.3 nm and stress optical coefficient (SOC) of the substrates are also reported in Table I. The density of the glass compositions was determined using the buoyancy method of ASTM C693-93 (2013). The term “annealing point,” as used herein, refers to the temperature at which the viscosity of the glass composition is 1×10^{13.18} poise. The term “strain point,” as used herein, refers to the temperature at which the viscosity of the glass composition is 1×10^{14.68} poise. The strain point and annealing point of the glass compositions was determined using the fiber elongation method of ASTM C336-71 (2015) or the beam bending viscosity (BBV) method of ASTM C598-93 (2013). The term “softening point,” as used herein, refers to the temperature at which the viscosity of the glass composition is 1×10^{7.6} poise. The softening point of the glass compositions was determined using the fiber elongation method of ASTM C336-71 (2015) or a parallel plate viscosity (PPV) method which measures the viscosity of inorganic glass from 10⁷ to 10⁹ poise as a function of temperature, similar to ASTM C1351M. The linear coefficient of thermal expansion (CTE) over the temperature range 0-300° C. is expressed in terms of ppm/° C. and was determined using a push-rod dilatometer in accordance with ASTM E228-11.

TABLE I

| Composition | | 1 | 2 | 3 | 4 | 5 | 6 |
|---|---|---|---|---|---|---|---|
| SiO₂ | | 62.41 | 63.14 | 62.24 | 62.98 | 62.79 | 63.37 |
| Al₂O₃ | | 14.81 | 14.52 | 15.32 | 14.32 | 14.16 | 13.87 |
| MgO | | 4.68 | 4.61 | 4.58 | 4.69 | 4.70 | 4.74 |
| CaO | | 0.04 | 0.04 | 0.04 | 0.05 | 0.04 | 0.04 |
| Li₂O | | 0.00 | 0.00 | 0.00 | 0.00 | 0.00 | 0.00 |
| Na₂O | | 17.87 | 17.51 | 17.63 | 17.78 | 18.11 | 17.79 |
| K₂O | | 0.01 | 0.01 | 0.01 | 0.01 | 0.01 | 0.01 |
| SnO₂ | | 0.18 | 0.17 | 0.17 | 0.17 | 0.17 | 0.17 |
| Fe₂O₃ | | 0.01 | 0.01 | 0.01 | 0.01 | 0.01 | 0.01 |
| RO | | 4.72 | 4.65 | 4.62 | 4.74 | 4.74 | 4.78 |
| R₂O | | 17.88 | 17.52 | 17.64 | 17.79 | 18.12 | 17.80 |
| Al₂O₃ + RO | | 19.53 | 19.17 | 19.94 | 19.06 | 18.90 | 18.65 |
| R₂O + RO | | 22.60 | 22.17 | 22.26 | 22.53 | 22.86 | 22.58 |
| R₂O + RO − Al₂O₃ | | 0.13 | 0.25 | 0.38 | 0.30 | 8.70 | 8.71 |
| (R₂O + RO)/Al₂O₃ | | 1.526 | 1.527 | 1.453 | 1.573 | 1.614 | 1.628 |
| R | | 0.753 | 0.742 | 0.763 | 0.740 | 0.739 | 0.729 |
| Density (g/cm³) | | 2.466 | 2.462 | 2.467 | 2.463 | 2.466 | 2.463 |
| CTE 0-300° C. | | 88.8 | 87.0 | 87.7 | 88.8 | 90.5 | 89.3 |
| (ppm/° C.) | | | | | | | |
| Fiber | Strain | 631 | 632 | 639 | 624 | 618 | 625 |
| Elongation | Point (° C.) | | | | | | |
| | Annealing | 684 | 685 | 693 | 678 | 670 | 678 |
| | Point (° C.) | | | | | | |
| | Softening | 931 | 929 | 937 | 918 | 910 | 921 |
| | Point (° C.) | | | | | | |

| Composition | | 1 | 2 | 3 | 4 | 5 | 6 |
|---|---|---|---|---|---|---|---|
| Young's Modulus | | 72.5 | 72.3 | 73.0 | 72.3 | 72.0 | 72.1 |
| (GPa) | | | | | | | |
| Shear Modulus | | 29.9 | 29.9 | 30.1 | 29.9 | 29.8 | 29.8 |
| (GPa) | | | | | | | |
| Poisson's ratio | | 0.210 | 0.208 | 0.213 | 0.211 | 0.208 | 0.211 |
| Refractive Index | | 1.5061 | 1.5060 | 1.5072 | 1.5060 | 1.5059 | 1.5057 |
| Stress Optical | | 2.956 | 2.958 | 2.964 | 2.964 | 2.954 | 2.958 |
| Coefficient | | | | | | | |
| VFT | A | −2.991 | −2.975 | −3.144 | −2.893 | −2.788 | −2.878 |
| | B | 7676.3 | 7719.9 | 7965.8 | 7536.1 | 7613.8 | 7543.3 |
| | Tₒ | 186.5 | 183.0 | 183.6 | 186.3 | 188.2 | 185.3 |
| Liquidus | Air | 1135 | 1120 | 1150 | 1100 | 1095 | 1115 |
| Temp | Internal | 1120 | 1110 | 1140 | 1080 | 1065 | 1100 |
| (° C.) | Platinum | 1100 | 1095 | 1125 | 1075 | 1050 | 1085 |
| Liquidus | Primary | Nepheline | Nepheline | Nepheline | Nepheline | Nepheline | Nepheline |
| Phase | Phase | | | | | | |
| | Secondary | Feldspar | Feldspar | Feldspar | Feldspar | Feldspar | |
| | Phase | | | | | | |
| Liquidus | Internal | 171 | 225 | 153 | 347 | 405 | 234 |
| Viscosity | | | | | | | |
| (kP) | | | | | | | |

| Composition | | 7 | 8 | 9 | 10 | 11 | 12 |
|---|---|---|---|---|---|---|---|
| SiO₂ | | 63.35 | 63.75 | 63.72 | 63.96 | 63.62 | 63.86 |
| Al₂O₃ | | 14.16 | 13.98 | 14.33 | 14.16 | 14.66 | 14.53 |
| MgO | | 4.65 | 4.51 | 4.41 | 4.30 | 4.31 | 4.20 |
| CaO | | 0.04 | 0.04 | 0.05 | 0.04 | 0.04 | 0.04 |
| Li₂O | | 0.00 | 0.00 | 0.00 | 0.00 | 0.00 | 0.00 |
| Na₂O | | 17.61 | 17.53 | 17.32 | 17.37 | 17.19 | 17.18 |
| K₂O | | 0.01 | 0.01 | 0.01 | 0.01 | 0.01 | 0.01 |
| SnO₂ | | 0.17 | 0.17 | 0.17 | 0.17 | 0.17 | 0.17 |
| Fe₂O₃ | | 0.01 | 0.01 | 0.01 | 0.01 | 0.01 | 0.01 |
| RO | | 4.69 | 4.55 | 4.45 | 4.34 | 4.35 | 4.24 |
| R₂O | | 17.62 | 17.54 | 17.33 | 17.38 | 17.20 | 17.19 |
| Al₂O₃ + RO | | 18.85 | 18.53 | 18.78 | 18.50 | 19.01 | 18.77 |
| R₂O + RO | | 22.31 | 22.09 | 21.78 | 21.72 | 21.55 | 21.43 |
| R₂O + RO − Al₂O₃ | | 8.15 | 8.11 | 7.45 | 7.56 | 6.89 | 6.90 |
| (R₂O + RO)/Al₂O₃ | | 1.576 | 1.580 | 1.520 | 1.534 | 1.470 | 1.475 |
| R | | 0.734 | 0.727 | 0.734 | 0.729 | 0.740 | 0.736 |
| Density (g/cm³) | | 2.463 | 2.460 | 2.459 | 2.458 | 2.459 | 2.457 |
| CTE 0-300° C. | | 88.5 | 87.8 | 87.7 | 87.8 | 86.7 | 86.4 |
| (ppm/° C.) | | | | | | | |
| Fiber | Strain | 618 | 622 | 633 | 634 | 635 | 625 |
| Elongation | Point (° C.) | | | | | | |
| | Annealing | 671 | 676 | 687 | 689 | 690 | 681 |
| | Point (° C.) | | | | | | |
| | Softening | 910 | 917 | 933 | 938 | 937 | 927 |
| | Point (° C.) | | | | | | |

| Composition | | 7 | 8 | 9 | 10 | 11 | 12 |
|---|---|---|---|---|---|---|---|
| Young's Modulus | | 72.3 | 72.1 | 72.1 | 72.1 | 72.3 | 72.3 |
| (GPa) | | | | | | | |
| Shear Modulus | | 29.9 | 29.7 | 29.8 | 29.7 | 29.9 | 29.9 |
| (GPa) | | | | | | | |
| Poisson's ratio | | 0.211 | 0.211 | 0.209 | 0.212 | 0.210 | 0.208 |
| Refractive Index | | 1.4875 | 1.5060 | 1.5053 | 1.5050 | 1.5054 | 1.5049 |
| Stress Optical | | 2.947 | 2.961 | 2.974 | 2.973 | 2.968 | 2.980 |
| Coefficient | | | | | | | |
| VFT | A | −2.812 | −2.852 | −2.961 | −3.056 | −3.027 | −2.917 |
| | B | 7361 | 7542.7 | 7765.7 | 7952.6 | 7931.3 | 7710.7 |
| | Tₒ | 189.0 | 182.6 | 178.8 | 176.5 | 174.6 | 177.8 |
| Liquidus | Air | 1080 | 1080 | 1100 | 1130 | 1115 | 1090 |
| Temp | Internal | 1070 | 1070 | 1090 | 1115 | 1105 | 1080 |
| (° C.) | Platinum | 1055 | 1065 | 1085 | 1090 | 1090 | 1070 |
| Liquidus | Primary | Nepheline | Nepheline | Nepheline | Nepheline | Nepheline | Nepheline |
| Phase | Phase | | | | | | |
| | Secondary | Feldspar | | | | | |
| | Phase | | | | | | |
| Liquidus | Internal | 349 | 444 | 365 | 262 | 314 | 426 |
| Viscosity | | | | | | | |
| (kP) | | | | | | | |

| Composition | | 13 | 14 | 15 | 16 | 17 | 18 |
|---|---|---|---|---|---|---|---|
| SiO₂ | | 63.48 | 63.86 | 63.15 | 63.58 | 62.98 | 63.50 |
| Al₂O₃ | | 15.02 | 14.87 | 15.41 | 15.23 | 15.80 | 15.61 |
| MgO | | 4.25 | 4.11 | 4.25 | 4.12 | 4.21 | 4.04 |
| CaO | | 0.04 | 0.05 | 0.04 | 0.04 | 0.04 | 0.04 |
| Li₂O | | 0.00 | 0.00 | 0.00 | 0.00 | 0.00 | 0.00 |
| Na₂O | | 17.02 | 16.92 | 16.96 | 16.84 | 16.78 | 16.63 |
| K₂O | | 0.01 | 0.01 | 0.01 | 0.01 | 0.01 | 0.00 |
| SnO₂ | | 0.17 | 0.17 | 0.17 | 0.18 | 0.17 | 0.17 |
| Fe₂O₃ | | 0.01 | 0.01 | 0.01 | 0.01 | 0.01 | 0.01 |
| RO | | 4.29 | 4.15 | 4.29 | 4.16 | 4.25 | 4.08 |
| R₂O | | 17.02 | 16.93 | 16.97 | 16.85 | 16.79 | 16.63 |
| Al₂O₃ + RO | | 19.31 | 19.02 | 19.70 | 19.39 | 20.05 | 19.69 |
| R₂O + RO | | 21.31 | 21.08 | 21.26 | 21.01 | 21.04 | 20.71 |
| R₂O + RO − Al₂O₃ | | 6.29 | 6.21 | 5.85 | 5.78 | 5.24 | 5.10 |
| (R₂O + RO)/Al₂O₃ | | 1.419 | 1.418 | 1.380 | 1.380 | 1.332 | 1.327 |
| R | | 0.747 | 0.742 | 0.756 | 0.750 | 0.764 | 0.757 |
| Density (g/cm³) | | 2.459 | 2.457 | 2.460 | 2.458 | 2.460 | 2.457 |
| CTE 0-300° C. | | 86.7 | 85.9 | 85.4 | 85.1 | 85.0 | 84.7 |
| (ppm/° C.) | | | | | | | |
| Fiber | Strain | 645 | 642 | 649 | 654 | 656 | 650 |
| Elongation | Point (° C.) | | | | | | |
| | Annealing | 699 | 697 | 704 | 709 | 712 | 704 |
| | Point (° C.) | | | | | | |
| | Softening | 949 | 946 | 957 | 963 | 964 | 958 |
| | Point (° C.) | | | | | | |

| Composition | | 13 | 14 | 15 | 16 | 17 | 18 |
|---|---|---|---|---|---|---|---|
| Young's Modulus | | 72.2 | 72.2 | 72.3 | 72.6 | 73.4 | 72.3 |
| (GPa) | | | | | | | |
| Shear Modulus | | 29.9 | 30.0 | 29.9 | 30.1 | 30.2 | 30.3 |
| (GPa) | | | | | | | |
| Poisson's ratio | | 0.207 | 0.204 | 0.206 | 0.208 | 0.215 | 0.195 |
| Refractive Index | | 1.5056 | 1.5051 | 1.5059 | 1.5048 | 1.5056 | 1.5056 |
| Stress Optical | | 2.984 | 2.980 | 2.963 | 2.996 | 2.981 | 2.955 |
| Coefficient | | | | | | | |
| VFT | A | −3.160 | −3.141 | −3.233 | −3.372 | −3.348 | −3.258 |
| | B | 8149.2 | 8166.5 | 8318.3 | 8520.3 | 8546.3 | 8310.4 |
| | Tₒ | 175.1 | 171.9 | 172.1 | 174.7 | 170.5 | 175.1 |
| Liquidus | Air | 1140 | 1130 | 1165 | 1145 | 1160 | 1135 |
| Temp | Internal | 1135 | 1115 | 1160 | 1135 | 1155 | 1135 |
| (° C.) | Platinum | 1115 | 1100 | 1150 | 1130 | 1145 | 1125 |
| Liquidus | Primary | Nepheline | Nepheline | Nepheline | Nepheline | Nepheline | Nepheline |
| Phase | Phase | | | | | | |
| | Secondary | | | | | | |
| | Phase | | | | | | |
| Liquidus | Internal | 214 | 329 | 154 | 317 | 215 | 251 |
| Viscosity | | | | | | | |
| (kP) | | | | | | | |

| Composition | | 19 | 20 | 21 | 22 | 23 | 24 |
|---|---|---|---|---|---|---|---|
| SiO₂ | | 62.15 | 62.77 | 63.22 | 61.89 | 62.20 | 62.51 |
| Al₂O₃ | | 16.35 | 16.18 | 16.01 | 17.92 | 17.77 | 17.54 |
| MgO | | 4.45 | 4.19 | 4.01 | 4.10 | 3.97 | 3.79 |
| CaO | | 0.05 | 0.04 | 0.04 | 0.04 | 0.04 | 0.05 |
| Li₂O | | 0.00 | 0.00 | 0.00 | 0.00 | 0.00 | 0.00 |
| Na₂O | | 16.82 | 16.62 | 16.53 | 15.87 | 15.83 | 15.94 |
| K₂O | | 0.01 | 0.01 | 0.01 | 0.00 | 0.00 | 0.00 |
| SnO₂ | | 0.17 | 0.17 | 0.17 | 0.17 | 0.17 | 0.17 |
| Fe₂O₃ | | 0.01 | 0.01 | 0.01 | 0.01 | 0.01 | 0.01 |
| RO | | 4.49 | 4.23 | 4.05 | 4.14 | 4.01 | 3.83 |
| R₂O | | 16.83 | 16.63 | 16.54 | 15.87 | 15.83 | 15.94 |
| Al₂O₃ + RO | | 20.84 | 20.41 | 20.06 | 22.06 | 21.78 | 21.37 |
| R₂O + RO | | 21.32 | 20.86 | 20.59 | 20.01 | 19.84 | 19.77 |
| R₂O + RO − Al₂O₃ | | 4.97 | 4.68 | 4.58 | 2.09 | 2.07 | 2.23 |
| (R₂O+ RO)/Al₂O₃ | | 1.304 | 1.289 | 1.286 | 1.117 | 1.116 | 1.127 |
| R | | 0.779 | 0.772 | 0.766 | 0.806 | 0.802 | 0.796 |
| Density (g/cm³) | | 2.465 | 2.461 | 2.458 | 2.465 | 2.463 | 2.462 |
| CTE 0-300° C. | | 84.0 | 83.9 | 84.0 | 83.9 | 83.4 | 78.6 |
| (ppm/° C.) | | | | | | | |
| Fiber | Strain | 661 | 664 | 682 | 680 | 682 | 662 |
| Elongation | Point (° C.) | | | | | | |
| | Annealing | 715 | 718 | 736 | 735 | 736 | 716 |
| | Point (° C.) | | | | | | |
| | Softening | 964 | 973 | 989 | 990 | 993 | 969 |
| | Point (° C.) | | | | | | |

| Composition | | 19 | 20 | 21 | 22 | 23 | 24 |
|---|---|---|---|---|---|---|---|
| Young's Modulus | | 73.8 | 73.1 | 72.9 | 74.7 | 74.5 | 74.3 |
| (GPa) | | | | | | | |
| Shear Modulus | | 30.3 | 30.2 | 30.1 | 30.9 | 30.8 | 30.7 |
| (GPa) | | | | | | | |
| Poisson's ratio | | 0.216 | 0.210 | 0.209 | 0.211 | 0.209 | 0.210 |
| Refractive Index | | 1.5071 | 1.5063 | 1.5058 | 15.079 | 1.5073 | 1.5070 |
| Stress Optical | | 3.001 | 2.988 | 3.002 | 2.993 | 2.999 | 2.988 |
| Coefficient | | | | | | | |
| VFT | A | −3.491 | −3.456 | −3.024 | −3.050 | −3.145 | −3.483 |
| | B | 8637.1 | 8731.9 | 7265.7 | 7382.0 | 7681.6 | 8717.7 |
| | Tₒ | 180.9 | 171.0 | 315.2 | 304.9 | 279.3 | 174.9 |
| Liquidus | Air | 1155 | 1145 | 1275 | 1275 | 1265 | 1155 |
| Temp | Internal | 1145 | 1145 | 1270 | 1265 | 1260 | 1155 |
| (° C.) | Platinum | 1145 | 1145 | 1150 | 1140 | 1265 | 1150 |
| Liquidus | Primary | Nepheline | Nepheline | Spinel | Spinel | Spinel | Nepheline |
| Phase | Phase | | | | | | |
| | Secondary | | | | | | |
| | Phase | | | | | | |
| Liquidus | Internal | 294 | 323 | 39 | 44 | 49 | 258 |
| Viscosity | | | | | | | |
| (kP) | | | | | | | |

| Composition | | 25 | 26 | 27 | 28 | 29 | 30 |
|---|---|---|---|---|---|---|---|
| SiO₂ | | 62.95 | 63.04 | 63.37 | 63.27 | 63.34 | 63.49 |
| Al₂O₃ | | 14.08 | 14.06 | 14.07 | 14.05 | 14.10 | 14.04 |
| MgO | | 4.76 | 4.76 | 3.64 | 4.73 | 3.67 | 2.56 |
| CaO | | 0.04 | 0.04 | 0.04 | 0.04 | 0.05 | 0.03 |
| Li₂O | | 1.11 | 2.02 | 2.07 | 3.00 | 2.97 | 3.05 |
| Na₂O | | 16.91 | 15.91 | 16.65 | 14.75 | 15.73 | 16.67 |
| K₂O | | 0.00 | 0.00 | 0.00 | 0.00 | 0.00 | 0.00 |
| SnO₂ | | 0.13 | 0.13 | 0.13 | 0.13 | 0.13 | 0.13 |
| Fe₂O₃ | | 0.01 | 0.01 | 0.00 | 0.01 | 0.00 | 0.00 |
| RO | | 4.80 | 4.80 | 3.68 | 4.77 | 3.71 | 2.59 |
| R₂O | | 18.02 | 17.93 | 18.72 | 17.75 | 18.70 | 19.72 |
| Al₂O₃ + RO | | 18.88 | 18.86 | 17.75 | 18.82 | 17.81 | 16.63 |
| R₂O + RO | | 22.82 | 22.73 | 22.40 | 22.52 | 22.41 | 22.31 |
| R₂O + RO − Al₂O₃ | | 8.74 | 8.67 | 8.33 | 8.47 | 8.31 | 8.27 |
| (R₂O + RO)/Al₂O₃ | | 1.621 | 1.617 | 1.592 | 1.603 | 1.589 | 1.589 |
| R | | 0.726 | 0.716 | 0.718 | 0.704937 | 0.710 | 0.712 |
| Density (g/cm³) | | 2.458 | 2.462 | 2.459 | 2.461 | 2.459 | 2.462 |
| CTE 0-300° C. | | 88.0 | 86.6 | 89.1 | 86.00 | 88.3 | 92.1 |
| (ppm/° C.) | | | | | | | |
| Fiber | Strain | 592 | 576 | 567 | 562 | 557 | 534 |
| Elongation | Point (° C.) | | | | | | |
| | Annealing | 644 | 626 | 617 | 612 | 607 | 583 |
| | Point (° C.) | | | | | | |
| | Softening | 883 | 865 | 856 | 851 | 846 | 822 |
| | Point (° C.) | | | | | | |

| Composition | | 25 | 26 | 27 | 28 | 29 | 30 |
|---|---|---|---|---|---|---|---|
| Young's Modulus | | 74.8 | 76.5 | 75.7 | 77.8 | 76.5 | 77.0 |
| (GPa) | | | | | | | |
| Shear Modulus | | 30.9 | 31.5 | 31.2 | 32.1 | 31.4 | 31.7 |
| (GPa) | | | | | | | |
| Poisson's ratio | | 0.210 | 0.213 | 0.213 | 0.214 | 0.215 | 0.213 |
| Refractive Index | | 1.5073 | 1.5094 | 1.5093 | 1.5102 | 1.5104 | 1.5098 |
| Stress Optical | | 2.871 | 2.901 | 2.873 | 2.856 | 2.840 | 2.828 |
| Coefficient | | | | | | | |
| VFT | A | −2.838 | −2.876 | −.955 | −2.863 | −2.777 | −2.662 |
| | B | 7610.4 | 7694.4 | 8057.3 | 7665.7 | 7718.9 | 7665.3 |
| | Tₒ | 145.4 | 120.2 | 78.5 | 101.1 | 73.0 | 51.8 |
| Liquidus | Air | 1105 | 1110 | 1050 | 1130 | 1025 | 1025 |
| Temp | Internal | 1100 | 1100 | 1040 | 1100 | 1010 | 1015 |
| (° C.) | Platinum | 1085 | 1080 | 1035 | 1075 | 1005 | 1035 |
| Liquidus | Primary | Forsterite | Forsterite | Forsterite | Nepheline | Forsterite | Nepheline |
| Phase | Phase | | | | | | |
| | Secondary | | | | | | |
| | Phase | | | | | | |
| Liquidus | Internal | 136 | 95 | 266 | 65 | 289 | 198 |
| Viscosity | | | | | | | |
| (kP) | | | | | | | |

| Composition | | 31 | 32 | 33 | 34 | 35 | 36 |
|---|---|---|---|---|---|---|---|
| SiO₂ | | 62.44 | 62.64 | 62.54 | 62.56 | 62.32 | 62.62 |
| Al₂O₃ | | 15.07 | 15.01 | 15.05 | 15.07 | 15.13 | 15.04 |
| MgO | | 4.39 | 4.41 | 3.37 | 4.43 | 3.47 | 2.32 |
| CaO | | 0.04 | 0.04 | 0.04 | 0.04 | 0.04 | 0.03 |
| Li₂O | | 1.12 | 2.10 | 2.11 | 3.07 | 3.05 | 3.05 |
| Na₂O | | 16.79 | 15.65 | 16.75 | 14.68 | 15.86 | 16.80 |
| K₂O | | 0.00 | 0.00 | 0.00 | 0.00 | 0.00 | 0.00 |
| SnO₂ | | 0.13 | 0.13 | 0.13 | 0.13 | 0.13 | 0.13 |
| Fe₂O₃ | | 0.01 | 0.01 | 0.00 | 0.01 | 0.00 | 0.00 |
| RO | | 4.43 | 4.45 | 3.41 | 4.47 | 3.51 | 2.35 |
| R₂O | | 17.91 | 17.75 | 18.86 | 17.75 | 18.91 | 19.85 |
| Al₂O₃ + RO | | 19.50 | 19.46 | 18.46 | 19.54 | 18.64 | 17.39 |
| R₂O + RO | | 22.34 | 22.20 | 22.27 | 22.22 | 22.42 | 22.20 |
| R₂O + RO − Al₂O₃ | | 7.27 | 7.19 | 7.22 | 7.15 | 7.29 | 7.16 |
| (R₂O + RO)/Al₂O₃ | | 1.482 | 1.479 | 1.480 | 1.474 | 1.482 | 1.476 |
| R | | 0.748 | 0.736 | 0.743 | 0.729 | 0.737 | 0.738 |
| Density (g/cm³) | | 2.463 | 2.463 | 2.464 | 2.461 | 2.465 | 2.461 |
| CTE 0-300° C. | | 88.5 | 86.9 | 89.1 | 85.0 | 88.6 | 92.1 |
| (ppm/° C.) | | | | | | | |
| Fiber | Strain | 615 | 591 | 579 | 579 | 548 | 56 |
| Elongation | Point (° C.) | | | | | | |
| | Annealing | 665 | 643 | 630 | 629 | 597 | 611 |
| | Point (° C.) | | | | | | |
| | Softening | 910 | 884 | 881 | 871 | 846 | 852 |
| | Point (° C.) | | | | | | |

| Composition | | 31 | 32 | 33 | 34 | 35 | 36 |
|---|---|---|---|---|---|---|---|
| Young's Modulus | | 75.3 | 76.9 | 76.1 | 78.2 | 77.2 | 76.7 |
| (GPa) | | | | | | | |
| Shear Modulus | | 31.0 | 31.6 | 31.3 | 32.2 | 31.8 | 31.6 |
| (GPa) | | | | | | | |
| Poisson's ratio | | 0.213 | 0.214 | 0.214 | 0.215 | 0.214 | 0.212 |
| Refractive Index | | 1.5081 | 1.5094 | 1.5086 | 1.5111 | 1.5105 | 15.096 |
| Stress Optical | | 2.893 | 2.895 | 2.891 | 2.863 | 2.855 | 2.846 |
| Coefficient | | | | | | | |
| VFT | A | −2.953 | −3.430 | −3.060 | −3.410 | −3.148 | −2.908 |
| | B | 7835.5 | 8979.9 | 8139.4 | 8924.3 | 8777.9 | 7923.3 |
| | Tₒ | 155.8 | 49.1 | 92.2 | 33.8 | −3.1 | 94.3 |
| Liquidus | Air | 1130 | 1130 | 1085 | 1110 | 1050 | 1065 |
| Temp | Internal | 1125 | 1100 | 1080 | 1105 | 1070 | 1050 |
| (° C.) | Platinum | 1105 | 1095 | 1070 | 1100 | 1065 | 1060 |
| Liquidus | Primary | Forsterite | Forsterite | Nepheline | Forsterite | Nepheline | Nepheline |
| Phase | Phase | | | | | | |
| | Secondary | | | | | | |
| | Phase | | | | | | |
| Liquidus | Internal | 135 | 130 | 151 | 83 | 108 | 241 |
| Viscosity | | | | | | | |
| (kP) | | | | | | | |

| Composition | | 37 | 38 | 39 | 40 | 41 | 42 |
|---|---|---|---|---|---|---|---|
| SiO₂ | | 62.03 | 62.02 | 61.87 | 62.32 | 62.23 | 61.87 |
| Al₂O₃ | | 16.03 | 16.04 | 16.08 | 15.99 | 16.02 | 16.06 |
| MgO | | 4.04 | 4.08 | 3.07 | 3.99 | 3.01 | 2.05 |
| CaO | | 0.04 | 0.04 | 0.03 | 0.05 | 0.03 | 0.03 |
| Li₂O | | 1.11 | 2.07 | 2.06 | 3.05 | 3.04 | 3.08 |
| Na₂O | | 16.61 | 15.60 | 16375 | 14.47 | 15.52 | 16.78 |
| K₂O | | 0.00 | 0.00 | 0.00 | 0.00 | 0.00 | 0.00 |
| SnO₂ | | 0.13 | 0.13 | 0.13 | 0.13 | 0.13 | 0.13 |
| Fe₂O₃ | | 0.01 | 0.01 | 0.00 | 0.01 | 0.00 | 0.00 |
| RO | | 4.08 | 4.12 | 3.10 | 4.03 | 3.04 | 2.08 |
| R₂O | | 17.72 | 17.67 | 18.81 | 17.52 | 18.56 | 19.86 |
| Al₂O₃ + RO | | 20.11 | 20.16 | 19.18 | 20.02 | 19.06 | 18.14 |
| R₂O + RO | | 21.80 | 21.79 | 21.91 | 21.55 | 21.60 | 21.94 |
| R₂O + RO − Al₂O₃ | | 5.77 | 5.75 | 5.83 | 5.56 | 5.58 | 5.88 |
| (R₂O + RO)/Al₂O₃ | | 1.360 | 1.358 | 1.363 | 1.348 | 1.348 | 1.366 |
| R | | 0.768 | 0.760 | 0.764 | 0.747 | 0.754 | 0.763 |
| Density (g/cm³) | | 2.465 | 2.462 | 2.462 | 2.462 | 2.461 | 2.466 |
| CTE 0-300° C. | | 86.5 | 84.9 | 88.9 | 83.7 | 88.4 | 91.9 |
| (ppm/° C.) | | | | | | | |
| Fiber | Strain | 622 | 611 | 596 | 584 | 564 | 594 |
| Elongation | Point (° C.) | | | | | | |
| | Annealing | 676 | 663 | 648 | 636 | 615 | 646 |
| | Point (° C.) | | | | | | |
| | Softening | 929 | 907 | 898 | 884 | 865 | 891 |
| | Point (° C.) | | | | | | |

| Composition | | 37 | 38 | 39 | 40 | 41 | 42 |
|---|---|---|---|---|---|---|---|
| Young's Modulus | | 75.6 | 77.2 | 76.4 | 78.5 | 77.4 | 76.9 |
| (GPa) | | | | | | | |
| Shear Modulus | | 31.2 | 31.9 | 31.6 | 62.4 | 62.3 | 31.8 |
| (GPa) | | | | | | | |
| Poisson's ratio | | 0.211 | 0.211 | 0.210 | 0.213 | 0.200 | 0.210 |
| Refractive Index | | 1.5080 | 1.5095 | 1.5097 | 1.5103 | 1.5101 | 1.5091 |
| Stress Optical | | 2.904 | 2.895 | 2.882 | 2.870 | 2.856 | 2.851 |
| Coefficient | | | | | | | |
| VFT | A | −3.425 | −3.478 | −3.339 | −3.624 | −3.218 | −3.617 |
| | B | 8561.9 | 8869.9 | 8679.8 | 9294.6 | 8375.7 | 9759.2 |
| | Tₒ | 136.9 | 80.3 | 96.3 | 37.2 | 88.0 | −39.1 |
| Liquidus | Air | 1140 | 1115 | 1120 | 1105 | 1100 | 1130 |
| Temp | Internal | 1130 | 1110 | 1115 | 1100 | 1085 | 1120 |
| (° C.) | Platinum | 1135 | 1105 | 1115 | 1090 | 1070 | 1100 |
| Liquidus | Primary | Forsterite | Forsterite | Nepheline | Forsterite | Nepheline | Nepheline |
| Phase | Phase | | | | | | |
| | Secondary | Nepheline | | | | | |
| | Phase | | | | | | |
| Liquidus | Internal | 157 | 137 | 152 | 132 | 152 | 63 |
| Viscosity | | | | | | | |
| (kP) | | | | | | | |

| Composition | | 43 | 44 | 45 | 46 | 47 | 48 |
|---|---|---|---|---|---|---|---|
| SiO₂ | | 63.75 | 62.69 | 61.65 | 63.52 | 62.54 | 61.61 |
| Al₂O₃ | | 13.87 | 14.85 | 15.84 | 13.87 | 14.86 | 15.84 |
| MgO | | 4.31 | 4.32 | 4.36 | 3.33 | 3.33 | 3.31 |
| CaO | | 0.05 | 0.04 | 0.05 | 0.04 | 0.04 | 0.04 |
| Li₂O | | 0.00 | 0.00 | 0.00 | 1.05 | 1.06 | 1.06 |
| Na₂O | | 17.92 | 17.98 | 17.99 | 18.09 | 18.08 | 18.03 |
| K₂O | | 0.00 | 0.00 | 0.00 | 0.00 | 0.00 | 0.00 |
| SnO₂ | | 0.09 | 0.09 | 0.09 | 0.10 | 0.09 | 0.09 |
| Fe₂O₃ | | 0.01 | 0.01 | 0.01 | 0.01 | 0.01 | 0.01 |
| RO | | 4.36 | 4.36 | 4.41 | 3.37 | 3.37 | 3.35 |
| R₂O | | 17.92 | 17.92 | 17.99 | 19.14 | 19.14 | 19.09 |
| Al₂O₃ + RO | | 18.23 | 19.21 | 20.25 | 17.24 | 18.23 | 19.19 |
| R₂O + RO | | 22.28 | 22.35 | 22.40 | 22.51 | 22.50 | 22.45 |
| R₂O + RO − Al₂O₃ | | 8.42 | 7.51 | 6.57 | 8.64 | 7.64 | 6.62 |
| (R₂O + RO)/Al₂O₃ | | 1.61 | 1.51 | 1.41 | 1.62 | 1.51 | 1.42 |
| R | | 0.727 | 0.753123 | 0.778 | 0.725 | 0.750 | 0.775 |
| Density (g/cm³) | | 2.457 | 2.461 | 2.465 | 2.461 | 2.464 | 2.466 |
| CTE 0-300° C. | | 91.20 | 90.20 | 89.00 | 92.20 | 92.20 | 91.60 |
| (ppm/° C.) | | | | | | | |
| Fiber | Strain | 621.0 | 634.0 | 646.0 | 573.0 | 591.0 | 610.0 |
| Elongation | Point (° C.) | | | | | | |
| | Annealing | 673.0 | 688.0 | 701.0 | 625.0 | 644.0 | 664.0 |
| | Point (° C.) | | | | | | |
| | Softening | 911.4 | 931.5 | 945.6 | 870.8 | 892.7 | 907.1 |
| | Point (° C.) | | | | | | |

| Composition | | 43 | 44 | 45 | 46 | 47 | 48 |
|---|---|---|---|---|---|---|---|
| Young's Modulus | | 71.6 | 71.9 | 72.6 | 73.7 | 74.0 | 74.4 |
| (GPa) | | | | | | | |
| Shear Modulus | | 29.6 | 29.8 | 30.0 | 30.4 | 30.5 | 30.6 |
| (GPa) | | | | | | | |
| Poisson's ratio | | 0.209 | 0.207 | 0.211 | 0.213 | 0.211 | 0.214 |
| Refractive Index | | 1.5050 | 1.5058 | 1.5068 | 1.5064 | 1.5074 | 1.5076 |
| Stress Optical | | 2.955 | 2.958 | 2.962 | 2.903 | 2.895 | 2.902 |
| Coefficient | | | | | | | |
| VFT | A | −3.154 | −3.351 | −3.459 | −3.081 | −3.244 | −3.123 |
| | B | 8232.9 | 8546.1 | 8569.0 | 8398.7 | 8552.2 | 7965.3 |
| | Tₒ | 129.2 | 130.0 | 155.1 | 59.0 | 78.3 | 150.7 |
| Liquidus | Air | 1065 | 1105 | 1155 | 1035 | 1095 | 1135 |
| Temp | Internal | 1065 | 1105 | 1150 | 1035 | 1090 | 1130 |
| (° C.) | Platinum | 1050 | 1095 | 1145 | 1025 | 1090 | 1125 |
| Liquidus | Primary | Nepheline | Nepheline | Nepheline | Nepheline | Nepheline | Nepheline |
| Phase | Phase | | | | | | |
| | Secondary | | | | | | |
| | Phase | | | | | | |
| Liquidus | Internal | 612 | 320 | 158 | 410 | 162 | 113 |
| Viscosity | | | | | | | |
| (kP) | | | | | | | |

| Composition | | 49 | 50 | 51 | 52 | 53 | 54 |
|---|---|---|---|---|---|---|---|
| SiO₂ | | 62.83 | 61.70 | 60.75 | 62.67 | 61.81 | 60.70 |
| Al₂O₃ | | 13.82 | 14.86 | 15.83 | 14.32 | 15.24 | 16.30 |
| MgO | | 4.27 | 4.23 | 4.22 | 3.81 | 3.78 | 3.79 |
| CaO | | 0.05 | 0.04 | 0.05 | 0.04 | 0.04 | 0.04 |
| Li₂O | | 1.05 | 1.06 | 1.04 | 1.05 | 1.06 | 1.06 |
| Na₂O | | 17.88 | 17.99 | 18.00 | 18.00 | 17.96 | 17.98 |
| K₂O | | 0.01 | 0.01 | 0.01 | 0.01 | 0.01 | 0.01 |
| SnO₂ | | 0.09 | 0.10 | 0.10 | 0.09 | 0.09 | 0.09 |
| Fe₂O₃ | | 0.01 | 0.01 | 0.01 | 0.01 | 0.01 | 0.01 |
| RO | | 4.29 | 4.27 | 4.27 | 3.85 | 3.82 | 3.83 |
| R₂O | | 18.93 | 19.05 | 19.04 | 19.05 | 19.03 | 19.06 |
| Al₂O₃ + RO | | 18.14 | 19.14 | 20.09 | 18.17 | 19.07 | 20.14 |
| R₂O + RO | | 23.25 | 23.33 | 23.31 | 22.90 | 22.85 | 22.89 |
| R₂O + RO − Al₂O₃ | | 9.43 | 8.46 | 7.48 | 8.58 | 7.61 | 6.59 |
| (R₂O + RO)/Al₂O₃ | | 1.68 | 1.57 | 1.47 | 1.60 | 1.50 | 1.40 |
| R | | 0.727 | 0.754 | 0.778 | 0.738 | 0.761 | 0.788 |
| Density (g/cm³) | | 2.467 | 2.469 | 2.474 | 2.465 | 2.469 | 2.473 |
| CTE 0-300° C. | | 93.00 | 92.50 | 91.60 | 92.40 | 92.80 | 92.30 |
| (ppm/° C.) | | | | | | | |
| Fiber | Strain | 575.0 | 592.0 | 605.0 | 582.00 | 594.0 | 610.0 |
| Elongation | Point (° C.) | | | | | | |
| | Annealing | 626.0 | 643.0 | 657.0 | 633.0 | 646.0 | 663.0 |
| | Point (° C.) | | | | | | |
| | Softening | 865.5 | 885.1 | 897.0 | 872.8 | 886.3 | 909.4 |
| | Point (° C.) | | | | | | |

| Composition | | 49 | 50 | 51 | 52 | 53 | 54 |
|---|---|---|---|---|---|---|---|
| Young's Modulus | | 74.3 | 74.3 | 74.8 | 74.1 | 74.8 | 75.3 |
| (GPa) | | | | | | | |
| Shear Modulus | | 30.6 | 30.6 | 30.8 | 30.6 | 30.8 | 31.0 |
| (GPa) | | | | | | | |
| Poisson's ratio | | 0.214 | 0.214 | 0.213 | 0.212 | 0.215 | 0.215 |
| Refractive Index | | 1.5079 | 1.5085 | 1.5095 | 1.5202 | 1.5088 | 1.5093 |
| Stress Optical | | 2.880 | 2.858 | 2.870 | 2.889 | 2.888 | 2.888 |
| Coefficient | | | | | | | |
| VFT | A | −2.855 | −3.153 | −2.749 | −3.091 | −3.164 | −3.184 |
| | B | 7669.2 | 8127.1 | 7195.9 | 8206.9 | 8160.9 | 7945.7 |
| | Tₒ | 112.9 | 112.7 | 189.7 | 87.3 | 114.8 | 157.3 |
| Liquidus | Air | 1070 | 1125 | 1160 | 1075 | 1135 | 1160 |
| Temp | Internal | 1065 | 1120 | 1145 | 1070 | 1130 | 1150 |
| (° C.) | Platinum | 1070 | 1130 | 1145 | 1060 | 1130 | 1160 |
| Liquidus | Primary | Nepheline | Nepheline | Nepheline | Nepheline | Nepheline | Nepheline |
| Phase | Phase | | | | | | |
| | Secondary | | | | | | |
| | Phase | | | | | | |
| Liquidus | Internal | 159 | 82 | 61 | 182 | 75 | 66 |
| Viscosity | | | | | | | |
| (kP) | | | | | | | |

| Composition | | 55 | 56 | 57 | 58 | 59 | 60 |
|---|---|---|---|---|---|---|---|
| SiO₂ | | 61.84 | 61.14 | 61.51 | 61.28 | 61.41 | 61.16 |
| Al₂O₃ | | 15.81 | 15.91 | 15.66 | 15.72 | 15.93 | 15.90 |
| MgO | | 4.56 | 5.01 | 4.72 | 5.03 | 4.14 | 4.55 |
| CaO | | 0.05 | 0.05 | 0.05 | 0.05 | 0.51 | 0.52 |
| Li₂O | | 0.00 | 0.00 | 0.00 | 0.00 | 0.00 | 0.00 |
| Na₂O | | 17.64 | 17.77 | 17.94 | 17.80 | 17.91 | 17.75 |
| K₂O | | 0.01 | 0.01 | 0.00 | 0.01 | 0.01 | 0.01 |
| SnO₂ | | 0.10 | 0.10 | 0.10 | 0.10 | 0.10 | 0.10 |
| Fe₂O₃ | | 0.01 | 0.01 | 0.01 | 0.01 | 0.01 | 0.01 |
| RO | | 4.61 | 5.06 | 4.77 | 5.08 | 4.65 | 5.07 |
| R₂O | | 17.64 | 17.77 | 17.94 | 17.80 | 17.91 | 17.76 |
| Al₂O₃ + RO | | 20.41 | 20.98 | 20.44 | 20.81 | 20.57 | 20.97 |
| R₂O + RO | | 22.25 | 22.84 | 22.72 | 22.89 | 22.56 | 22.83 |
| R₂O + RO − Al₂O₃ | | 6.44 | 6.92 | 7.05 | 7.17 | 6.64 | 6.93 |
| (R₂O + RO)/Al₂O₃ | | 1.41 | 1.43 | 1.45 | 1.46 | 1.42 | 1.44 |
| R | | 0.775 | 0.781 | 0.775 | 0.777 | 0.774 | 0.773 |
| Density (g/cm³) | | 2.466 | 2.468 | 2.467 | 2.465 | 2.470 | 2.473 |
| CTE 0-300° C. | | 89.50 | 87.30 | 88.80 | 88.20 | 88.00 | 87.00 |
| (ppm/° C.) | | | | | | | |
| Fiber | Strain | 641.0 | 644.0 | 639.0 | 645.0 | 637.0 | 640.0 |
| Elongation | Point (° C.) | | | | | | |
| | Annealing | 694.0 | 698.0 | 692.0 | 699.0 | 690.0 | 694.0 |
| | Point (° C.) | | | | | | |
| | Softening | 936.1 | 944.7 | 939.9 | 945.5 | 936.0 | 943.5 |
| | Point (° C.) | | | | | | |

| Composition | | 55 | 56 | 57 | 58 | 59 | 60 |
|---|---|---|---|---|---|---|---|
| Young's Modulus | | 73.2 | 73.2 | 73.0 | 73.1 | 73.2 | 73.7 |
| (GPa) | | | | | | | |
| Shear Modulus | | 30.1 | 30.2 | 30.1 | 30.1 | 30.2 | 30.4 |
| (GPa) | | | | | | | |
| Poisson's ratio | | 0.217 | 0.214 | 0.214 | 0.213 | 0.211 | 0.213 |
| Refractive Index | | 1.5077 | 1.5074 | 1.5076 | 1.5080 | 1.5080 | 1.5084 |
| Stress Optical | | 2.913 | 2.911 | 2.929 | 2.912 | 2.895 | 2.923 |
| Coefficient | | | | | | | |
| VFT | A | −3.241 | −3.525 | −3.133 | −3.266 | −3.384 | −3.254 |
| | B | 8045.0 | 8534.4 | 7802.0 | 8110.5 | 8405.8 | 8091.0 |
| | Tₒ | 190.1 | 159.5 | 202.6 | 177.8 | 150.6 | 178.5 |
| Liquidus | Air | 1140 | 1150 | 1125 | 1150 | 1135 | 1135 |
| Temp | Internal | 1140 | 1145 | 1125 | 1140 | 1135 | 1130 |
| (° C.) | Platinum | 1140 | 1150 | 1125 | 1150 | 1145 | 1130 |
| Liquidus | Primary | Nepheline | Forsterite | Forsterite | Nepheline | Nepheline | Nepheline |
| Phase | Phase | | | | | | |
| | Secondary | Forsterite | | Nepheline | | | Forsterite |
| | Phase | | | | | | |
| Liquidus | Internal | 169 | 136 | 212 | 146 | 143 | 178 |
| Viscosity | | | | | | | |
| (kP) | | | | | | | |

| Composition | | 61 | 62 | 63 | 64 | 65 | 66 | 67 | 68 |
|---|---|---|---|---|---|---|---|---|---|
| SiO₂ | | 61.96 | 61.93 | 62.28 | 62.26 | 62.67 | 62.39 | 63.90 | 64.17 |
| Al₂O₃ | | 14.91 | 14.93 | 15.12 | 15.12 | 14.84 | 14.90 | 14.77 | 14.80 |
| MgO | | 4.85 | 5.11 | 4.68 | 4.92 | 4.13 | 4.49 | 4.18 | 4.08 |
| CaO | | 0.05 | 0.05 | 0.05 | 0.05 | 0.50 | 0.51 | 0.03 | 0.00 |
| Li₂O | | 0.00 | 0.00 | 0.00 | 0.00 | 0.00 | 0.00 | 0.00 | 0.00 |
| Na₂O | | 18.11 | 17.86 | 17.77 | 17.53 | 17.73 | 17.59 | 16.86 | 16.80 |
| K₂O | | 0.01 | 0.00 | 0.00 | 0.01 | 0.01 | 0.01 | 0.01 | 0.00 |
| SnO₂ | | 0.10 | 0.10 | 0.10 | 0.10 | 0.10 | 0.10 | 0.25 | 0.15 |
| Fe₂O₃ | | 0.01 | 0.01 | 0.01 | 0.01 | 0.01 | 0.01 | 0.01 | 0.01 |
| RO | | 4.90 | 5.16 | 4.73 | 4.97 | 4.63 | 5.00 | 4.21 | 4.08 |
| R₂O | | 18.12 | 17.86 | 17.77 | 17.54 | 17.73 | 17.59 | 16.86 | 16.80 |
| Al₂O₃ + RO | | 19.81 | 20.09 | 19.84 | 20.10 | 19.48 | 19.90 | 18.98 | 18.88 |
| R₂O + RO | | 23.02 | 23.03 | 22.50 | 22.51 | 22.37 | 22.59 | 21.07 | 20.88 |
| R₂O + RO − Al₂O₃ | | 8.11 | 8.10 | 7.38 | 7.39 | 7.53 | 7.69 | 6.30 | 6.08 |
| (R₂O + RO)/Al₂O₃ | | 1.54 | 1.54 | 1.49 | 1.49 | 1.51 | 1.52 | 1.43 | 1.41 |
| R | | 0.759 | 0.758 | 0.759 | 0.758 | 0.745 | 0.747 | 0.739 | 0.739 |
| Density (g/cm³) | | 2.462 | 2.463 | 2.463 | 2.464 | 2.466 | 2.465 | 2.457 | |
| CTE 0-300° C. | | 88.90 | 88.30 | 88.80 | 88.00 | 89.10 | 87.60 | 85.20 | |
| (ppm/° C.) | | | | | | | | | |
| Fiber | Strain | 640.0 | 630.0 | 635.0 | 638.0 | 623.0 | 630.0 | 642.0 | |
| Elongation | Point (° C.) | | | | | | | | |
| | Annealing | 692.0 | 683.0 | 689.0 | 691.0 | 677.0 | 683.0 | 697.0 | |
| | Point (° C.) | | | | | | | | |
| | Softening | 925.4 | 931.6 | 934.7 | 933.7 | 920.4 | 928.1 | 946.9 | |
| | Point (° C.) | | | | | | | | |

| Composition | | 61 | 62 | 63 | 64 | 65 | 66 | 67 |
|---|---|---|---|---|---|---|---|---|
| Young's Modulus | | 72.2 | 72.4 | 72.0 | 72.3 | 72.4 | 72.6 | 72.6 |
| (GPa) | | | | | | | | |
| Shear Modulus | | 29.7 | 29.9 | 29.8 | 29.9 | 29.8 | 29.9 | 30.0 |
| (GPa) | | | | | | | | |
| Poisson's ratio | | 0.214 | 0.211 | 0.209 | 0.210 | 0.214 | 0.212 | 0.211 |
| Refractive Index | | 1.5062 | 1.5069 | 1.5066 | 1.5070 | 1.5070 | 1.5074 | 1.5042 |
| Stress Optical | | 2.947 | 2.932 | 2.958 | 2.960 | 2.950 | 2.936 | 2.986 |
| Coefficient | | | | | | | | |
| VFT | A | −3.225 | −3.342 | −3.178 | −3.297 | −3.104 | −3.222 | −2.939 |
| | B | 8198.0 | 8382.9 | 8013.1 | 8281.5 | 7977.3 | 8213.3 | 7654.1 |
| | Tₒ | 159.3 | 145.6 | 177.8 | 157.6 | 158.3 | 155.0 | 211.0 |
| Liquidus | Air | 1120 | 1130 | 1115 | 1135 | 1090 | 1100 | 1110 |
| Temp | Internal | 1110 | 1120 | 1105 | 1130 | 1080 | 1080 | 1110 |
| (° C.) | Platinum | 1105 | 1125 | 1115 | 1135 | 1100 | 1085 | 1100 |
| Liquidus | Primary | Nepheline | Forsterite | Forsterite | Forsterite | Nepheline | Nepheline | Forsterite |
| Phase | Phase | | | | | | | |
| | Secondary | Forsterite | Nepheline | Nepheline | | | Forsterite | Nepheline |
| | Phase | | | | | | | |
| Liquidus | Internal | 250 | 182 | 291 | 166 | 356 | 454 | 376 |
| Viscosity | | | | | | | | |
| (kP) | | | | | | | | |

Glass-based substrates with the thickness stated in Table II were formed from the stated composition (referring to the compositions in Table I), and subsequently ion exchanged to form example glass-based articles reported in Table II. Unless otherwise indicated, the glass-based substrates had a thickness of 0.8 mm. The glass-based substrates were subjected to a single ion exchange process, where the glass-based substrates were submerged in a potassium nitrate (KNO₃) molten salt bath maintained at 410° C. for the period of time (between 0.25 hours and 4 hours) stated in Table II. Table II also reports properties of the resulting stress profile, including the maximum compressive stress at the first major surface (CS_{surface}), the depth of the spike (DOLₛₚ), and the ratio of CS_{surface} to the elastic modulus (e.g., Young's modulus) as CS/E in MPa/GPa. The properties of the stress profiles reported in Table II were measured with RNF.

TABLE II

| Article | A1 | DA1 | DB1 | DC1 | DD1 | DE1 | DF1 |
|---|---|---|---|---|---|---|---|
| Composition | AA | 1 | 2 | 3 | 4 | 5 | 6 |
| Thickness (mm) | 0.8 | 0.8 | 0.8 | 0.8 | 0.8 | 0.8 | 0.8 |
| IOX Time (h) | 0.25 | 0.25 | 0.25 | 0.25 | 0.25 | 0.25 | 0.25 |
| CS_{surface} (MPa) | 945 | 1252 | 1237 | 1261 | 1223 | 1243 | 1217 |
| DOLₛₚ (μm) | 8.0 | 9.5 | 9.5 | 9.6 | 9.6 | 9.7 | 9.6 |
| CS/E (MPa/GPa) | 13.3 | 17.3 | 17.1 | 17.3 | 16.9 | 17.3 | 16.9 |

| Article | A2 | DA2 | DB2 | DC2 | DD2 | DE2 | DF2 |
|---|---|---|---|---|---|---|---|
| Composition | AA | 1 | 2 | 3 | 4 | 5 | 6 |
| Thickness (mm) | 0.8 | 0.8 | 0.8 | 0.8 | 0.8 | 0.8 | 0.8 |
| IOX Time (h) | 0.5 | 0.5 | 0.5 | 0.5 | 0.5 | 0.5 | 0.5 |
| CS_{surface} (MPa) | 999 | 1267 | 1260 | 1284 | 1251 | 1235 | 1244 |
| DOLₛₚ (μm) | 11.1 | 13.4 | 13.3 | 13.2 | 12.7 | 12.9 | 12.9 |
| CS/E (MPa/GPa) | 14.0 | 17.5 | 17.4 | 17.6 | 17.3 | 17.2 | 17.3 |

| Article | A3 | DC3 | DF3 |
|---|---|---|---|
| Composition | AA | 3 | 6 |
| Thickness (mm) | 0.8 | 0.8 | 0.8 |
| IOX Time (h) | 1.0 | 1.0 | 1.0 |
| CS_{surface} (MPa) | 1008 | 1266 | 1192 |
| DOLₛₚ (μm) | 17.1 | 20.1 | 19.8 |
| CS/E (MPa/GPa) | 14.1 | 17.3 | 16.5 |

| Article | DG1 | DH1 | DI1 | DJ1 | DK1 | DL1 |
|---|---|---|---|---|---|---|
| Composition | 7 | 8 | 9 | 10 | 11 | 12 |
| Thickness (mm) | 0.8 | 0.8 | 0.8 | 0.8 | 0.8 | 0.8 |
| IOX Time (h) | 0.25 | 0.25 | 0.25 | 0.25 | 0.25 | 0.25 |
| CS_{surface} (MPa) | 1298 | 1201 | 1225 | 1216 | 1240 | 1250 |
| DOLₛₚ (μm) | 9.2 | 9.7 | 9.6 | 9.6 | 9.6 | 9.5 |
| CS/E (MPa/GPa) | 17.9 | 16.7 | 17.0 | 16.9 | 17.2 | 17.3 |
| Article | DG2 | DH2 | DI2 | DJ2 | DK2 | DL2 |
| Composition | 7 | 8 | 9 | 10 | 11 | 12 |
| Thickness (mm) | 0.8 | 0.8 | 0.8 | 0.8 | 0.8 | 0.8 |
| IOX Time (h) | 0.5 | 0.5 | 0.5 | 0.5 | 0.5 | 0.5 |
| CS_{surface} (MPa) | 1292 | 1237 | 1238 | 1232 | 1282 | 1265 |
| DOLₛₚ (μm) | 13.0 | 12.8 | 13.4 | 13.4 | 12.8 | 12.9 |
| CS/E (MPa/GPa) | 17.9 | 17.2 | 17.2 | 17.1 | 17.7 | 17.5 |

| Article | DH3 | DK3 | A4 | DG4 | DI4 | DJ4 |
|---|---|---|---|---|---|---|
| Composition | 8 | 11 | AA | 7 | 9 | 10 |
| Thickness (mm) | 0.8 | 0.8 | 0.8 | 0.8 | 0.8 | 0.8 |
| IOX Time (h) | 1.0 | 1.0 | 2.0 | 2.0 | 2.0 | 2.0 |
| CS_{surface} (MPa) | 1210 | 1244 | 993 | 1215 | 1207 | 1195 |
| DOLₛₚ (μm) | 19.4 | 20.4 | 23.7 | 27.4 | 28.1 | 27.6 |
| CS/E (MPa/GPa) | 16.8 | 17.2 | 13.9 | 16.8 | 16.8 | 16.6 |

| Article | DM1 | DN1 | DO1 | DP1 | DQ1 | DR1 |
|---|---|---|---|---|---|---|
| Composition | 13 | 14 | 15 | 16 | 17 | 18 |
| Thickness (mm) | 0.8 | 0.8 | 0.8 | 0.8 | 0.8 | 0.8 |
| IOX Time (h) | 0.25 | 0.25 | 0.25 | 0.25 | 0.25 | 0.25 |
| CS_{surface} (MPa) | 1257 | 1234 | 1257 | 1240 | 1267 | 1257 |
| DOLₛₚ (μm) | 9.7 | 9.9 | 9.6 | 9.6 | 9.3 | 9.6 |
| CS/E (MPa/GPa) | 17.4 | 17.1 | 17.4 | 17.1 | 17.3 | 17.4 |
| Article | DM2 | DN2 | DO2 | DP2 | DQ2 | DR2 |
| Composition | 13 | 14 | 15 | 16 | 17 | 18 |
| Thickness (mm) | 0.8 | 0.8 | 0.8 | 0.8 | 0.8 | 0.8 |
| IOX Time (h) | 0.5 | 0.5 | 0.5 | 0.5 | 0.5 | 0.5 |
| CS_{surface} (MPa) | 1254 | 1253 | 1284 | 1261 | 1279 | 1279 |
| DOLₛₚ (μm) | 13.3 | 13.4 | 13.3 | 12.6 | 12.6 | 13.2 |
| CS/E (MPa/GPa) | 17.4 | 17.4 | 17.8 | 17.4 | 17.4 | 17.7 |

| Article | DO3 | DP3 | DQ3 |
|---|---|---|---|
| Composition | 15 | 16 | 17 |
| Thickness (mm) | 0.8 | 0.8 | 0.8 |
| IOX Time (h) | 1.0 | 1.0 | 1.0 |
| CS_{surface} (MPa) | 1277 | 1261 | 1293 |
| DOLₛₚ (μm) | 20.1 | 20.3 | 20.1 |
| CS/E (MPa/GPa) | 17.7 | 17.4 | 17.9 |

| Article | DS1 | DT1 | DU1 | DV1 | DW1 | DX1 |
|---|---|---|---|---|---|---|
| Composition | 19 | 20 | 21 | 22 | 23 | 24 |
| Thickness (mm) | 0.8 | 0.8 | 0.8 | 0.8 | 0.8 | 0.8 |
| IOX Time (h) | 0.25 | 0.25 | 0.25 | 0.25 | 0.25 | 0.25 |
| CS_{surface} (MPa) | 1270 | 1254 | 1259 | 1220 | 1212 | 1221 |
| DOLₛₚ (μm) | 8.9 | 9.3 | 9.3 | 7.7 | 8.1 | 8.3 |
| CS/E (MPa/GPa) | 17.2 | 17.2 | 17.3 | 16.3 | 16.3 | 16.4 |
| Article | DS2 | DT2 | DU2 | DV2 | DW2 | DX2 |
| Composition | 19 | 20 | 21 | 22 | 23 | 24 |
| Thickness (mm) | 0.8 | 0.8 | 0.8 | 0.8 | 0.8 | 0.8 |
| IOX Time (h) | 0.5 | 0.5 | 0.5 | 0.5 | 0.5 | 0.5 |
| CS_{surface} (MPa) | 1277 | 1278 | 1275 | 1242 | 1239 | 1241 |
| DOLₛₚ (μm) | 12.4 | 12.7 | 13.1 | 10.8 | 11.2 | 11.7 |
| CS/E (MPa/GPa) | 17.4 | 17.5 | 17.5 | 16.6 | 16.6 | 16.7 |

| Article | DS3 | DT3 | DU3 | DV3 | DW3 | DX3 | DW4 | DX4 |
|---|---|---|---|---|---|---|---|---|
| Composition | 19 | 20 | 21 | 22 | 23 | 24 | 23 | 24 |
| Thickness (mm) | 0.8 | 0.8 | 0.8 | 0.8 | 0.8 | 0.8 | 0.8 | 0.8 |
| IOX Time (h) | 1.0 | 1.0 | 1.0 | 1.0 | 1.0 | 1.0 | 2.0 | 2.0 |
| CS_{surface} (MPa) | 1295 | 1279 | 1276 | 1242 | 1261 | 1270 | 1259 | 1265 |
| DOLₛₚ (μm) | 18.7 | 19.6 | 19.5 | 16.6 | 16.5 | 17.7 | 23.6 | 25.2 |
| CS/E (MPa/GPa) | 17.6 | 17.5 | 17.5 | 16.6 | 16.9 | 17.1 | 16.9 | 17.0 |

| Article | EA1 | EB1 | EC1 | ED1 | EE1 | EF1 |
|---|---|---|---|---|---|---|
| Composition | 25 | 26 | 27 | 28 | 29 | 30 |
| Thickness (mm) | 0.8 | 0.8 | 0.8 | 0.8 | 0.8 | 0.8 |
| IOX Time (h) | 0.25 | 0.25 | 0.25 | 0.25 | 0.25 | 0.25 |
| CS_{surface} (MPa) | 1196 | 1127 | 1117 | 1174 | 1108 | 1073 |
| DOLₛₚ (μm) | 8.3 | 6.3 | 7.0 | 5.2 | 5.6 | 6.3 |
| CS/E (MPa/GPa) | 16.0 | 14.7 | 14.8 | 15.1 | 14.5 | 13.9 |
| Article | EA2 | EB2 | EC2 | ED2 | EE2 | EF2 |
| Composition | 25 | 26 | 27 | 28 | 29 | 30 |
| Thickness (mm) | 0.8 | 0.8 | 0.8 | 0.8 | 0.8 | 0.8 |
| IOX Time (h) | 0.5 | 0.5 | 0.5 | 0.5 | 0.5 | 0.5 |
| CS_{surface} (MPa) | 1187 | 1143 | 1138 | 1153 | 1108 | 1066 |
| DOLₛₚ (μm) | 10.45 | 8.62 | 9.72 | 7.46 | 8.07 | 8.83 |
| CS/E (MPa/GPa) | 15.9 | 14.9 | 15.0 | 14.8 | 14.5 | 13.8 |
| Article | EA3 | EB3 | EC3 | ED3 | EE3 | EF3 |
| Composition | 25 | 26 | 27 | 28 | 29 | 30 |
| Thickness (mm) | 0.8 | 0.8 | 0.8 | 0.8 | 0.8 | 0.8 |
| IOX Time (h) | 1.0 | 1.0 | 1.0 | 1.0 | 1.0 | 1.0 |
| CS_{surface} (MPa) | 1197 | 1158 | 1123 | 1149 | 1064 | 1019 |
| DOLₛₚ (μm) | 14.9 | 12.7 | 13.2 | 10.8 | 12.0 | 12.3 |
| CS/E (MPa/GPa) | 16.0 | 15.1 | 14.8 | 14.8 | 13.9 | 13.2 |

| Article | EA4 | EB4 | EC4 | ED4 | EE4 | EF4 |
|---|---|---|---|---|---|---|
| Composition | 25 | 26 | 27 | 28 | 29 | 30 |
| Thickness (mm) | 0.8 | 0.8 | 0.8 | 0.8 | 0.8 | 0.8 |
| IOX Time (h) | 2.0 | 2.0 | 2.0 | 2.0 | 2.0 | 2.0 |
| CS_{surface} (MPa) | 1180 | 1112 | 1071 | 1128 | 1041 | 953 |
| DOLₛₚ (μm) | 21.5 | 17.4 | 18.3 | 14.9 | 15.8 | 16.7 |
| CS/E (MPa/GPa) | 15.8 | 14.5 | 14.1 | 14.5 | 13.6 | 12.4 |

| Article | EG1 | EH1 | EI1 | EJ1 | EK1 | EL1 |
|---|---|---|---|---|---|---|
| Composition | 31 | 32 | 33 | 34 | 35 | 36 |
| Thickness (mm) | 0.8 | 0.8 | 0.8 | 0.8 | 0.8 | 0.8 |
| IOX Time (h) | 0.25 | 0.25 | 0.25 | 0.25 | 0.25 | 0.25 |
| CS_{surface} (MPa) | 1273 | 1238 | 1226 | 1262 | 1229 | 1152 |
| DOLₛₚ (μm) | 7.9 | 7.9 | 7.8 | 6.0 | 6.4 | 7.4 |
| CS/E (MPa/GPa) | 16.9 | 16.1 | 16.1 | 16.1 | 15.9 | 15.0 |
| Article | EG2 | EH2 | EI2 | EJ2 | EK2 | EL2 |
| Composition | 31 | 32 | 33 | 34 | 35 | 36 |
| Thickness (mm) | 0.8 | 0.8 | 0.8 | 0.8 | 0.8 | 0.8 |
| IOX Time (h) | 0.5 | 0.5 | 0.5 | 0.5 | 0.5 | 0.5 |
| CS_{surface} (MPa) | 1257 | 1253 | 1219 | 1246 | 1222 | 1148 |
| DOLₛₚ (μm) | 11.4 | 9.8 | 10.7 | 8.0 | 8.9 | 10.0 |
| CS/E (MPa/GPa) | 16.7 | 16.3 | 16.0 | 15.9 | 15.8 | 15.0 |
| Article | EG3 | EH3 | EI3 | EJ3 | EK3 | EL3 |
| Composition | 31 | 32 | 33 | 34 | 35 | 36 |
| Thickness (mm) | 0.8 | 0.8 | 0.8 | 0.8 | 0.8 | 0.8 |
| IOX Time (h) | 1.0 | 1.0 | 1.0 | 1.0 | 1.0 | 1.0 |
| CS_{surface} (MPa) | 1198 | 1206 | 1148 | 1216 | 1152 | 1045 |
| DOLₛₚ (μm) | 22.7 | 19.3 | 21.5 | 15.5 | 17.3 | 19.6 |
| CS/E (MPa/GPa) | 15.8 | 15.4 | 15.0 | 15.3 | 14.5 | 12.7 |

| Article | EG4 | EH4 | EI4 | EJ4 | EK4 | EL4 |
|---|---|---|---|---|---|---|
| Composition | 31 | 32 | 33 | 34 | 35 | 36 |
| Thickness (mm) | 0.8 | 0.8 | 0.8 | 0.8 | 0.8 | 0.8 |
| IOX Time (h) | 2.0 | 2.0 | 2.0 | 2.0 | 2.0 | 2.0 |
| CS_{surface} (MPa) | 1191 | 1182 | 1139 | 1196 | 1121 | 972 |
| DOLₛₚ (μm) | 31.2 | 25.9 | 28.9 | 22.0 | 23.9 | 25.6 |
| CS/E (MPa/GPa) | 15.8 | 15.4 | 15.0 | 15.3 | 14.5 | 12.7 |

| Article | EM1 | EN1 | EO1 | EP1 | EQ1 | ER1 |
|---|---|---|---|---|---|---|
| Composition | 37 | 38 | 39 | 40 | 41 | 42 |
| Thickness (mm) | 0.8 | 0.8 | 0.8 | 0.8 | 0.8 | 0.8 |
| IOX Time (h) | 0.25 | 0.25 | 0.25 | 0.25 | 0.25 | 0.25 |
| CS_{surface} (MPa) | 1309 | 1306 | 1300 | 1323 | 1306 | 1264 |
| DOLₛₚ (μm) | 7.8 | 6.8 | 7.8 | 5.3 | 6.2 | 7.0 |
| CS/E (MPa/GPa) | 17.3 | 16.9 | 17.0 | 16.9 | 16.9 | 16.4 |
| Article | EM2 | EN2 | EO2 | EP2 | EQ2 | ER2 |
| Composition | 37 | 38 | 39 | 40 | 41 | 42 |
| Thickness (mm) | 0.8 | 0.8 | 0.8 | 0.8 | 0.8 | 0.8 |
| IOX Time (h) | 0.5 | 0.5 | 0.5 | 0.5 | 0.5 | 0.5 |
| CS_{surface} (MPa) | 1351 | 1321 | 1303 | 1336 | 1317 | 1239 |
| DOLₛₚ (μm) | 11.1 | 9.4 | 10.8 | 8.2 | 9.0 | 9.8 |
| CS/E (MPa/GPa) | 17.9 | 17.1 | 17.1 | 17.0 | 17.0 | 16.1 |
| Article | EM3 | EN3 | EO3 | EP3 | EQ3 | ER3 |
| Composition | 37 | 38 | 39 | 40 | 41 | 42 |
| Thickness (mm) | 0.8 | 0.8 | 0.8 | 0.8 | 0.8 | 0.8 |
| IOX Time (h) | 1.0 | 1.0 | 1.0 | 1.0 | 1.0 | 1.0 |
| CS_{surface} (MPa) | 1312 | 1298 | 1270 | 1319 | 1281 | 1194 |
| DOLₛₚ (μm) | 15.2 | 12.5 | 14.9 | 10.8 | 12.6 | 12.9 |
| CS/E (MPa/GPa) | 17.4 | 16.8 | 16.6 | 16.8 | 16.5 | 15.5 |
| Article | EM4 | EN4 | EO4 | EP4 | EQ4 | ER4 |
| Composition | 37 | 38 | 39 | 40 | 41 | 42 |
| Thickness (mm) | 0.8 | 0.8 | 0.8 | 0.8 | 0.8 | 0.8 |
| IOX Time (h) | 2.0 | 2.0 | 2.0 | 2.0 | 2.0 | 2.0 |
| CS_{surface} (MPa) | 1314 | 1305 | 1241 | 1295 | 1259 | 1156 |
| DOLₛₚ (μm) | 22.5 | 18.5 | 21.7 | 16.0 | 17.4 | 19.7 |
| CS/E (MPa/GPa) | 17.4 | 16.9 | 16.2 | 16.5 | 16.3 | 15.0 |

| Article | A5 | EM5 | EN5 | EO5 | EP5 | EQ5 | ER5 |
|---|---|---|---|---|---|---|---|
| Composition | AA | 37 | 38 | 39 | 40 | 41 | 42 |
| Thickness (mm) | 0.8 | 0.8 | 0.8 | 0.8 | 0.8 | 0.8 | 0.8 |
| Time (h) | 4.0 | 4.0 | 4.0 | 4.0 | 4.0 | 4.0 | 4.0 |
| CS_{surface} (MPa) | 968 | 1295 | 1242 | 1195 | 1284 | 1208 | 1090 |
| DOLₛₚ (μm) | 33.0 | 30.6 | 26.0 | 30.4 | 21.8 | 24.4 | 26.8 |
| CS/E (MPa/GPa) | 13.6 | 17.1 | 16.1 | 15.6 | 16.3 | 15.6 | 14.2 |

| Article | ES2 | ET2 | EU2 | EV2 | EW2 | EX2 |
|---|---|---|---|---|---|---|
| Composition | 43 | 44 | 45 | 46 | 47 | 48 |
| Thickness (mm) | 0.8 | 0.8 | 0.8 | 0.8 | 0.8 | 0.8 |
| Time (h) | 0.5 | 0.5 | 0.5 | 0.5 | 0.5 | 0.5 |
| CS_{surface} (MPa) | 1209 | 1258 | 1310 | 1151 | 1215 | 1288 |
| DOLₛₚ (μm) | 14.2 | 14.8 | 14.5 | 12.0 | 12.6 | 12.8 |
| CS/E (MPa/GPa) | 16.9 | 17.5 | 18.1 | 15.6 | 16.4 | 17.3 |
| Article | ES3 | ET3 | EU3 | EV3 | EW3 | EX3 |
| Composition | 43 | 44 | 45 | 46 | 47 | 48 |
| Thickness (mm) | 1.0 | 1.0 | 1.0 | 1.0 | 1.0 | 1.0 |
| Time (h) | 1226 | 1262 | 1312 | 1138 | 1202 | 1272 |
| CS_{surface} (MPa) | 15.1 | 15.5 | 22.0 | 12.9 | 13.3 | 13.7 |
| DOLₛₚ (μm) | 17.1 | 17.6 | 18.1 | 15.4 | 16.3 | 17.1 |
| CS/E (MPa/GPa) | 1.0 | 1.0 | 1.0 | 1.0 | 1.0 | 1.0 |
| Article | ES4 | ET4 | EU4 | EV4 | EW4 | EX4 |
| Composition | 43 | 44 | 45 | 46 | 47 | 48 |
| Thickness (mm) | 2.0 | 2.0 | 2.0 | 2.0 | 2.0 | 2.0 |
| Time (h) | 1144 | 1234 | 1305 | 1070 | 1187 | 1254 |
| CS_{surface} (MPa) | 29.6 | 29.5 | 28.2 | 24.3 | 24.0 | 25.6 |
| DOLₛₚ (μm) | 16.0 | 17.2 | 18.0 | 14.5 | 16.0 | 16.9 |
| CS/E (MPa/GPa) | 2.0 | 2.0 | 2.0 | 2.0 | 2.0 | 2.0 |
| Article | FA2 | FB2 | FC2 | FD2 | FE2 | FF2 |
| Composition | 49 | 50 | 51 | 52 | 53 | 54 |
| Thickness (mm) | 0.8 | 0.8 | 0.8 | 0.8 | 0.8 | 0.8 |
| Time (h) | 0.5 | 0.5 | 0.5 | 0.5 | 0.5 | 0.5 |
| CS_{surface} (MPa) | 1163 | 1254 | 1299 | 1175 | 1237 | 1302 |
| DOLₛₚ (μm) | 11.2 | 11.5 | 11.6 | 11.4 | 11.9 | 11.8 |
| CS/E (MPa/GPa) | 15.7 | 16.9 | 17.4 | 15.8 | 16.5 | 17.3 |
| Article | FA3 | FB3 | FC3 | FD3 | FE3 | FF3 |
| Composition | 49 | 50 | 51 | 52 | 53 | 54 |
| Thickness (mm) | 0.8 | 0.8 | 0.8 | 0.8 | 0.8 | 0.8 |
| Time (h) | 1.0 | 1.0 | 1.0 | 1.0 | 1.0 | 1.0 |
| CS_{surface} (MPa) | 1145 | 1224 | 1310 | 1167 | 1233 | 1320 |
| DOLₛₚ (μm) | 15.7 | 15.7 | 15.4 | 16.1 | 16.7 | 16.6 |
| CS/E (MPa/GPa) | 15.4 | 16.5 | 17.5 | 15.7 | 16.5 | 17.5 |
| Article | FA4 | FB4 | FC4 | FD4 | FE4 | FF4 |
| Composition | 49 | 50 | 51 | 52 | 53 | 54 |
| Thickness (mm) | 0.8 | 0.8 | 0.8 | 0.8 | 0.8 | 0.8 |
| Time (h) | 2.0 | 2.0 | 2.0 | 2.0 | 2.0 | 2.0 |
| CS_{surface} (MPa) | 1106 | 1200 | 1260 | 1120 | 1216 | 1298 |
| DOLₛₚ (μm) | 22.0 | 22.3 | 22.2 | 22.6 | 23.7 | 23.4 |
| CS/E (MPa/GPa) | 14.9 | 16.2 | 16.8 | 15.1 | 16.3 | 17.2 |
| Article | FG3 | FH3 | FI3 | FJ3 | FK3 | FL3 |
| Composition | 55 | 56 | 57 | 58 | 59 | 60 |
| Thickness (mm) | 0.8 | 0.8 | 0.8 | 0.8 | 0.8 | 0.8 |
| Time (h) | 1.0 | 1.0 | 1.0 | 1.0 | 1.0 | 1.0 |
| CS_{surface} (MPa) | 1312 | 1326 | 1299 | 1313 | 1321 | 1315 |
| DOLₛₚ (μm) | 19.2 | 18.6 | 19.0 | 18.8 | 18.5 | 17.7 |
| CS/E (MPa/GPa) | 17.9 | 18.1 | 17.8 | 18.0 | 18.0 | 17.8 |

| Article | FM3 | FN3 | FO3 | FP3 | FQ3 | FR3 | FS6 |
|---|---|---|---|---|---|---|---|
| Composition | 61 | 62 | 63 | 64 | 65 | 66 | 67 |
| Thickness (mm) | 0.8 | 0.8 | 0.8 | 0.8 | 0.8 | 0.8 | 0.8 |
| Time (h) | 1.0 | 1.0 | 1.0 | 1.0 | 1.0 | 1.0 | 5.5 |
| CS_{surface} (MPa) | 1278 | 1275 | 1273 | 1281 | 1264 | 1265 | 1330 |
| DOLₛₚ (μm) | 19.2 | 18.8 | 19.3 | 18.8 | 18.8 | 18.7 | 35.2 |
| CS/E (MPa/GPa) | 17.7 | 17.6 | 17.7 | 17.7 | 17.5 | 17.4 | 18.3 |

Unless otherwise indicated, all glass-based articles in Table II comprised a thickness of 0.8 mm and were chemically strengthened in a molten salt bath comprising 100 wt % KNO₃ maintained at 410° C. for the time stated in Table II. Articles A1-A4 comprised a thickness of 0.8 mm and were chemically strengthened for 0.25 hours, 0.5 hours, 1 hour, and 2 hours respectively. As shown in Table II, the depth of layer (DOLₛₚ) increased from 8.0 μm to 11.1 μm and then to 17.1 μm and 23.7 μm, respectively, as the time for the chemical strengthening increased. Also, the compressive stress (CS_{surface}) for Articles A1-A3 increased from 945 MPa to 999 MPa and then to 1008 MPa, respectively, as the time for the chemical strengthening increased. By 2 hours, the compressive stress has decreased to 993 MPa. This caused the CS/E ratio to increase with increasing chemical strengthening time up to 1 hour. The maximum CS/E ratio is 14.1 MPa/GPa for 1 hour with lower values for 0.5 hours (14.0) and 2 hours (13.9).

Composition AA comprised 68.9 mol % SiO₂, 10.25 mol % Al₂O₃, 5.45 mol % MgO, 0.05 mol % CaO, 0 mol % Li₂O, 15.2 mol % Na₂O, and 0.15 mol % SnO₂. Composition BB comprised 65.1 mol % SiO₂, 14.05 mol % Al₂O₃, 3.35 mol % MgO, 0.95 mol % CaO, 0 mol % Li₂O, 16.4 mol % Na₂O, and 0.15 mol % SnO₂.

Articles DA1-DX1 and EA1-ER1 were chemically strengthened for 0.25 hours. Articles DA2-DX2, EA2-EX2, and FA2-FF2 were chemically strengthened for 0.5 hours. Articles DC3, DF3, DH3, DK3, DO3-DQ3, DS3-DX3, EA3-EX3, and FA3-FR3 were chemically strengthened for 1 hour. Articles DG4, DI4, DJ4, DW4, DX4, and EA4-EX4 were chemically strengthened for 2 hours. Articles EM5 to ER5 were chemically strengthened for 4 hours. Article FS6 was chemically strengthened for 5.5 hours.

For the articles chemically strengthened for 15 minutes, articles DA1-DX1, EG1-EK1, and EM1-ER1 have compressive stress (CS_{surface}) of greater than or equal to 1200 MPa. Articles EA1-EE1 and EL1 have compressive stress (CS_{surface}) of greater than or equal to 1100 MPa (e.g., from 1100 MPa to 1200 MPa in addition to the articles discussed in the previous sentence). Consequently, these articles (DA1-DX1, EA1-EE1, and EG1-ER1) have a compressive stress (CS_{surface}) that is greater than that of article A1 by at least 150 MPa (e.g., 200 MPa or more, 250 MPa or more) when both articles are strengthened under the same conditions for 15 minutes. Articles DA1-DF1, DH1-DP1, and DR1 have a depth of layer (DOLₛₚ) greater than or equal to 9.5 μm. Also, articles DA1-DR1 and DT1-DU1 have a depth of layer (DOLₛₚ) greater than or equal to 9.0 μm. Indeed, Articles DA1-DX1, EA1, EC1, and EM1 have a depth of layer (DOLₛₚ) greater than or equal to that of article A1. Articles DA1-DX1, EA1, EG1-EJ1, and EM1-ER1 have a CS/E ratio greater than or equal to 16.0 MPa/GPa. Also, articles DA1-DX1, EG1, EM1-ER1 have a CS/E ratio greater than or equal to 16.5 MPa/GPa, and articles DA1-DC1, DE1, DG1, DI1, DK1-DU1, EM1, and EO1 have a CS/E ratio greater than or equal to 17.0 MPa/GPa. Consequently, articles DA1-DX1, EA1, EC1, and EM1 achieve the unexpected benefit of having a CS/E ratio greater than or equal to 16.0 MPa/GPa that improves foldability and is greater than the CS/E ratio by greater than 2.5 MPa/GPa (when both articles are treated by the same conditions for 15 minutes).

For the articles chemically strengthened for 30 minutes, articles DA2-DX2, EG2-EK2, EM2-EU2, EW2-EX2, FB2-FC2, and FE2-FF2 have compressive stress (CS_{surface}) of greater than or equal to 1200 MPa. Articles DA2-DD2, DG2, DK2-DU2, EG2-EH2, and EM2-EQ2, ET2-EU2, EX2, FB2-FC2, and FF2 have compressive stress (CS_{surface}) of greater than or equal to 1250 MPa. Consequently, these articles (DA2-DX2, EG2-EK2, EM2-EU2, EW2-EX2, FB2-FC2, and FE2-FF2) have a compressive stress (CS_{surface}) that is greater than that of article A2 by at least 200 MPa (e.g., 250 MPa or more) when both articles are strengthened under the same conditions for 30 minutes. Articles DA2-DS2, DT2-DV2, ES2-EU2, and EW2-EX2 have a depth of layer (DOLₛₚ) greater than or equal to 12.5 μm, and articles DA2-DC2, DG2, DI2-DJ2, DM2-DO2, DR2, DU2, and ES2-EU2 have a depth of layer (DOLₛₚ) greater than or equal to 13.0 μm. Consequently, these article (DA2-DS2, DT2-DV2, ES2-EU2, and EW2-EX2) have a depth of layer (DOLₛₚ) greater than 1.5 μm (e.g., greater than or equal to 2.0 μm, or greater than or equal to 2.5 μm) of that for article A2. Articles DA2-DX2, EG2-EI2, EM2-ER2, ES2-EU2, EW2-EX2, FB2-FC2, and FE2-FF2 have a CS/E ratio greater than or equal to 16.0 MPa/GPa. Articles DA2-DX2, EG2, EM2-EQ2, ES2-EU2, EX2, FB2-FC2, and FE2-FF2 have a CS/E ratio greater than or equal to 16.5 MPa/GPa. Articles DA2-DU2, EM2-EQ2, and ET2-EU2 have a CS/E ratio greater than or equal to 17.0 MPa/GPa. Consequently, articles DA2-DX2, EG2-EI2, EM2-ER2, ES2-EU2, EW2-EX2, FB2-FC2, and FE2-FF2 achieve the unexpected benefit of having a CS/E ratio greater than or equal to 16.0 MPa/GPa that improves foldability (as discussed above) and is greater than the CS/E ratio by greater than 2.0 MPa/GPa (when both articles are strengthened under the same conditions for 30 minutes).

For the articles chemically strengthened for 1 hour, articles DC3, DH3, DK3, DO3-DQ3, DS3-DX3, EA3-ED3, EG3-EK3, EM3-ER3, ES3-EX3, and FA3-FR3 have compressive stress (CS_{surface}) of greater than or equal to 1100 MPa. Articles DC3, DF3, DH3, DK3, DO3-EQ3, DX3-DX3, DH3, EJ3, EM3-ER3, ES3-EU3, EW3-EX3, FB3-FC3, and FE3-FR3 have a compressive stress (CS_{surface}) of greater than or equal to 1200 MPa. Consequently, these articles (DC3, DH3, DK3, DO3-DQ3, DS3-DX3, EA3-ED3, EG3-EK3, EM3-ER3, ES3-EX3, and FA3-FR3) have a CS_{surface} that is greater than that of article A3 by at least 100 MPa (e.g., 150 MPa or more, 200 MPa or more) when both articles are strengthened under the same conditions for 1 hour. Articles DC3, DF3, DH3, DK3, DO3-DQ3, DT3, DU3, DG3, EI3, EL3, EU3, FG3, FI3, FM3, and FO3 have a depth of layer (DOLₛₚ) greater than or equal to 19.0 μm, and articles DC3, DK3, DO3-DQ3, EG3, EI3, and EU3 have a depth of layer (DOLₛₚ) greater than or equal to 20.0 μm. Articles DC3, DF3, DH3, DK3, DO3-DQ3, DS3-DU3, DX3, EA3, EM3-EQ3, ES3-EU3, WE3-EX3, FB3-FC3, and FE3-FR3 have a CS/E ratio greater than or equal to 16.0 MPa/GPa. Also, Articles DC3, DK3, DO3-DQ3, DS3-DX3, EM3, and ES3-EU3, EX3, FC3, and FF3-FR3 have a CS/E ratio greater than or equal to 17.0 MPa/GPa. Consequently, articles DC3, DF3, DH3, DK3, DO3-DQ3, DS3-DU3, DX3, EA3, EM3-EQ3, ES3-EU3, WE3-EX3, FB3-FC3, and FE3-FR3, achieve the unexpected benefit of having a CS/E ratio greater than or equal to 16.0 MPa/GPa that improves foldability (as discussed above) and is greater than the CS/E ratio by greater than or equal to 2.0 MPa/GPa (e.g., greater than or equal to 2.5 MPa/GPa, greater than or equal to 3.0 MPa/GPa).

For the articles chemically strengthened for 2 hours, articles DG4, DI4, DJ4, DW4, DX4, EA4-EB4, ED4, EG4-EK4, and EM4-ER4, ES4-EX4, FB4-FC4, and FE4-FF4 have compressive stress (CS_{surface}) of greater than or equal to 1100 MPa. Articles DG4, DI4, DW4, DX4, EM4-EQ4, ET4-EU4, EX2, FB2-FC2, and FF4 have a CS_{surface} of greater than or equal to 1200 MPa. Consequently, these articles (DG4, DI4, DJ4, DW4, DX4, EA4-EB4, ED4, EG4-EK4, and EM4-ER4, ES4-EX4, FB4-FC4, and FE4-FF4) have a CS_{surface} that is greater than that of article A4 by at least 200 MPa (e.g., 250 MPa or more, 300 MPa or more) when both articles are strengthened under the same conditions for 2 hours. Articles DG4, DI4, DJ4, DX4, EG4, EI4, DL4, and ES4-EU4 have a depth of layer (DOLₛₚ) greater than or equal to 25.0 μm. Articles DW4, DX4, EM4, EQ4, ES4-EU4, EW4-EX4, FB4-FC4, and FE4-FF4 have a CS/E ratio greater than or equal to 16.0 MPa/GPa. Articles DX4, EM4, ET4-EU4, and FF4 have a CS/E ratio greater than or equal to 17.0 MPa/GPa. Consequently, articles DW4, DX4, EM4, EQ4, EW4-EX4, FB4-FC4, and FE4-FF4 achieve the unexpected benefit of having a CS/E ratio greater than or equal to 16.0 MPa/GPa that improves foldability (as discussed above) and is greater than the CS/E ratio by greater than or equal to 2.0 MPa/GPa (e.g., greater than or equal to 2.5 MPa/GPa, greater than or equal to 3.0 MPa/GPa).

Articles A5 and EM5-ER5 were chemically strengthened for 4 hours. While article A5 has a compressive stress of less than 1000 MPa, Articles EM5-EQ5 have a compressive stress of about 1200 MPa or more. Also, Articles EM5, EN5, and EP5 have a CS/E ratio greater than or equal to 16.0 (with article EM5 having a CS/E ratio greater than or equal to 17.0) while article A5 has a CS/E ratio less than 14.

Article FS6 was chemically strengthened for 5.5 hours. Article FS6 has a compressive stress of greater than or equal to 1000 MPa, greater than or equal to 1200 MPa, and greater than or equal to 1250 MPa (i.e., 1330 MPa). Also, Article FS6 has a CS/E ratio greater than or equal to 16.0, greater than or equal to 17.0, and greater than or equal to 18.0 (i.e., 18.3).

In view of the results in Table II, Compositions 1-25, 31-34, 37-45, 47-48, and 50-67 produced glass-based articles (with a thickness of 0.8 mm chemically strengthened in a KNO₃ molten salt solution at 410° C.) achieved a CS/E ratio of greater than or equal to 16.0 MPa/GPa.

The above observations can be combined to produce sodium aluminosilicate glasses with good ion exchangeability, good glass quality, and good foldability. Chemical strengthening processes can be used to achieve high strength and high toughness properties in sodium aluminosilicate glasses. By chemical strengthening in a molten salt bath (e.g., KNO₃), glasses with high strength, high toughness, and high indentation cracking resistance can be achieved. The stress profiles achieved through chemical strengthening may have a variety of shapes that increase the drop performance, strength, toughness, and other attributes of the glass-based articles. The compositions disclosed herein are capable of achieving a high maximum compressive stress (e.g., greater than or equal to 800 MPa, from 1,100 MPa to 1,600 MPa, or from 1,300 MPa to less than or equal to 1,450) that can enable foldability, good impact resistance, and/or puncture resistance. Also, the compositions of can provide deeper depth of layer (e.g., DOL_{SP}) than would otherwise be achievable for the same treatment.

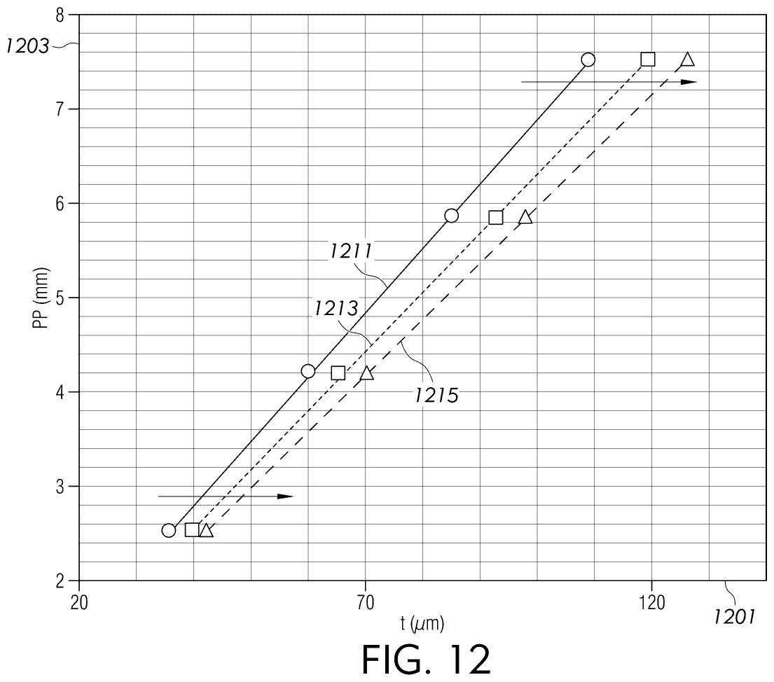

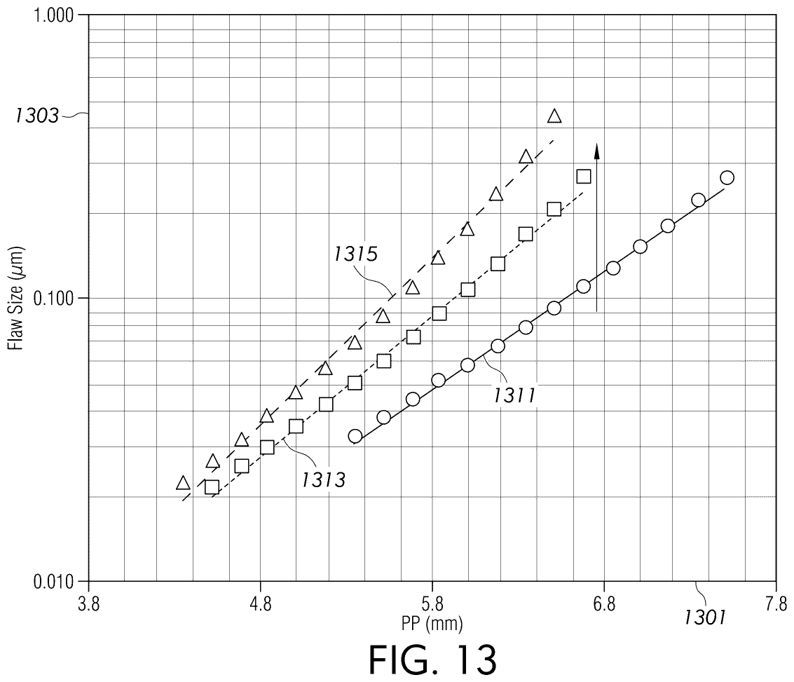

FIGS. 12-13 compare the properties of glass-based articles in accordance with the present disclosure with known glass-based articles. Curves 1211 and 1311 correspond to simulations based on glass-based articles formed from Composition AA (presented above) using the chemically strengthening properties and elastic modulus of the glass-based articles. Curves 1213 and 1313 correspond to glass-based articles formed from Composition BB (presented above). Curves 1215 and 1315 correspond to glass-based articles formed from Composition 58 (Table I).

FIG. 12 schematically illustrates a relationship between substrate thickness in micrometers on the horizontal axis 1201 (i.e., x-axis) and parallel plate distance (e.g., double the effective bend radius) in millimeters on the vertical axis 1203 (i.e., y-axis) for various glass-based articles. The compositions (Compositions AA, BB, and 1) were chemically strengthened to form glass-based articles with various thicknesses to achieve a maximum CS without becoming frangible. For comparison, the glass-based articles with a thickness of 90 μm had the following CS: 700 MPa for Composition AA, 835 MPa for Composition BB, and 915 MPa for Composition 58. In FIG. 12, the vertical axis 1203 corresponds to the median (i.e., point at which 50% of the samples failed). As shown, curve 1215 (Composition 58) can reliably achieve smaller parallel plate distances (and bend radii) for a predetermined thickness than curve 1211 (Composition AA) or curve 1213 (Composition BB). For example, a parallel plate distance of 5.8 mm can be achieved with a thickness of about 100 μm for Composition 58 whereas Composition AA can achieve the parallel plate distance with a thickness of about 85 μm and Composition BB can achieve the parallel plate distance with a thickness of about 92 μm. For example, a parallel plate distance of 6.8 mm can be achieved with a thickness of about 125 μm for Composition 58 whereas Composition AA can achieve the parallel plate distance with a thickness of about 108 μm and Composition BB can achieve the parallel plate distance with a thickness of about 118 μm. It is believed that the increased CS/E ratio achieved by the compositions of the present disclosure (e.g., Composition 58) enables the resulting glass-based article to better counteract bend-induced stresses such that a smaller parallel plate distance (and bend radius) can be reliably obtained (relative to known compositions)

FIG. 13 schematically shows a relationship between parallel plate distance (e.g., double the effective bend radii) in millimeters on the horizontal axis (i.e., x-axis) and a flaw size in micrometers on the vertical axis (i.e., y-axis) that the glass-based article can withstand while achieving the parallel plate distance bend radius for various glass-based articles having a substrate thickness of 90 μm. As shown, curve 1315 (Composition 58) can achieve a smaller parallel plate distance (and bend radius) with a predetermined flaw compared to curve 1311 (Composition AA) or curve 1313 (Composition BB). For example, with a flaw size of 0.1 μm (e.g., 100 nm), Composition 58 can achieve a parallel plate distance of about 5.5 mm whereas Composition AA achieves a parallel plate distance of 6.6 mm and Composition BB achieves a parallel plate distance of about 6.0 mm. Likewise, FIG. 13 shows that curve 1315 (Composition 58) can tolerate larger flaws while achieving a predetermined parallel plate distance (and bend radius) compared to curve 1311 (Composition AA) or curve 1313 (Composition BB). For example, a parallel plate distance of 5.8 mm can be achieved for Composition 58 with a flaw size greater than 100 nm, Composition AA with a flaw size of about 50 nm, and Composition BB with a flaw size of 90 nm. It is believed that the increased CS/E ratio achieved by the compositions of the present disclosure (e.g., Composition 58) enables the resulting glass-based article to prevent propagation of flaws (e.g., even relatively large flaws), which in turn enables the resulting glass-based article to achieve good parallel plate distances (and bend radii) even in the presence of flaws.

The glass-based compositions and/or glass-based articles of the present disclosure can provide improved foldability. Without wishing to be bound by theory, fracture toughness (e.g., caused by a “flaw” near the surface of the glass-based article) is proportional to a glass strength of the glass-based article. The glass strength (e.g., σ_{NET}) can be approximated as a difference between a bend-induced stress (e.g., σ_{BEND} at the surface of the glass-based article) and a compressive stress (e.g., σ_{IOX} from chemically strengthening the glass-based article, the first and/or second maximum compressive stress) (i.e., σ_{NET}≈σ_{BEND}−σ_{IOX}). During bending, the stress on the glass-based article is proportional to a product of the elastic modulus (E). The inventor of the present disclosure has determined that these expressions can be combined to state the glass strength as σ_{BEND}≈E[Z-CS/E], where Z is a constant for a predetermined bend (e.g., folding to a predetermined parallel plate distance for a glass-based article having a predetermined thickness. As shown in FIG. 10, there is a linear relationship (indicated by line 1007) between data points 1005 for more than 80 example glass-based articles with different compositions between CS/E (MPa/GPa) on the horizontal axis 1001 (e.g., x-axis) and E(Z-CS/E) on the vertical axis 1003 (e.g., y-axis). Based on this observed linear relationship (and the theoretical prediction of such relationship), the inventor of the present disclosure has unexpectedly discovered glass-based compositions for glass-based articles that are able to achieve higher CS/E ratios than have otherwise been possible. In view of the above, glass-based compositions for glass-based articles that are able to achieve higher CS/E ratios exhibit increased glass strength that can manifest as increased foldability of the glass-based article. Without wishing to be bound by theory, the bend-induced stress increases as the elastic modulus increases for a predetermined strain (e.g., bend or folded configuration), the compressive stress at least offsets the bend-induced stress before failure, and therefore, it is the competition (e.g., ratio) of these values (i.e., CS/E) that controls foldability. Further, it has not been possible to achieve a ratio of CS/E (in MPa/GPa) greater than 16.0; however, the inventor of the present disclosure has unexpectedly found that glass-based compositions of the present disclosure can have a ratio of CS/E (in MPa/GPa) exceeding 16.0. In view of the results in Table II, Compositions 1-25, 31-34, and 37-42 produced glass-based articles (with a thickness of 0.8 mm chemically strengthened in a KNO₃ molten salt solution at 410° C.) achieved a CS/E ratio of greater than or equal to 16.0 MPa/GPa. Further, as shown in FIGS. 11-12, the glass-based articles of the present disclosure can achieve lower parallel plate distances (e.g., twice the effective bend radius) than known articles, and the glass-based articles of present disclosure can unexpectedly tolerate larger flaws than known articles while still achieving lower parallel plate distances (e.g., twice the effective bend radius).

Embodiments of the present disclosure can be further understood in view of the following additional information.

The compositions reported in Table 1 herein each exhibit an R value that is greater than or equal to 0.665, with the R value being computed as

$$R = \frac{( 2.003 * {SiO}_{2} ) + ( 56.649 * {Al}_{2} {O}_{3} ) + ( 22.146 * MgO ) + ( 16.751 * {Na}_{2} O )}{1143.675 + ( 5.225 * {SiO}_{2} ) + ( 17.15 * {Al}_{2} {O}_{3} ) + ( 19.375 * MgO ) + ( 26.65 * CaO ) + ( 7.425 * {K}_{2} O )}$$

where each component refers to a concentration in mol % of the represented constituent on an oxide basis (i.e., in the equation for the R value, “SiO₂” represents a concentration of SiO₂ in mol %). The R value quantifies the manufacturability of a given glass composition into a glass-based article that can exhibit the favorable foldability characteristics described herein. The R value of a glass composition has been found to be inversely proportional to a minimum parallel plate distance that a glass-based article formed via the methods described herein can exhibit, when holding other factors (e.g., flaw size, strengthening treatment, thickness) constant. That is, a first glass-based article with a higher R value than a second glass-based article will generally exhibit a smaller minimum plate distance than a second glass-based article if the first and second glass-based articles are formed to have similar thicknesses, undergo the same ion exchange strengthening treatments, and comprise comparable flaw populations. The compositions reported in Table 1 herein each exhibit an R value that is greater than 0.70. Indeed, each of the compositions 1-25, 31-34, 37-45, 47-48, and 50-67 identified herein that provided a relatively high CS/E ratio of greater than or equal to 16 MPa/GPa also exhibited an R-value greater than 0.72. It is believed that glass compositions can exhibit an R value as high as 0.9 while exhibiting the favorable combination of characteristics described herein. Accordingly, glass compositions can exhibit an R value of 0.665, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, and any number between such values, or within any range with any two of the preceding values serving as inclusive endpoints (e.g., greater than or equal to 0.665 and less than or equal to 0.9, greater than or equal to 0.71 and less than or equal to 0.85, greater than or equal to 0.75 and less than or equal to 0.9, etc.). Lower R values (e.g., from 0.60 to 0.664) may be suitable, provided that SiO₂ is present in the composition in an amount that is at least 61 mol % and Na₂O is present in an mount that is at least 16 mol %.

The compositions described herein may include a limited amount of B₂O₃ while providing the favorable foldability characteristics described herein. In aspects, the compositions may include up to 2 mol % B₂O₃ without overly inhibiting the ion exchange performance of the glass-based articles described herein. Including more than 2 mol % of B₂O₃ may also lead to issues in manufacturing glass-based articles due to its volatility. As such, the glass compositions described herein can include B₂O₃ in an amount that is equal to 0.0 mol %, 0.1 mol %, 0.2 mol %, 0.3 mol %, 0.4 mol %, 0.5 mol %, 0.6 mol %, 0.7 mol %, 0.8 mol %, 0.9 mol %, 1.0 mol %, 1.1 mol %, 1.2 mol %, 1.3 mol %, 1.4 mol %, 1.5 mol %, 1.6 mol %, 1.7 mol %, 1.8 mol %, 1.9 mol %, 2.0 mol %, and any number between such values, or within any range with any two of the preceding values serving as inclusive endpoints (e.g., greater than or equal to 0.0 mol % and less than or equal to 2.0 mol %, greater than or equal to 0.9 mol % and less than or equal to 1.1 mol %, etc.).

The compositions described herein may include a limited amount of P₂O₅ while providing the favorable foldability characteristics described herein. In aspects, the compositions may include up to 2.5 mol % P₂O₅. While additions of P₂O₅ can increase the rate at which a glass-based substrate is ion exchanged, P₂O₅ may generally reduce a maximum CS achieved in a glass-based article for a given strengthening treatment, potentially adversely effecting foldability performance. Moreover, P₂O₅ in excess amounts may cause manufacturing issues due to its volatility and corrosiveness. Accordingly, the amount of P₂O₅ may be limited, and the glass compositions described herein can include P₂O₅ in an amount that is equal to 0.0 mol %, 0.1 mol %, 0.2 mol %, 0.3 mol %, 0.4 mol %, 0.5 mol %, 0.6 mol %, 0.7 mol %, 0.8 mol %, 0.9 mol %, 1.0 mol %, 1.1 mol %, 1.2 mol %, 1.3 mol %, 1.4 mol %, 1.5 mol %, 1.6 mol %, 1.7 mol %, 1.8 mol %, 1.9 mol %, 2.0 mol %, 2.1 mol %, 2.2 mol %, 2.3 mol %, 2.4 mol %, 2.5 mol % and any number between such values, or within any range with any two of the preceding values serving as inclusive endpoints (e.g., greater than or equal to 0.0 mol % and less than or equal to 2.5 mol %, greater than or equal to 0.9 mol % and less than or equal to 1.1 mol %, etc.).

Should B₂O₃ and P₂O₅ be included in glass compositions described herein, the combined amount of B₂O₃ and P₂O₅ should be limited to avoid overly inhibiting ion exchange performance. In aspects, the glass compositions described herein may include a combined amount of P₂O₅ and B₂O₃ that is less than or equal to 2.5 mol %. As such, the glass compositions described herein can include a combined amount of P₂O₅ and B₂O₃ that is equal to 0.0 mol %, 0.1 mol %, 0.2 mol %, 0.3 mol %, 0.4 mol %, 0.5 mol %, 0.6 mol %, 0.7 mol %, 0.8 mol %, 0.9 mol %, 1.0 mol %, 1.1 mol %, 1.2 mol %, 1.3 mol %, 1.4 mol %, 1.5 mol %, 1.6 mol %, 1.7 mol %, 1.8 mol %, 1.9 mol %, 2.0 mol %, 2.1 mol %, 2.2 mol %, 2.3 mol %, 2.4 mol %, 2.5 mol % and any number between such values, or within any range with any two of the preceding values serving as inclusive endpoints (e.g., greater than or equal to 0.0 mol % and less than or equal to 0.4 mol %, greater than or equal to 0.9 mol % and less than or equal to 1.1 mol %, etc.). In a preferred aspect, the compositions described herein may include less than or equal to 0.1 mol % of each of B₂O₃ and P₂O₅, such that, in compositions according to this preferred aspect, neither of P₂O₅ and B₂O₃ are present in an amount that is greater than or equal to 0.1 mol %.

With reference to the example compositions reported in Table 1 herein, it is believed that small amounts of Al₂O₃ can be replaced with at least one of B₂O₃ and ZrO₂ without significantly effecting the performance of resultant glass-based articles. As such, any of the ranges for Al₂O₃ of a composition provided herein can be replaced with a combined amount of B₂O₃, Al₂O₃ and ZrO₂, provided that Al₂O₃ makes up a substantial portion (at least 80%) of the combined amount. In aspects, the compositions described herein may contain a combined amount of B₂O₃, ZrO₂ and Al₂O₃ as low as 10.5 mol % and still provide favorable foldability performance, provided that an R value of at least 0.60 is maintained and ZrO₂ is contained in an amount that is less than or equal to 2 mol %). As such, in aspects, the composition can comprise a combined amount of B₂O₃, ZrO₂, and Al₂O₃ in a range from greater than or equal to 10.5 mol % and less than or equal to 19.5 mol %, greater than or equal to 13.5 mol % to less than or equal to 19 mol %, from greater than or equal to 13.5 mol % to less than or equal to 18.5 mol %, from greater than or equal to 14 mol % to less than or equal to 18 mol %, from greater than or equal to 14.5 mol % to less than or equal to 17.5 mol %, from greater than or equal to 15 mol % to less than or equal to 17 mol %, from greater than or equal to 15.5 mol % to less than or equal to 16.5 mol %, or any range or subrange therebetween.

All compositional components, relationships, and ratios described in this specification are provided in mol % unless otherwise stated. All ranges disclosed in this specification include any and all ranges and subranges encompassed by the broadly disclosed ranges whether or not explicitly stated before or after a range is disclosed. Also, it is to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. While various features, elements, or steps of particular aspects may be disclosed using the transitional phrase “comprising,” it is to be understood that alternative aspects, including those that may be described using the transitional phrases “consisting” or “consisting essentially of,” are implied. As used herein, the terms “comprising” and “including”, and variations thereof shall be construed as synonymous and open-ended unless otherwise indicated. The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A glass composition comprising:
SiO₂;
Al₂O₃;
from greater than or equal to 0 mol % to 3.1 mol % Li₂O;
from greater than or equal to 14 mol % to less than or equal to 18.5 mol % Na₂O;
from greater than or equal to 2.0 mol % to less than or equal to 5.0 mol % MgO;
from greater than or equal to 0 mol % to 0.5 mol % CaO;
from greater than or equal to 0 mol % to 2 mol % B₂O₃
from greater than or equal to 0 to 2.5 mol % P₂O₅; and
a combined amount of P₂O₅ and B₂O₃ that is less than or equal to 2.5 mol %,
wherein an R value of the composition is greater than or equal to 0.665, the R value being computed as
$$R = \frac{( 2.003 * {SiO}_{2} ) + ( 56.649 * {Al}_{2} {O}_{3} ) + ( 22.146 * MgO ) + ( 16.751 * {Na}_{2} O )}{1143.675 + ( 5.225 * {SiO}_{2} ) + ( 17.15 * {Al}_{2} {O}_{3} ) + ( 19.375 * MgO ) + ( 26.65 * CaO ) + ( 7.425 * {K}_{2} O )}$$
where each component refers to a concentration in mol % of the constituent on an oxide basis.

2. The glass composition of claim 1, further comprising a combined amount of B₂O₃, Al₂O₃ and ZrO₂ that is greater than or equal to 10.5 mol % and less than or equal to 19 mol %.

3. The glass composition of claim 1, wherein Al₂O₃ is present in an amount that is greater than or equal to 13.5 mol % and less than or equal to 19 mol %.

4. The glass composition of claim 1, wherein the R value is greater than or equal to 0.71.

5. The glass composition of claim 4, wherein the R value is greater than or equal to 0.75 and less than or equal to 0.9.

6. The glass composition of claim 1, wherein SiO₂ is present in an amount that is greater than or equal to 60 mol % and less than or equal to 65 mol %.

7. The glass composition of claim 1, wherein the combined amount of P₂O₅ and B₂O₃ that is less than or equal to 0.4 mol %.

8. The glass composition of claim 1, wherein neither of P₂O₅ and B₂O₃ are present in an amount that is greater than or equal to 0.1 mol %.

9. A glass-based article comprising a composition comprising, based on 100 mol % of the glass-based article:
from greater than or equal to 60 mol % to less than or equal to 65 mol % SiO₂;
from greater than or equal to 13.5 mol % to less than or equal to 19 mol % Al₂O₃;
from greater than or equal to 0 mol % to 3.1 mol % Li₂O;
from greater than or equal to 14 mol % to less than or equal to 18.5 mol % Na₂O;
from greater than or equal to 2.0 mol % to less than or equal to 5.0 mol % MgO; and
from greater than or equal to 0 mol % to 0.5 mol % CaO.

10. The glass-based article of claim 9, wherein the composition comprises R₂O+RO—Al₂O₃>2.0 mol %, where R₂O is a total amount of Li₂O, Na₂O, K₂O, Rb₂O, and Cs₂O, and RO is a total amount of MgO, CaO, BaO, and SrO, wherein the composition comprises Al₂O₃+RO≥16.0 mol %, where RO is a total amount of MgO, CaO, BaO, and SrO.

11. The glass-based article of claim 9, wherein 16.5 mol %≤Al₂O₃+RO≤22.1 mol %.

12. The glass-based article of claim 9, wherein the composition comprises:
from greater than or equal to 14.0 mol % to less than or equal to 18.0 mol % Al₂O₃; and
from greater than or equal to 0 mol % to less than or equal to 0.5 mol % K₂O.

13. The glass-based article of claim 9, wherein the composition comprises:
from greater than or equal to 62 mol % to less than or equal to 64.5 mol % SiO₂.

14. The glass-based article of claim 9, wherein the composition comprises from greater than or equal to 17.5 mol % to less than or equal to 19.0 mol % R₂O, where R₂O is a total amount of Li₂O, Na₂O, K₂O, Rb₂O, and Cs₂O.

15. The glass-based article of claim 9, wherein the composition is substantially free of BaO, SrO, ZnO, B₂O₃, and P₂O₅.

16. A consumer electronic product, comprising:
a housing comprising a front surface, a back surface, and a side surface;
electrical components at least partially within the housing, the electrical components comprising a controller, a memory, and a display, the display at or adjacent the front surface of the housing; and
a cover substrate disposed over the display,
wherein at least one of a portion of the housing comprises a glass-based article according to claim 9.

17. A glass-based article comprising:
a first compressive stress region extending to a first depth of compressive from a first major surface, the first compressive stress region comprising a first maximum compressive stress greater than or equal to 800 MegaPascals; and
an elastic modulus less than or equal to 80 GigaPascals,
wherein a CS/E ratio of the first maximum compressive stress (in MegaPascals) to the elastic modulus (in GigaPascals) is greater than or equal to 16.0.

18. The glass-based article of claim 17, further comprising a first depth of layer of an alkali metal ion associated with the first compressive stress region is from greater than or equal to 20 micrometers to less than or equal to 50 micrometers, wherein the first maximum compressive stress is from greater than or equal to 1100 MegaPascals to less than or equal to 1600 MegaPascals, wherein the elastic modulus is from greater than or equal to 72.0 GigaPascals to 74.0 GigaPascals.

19. The glass-based article of claim 17, wherein the glass-based article exhibits:
a liquidus viscosity from greater than or equal to 60 kiloPoise to less than or equal to 500 kiloPoise;
a strain point temperature greater than or equal to 530° C. to less than or equal to 685° C.; and
a softening point temperature greater than or equal to 820° C. to less than or equal to 995° C.

20. The glass-based article of claim 17, comprising a composition comprising, based on 100 mol % of the glass-based article:
SiO₂;
Al₂O₃;
from greater than or equal to 0 mol % to 3.1 mol % Li₂O;
from greater than or equal to 14 mol % to less than or equal to 18.5 mol % Na₂O;
from greater than or equal to 2.0 mol % to less than or equal to 5.0 mol % MgO;
from greater than or equal to 0 mol % to 0.5 mol % CaO;
from greater than or equal to 0 mol % to 2 mol % B₂O₃
from greater than or equal to 0 to 2.5 mol % P₂O₅; and
a combined amount of P₂O₅ and B₂O₃ that is less than or equal to 2.5 mol %,
wherein an R value of the composition is greater than or equal to 0.665, the R value being computed as
$$R = \frac{( 2.003 * {SiO}_{2} ) + ( 56.649 * {Al}_{2} {O}_{3} ) + ( 22.146 * MgO ) + ( 16.751 * {Na}_{2} O )}{1143.675 + ( 5.225 * {SiO}_{2} ) + ( 17.15 * {Al}_{2} {O}_{3} ) + ( 19.375 * MgO ) + ( 26.65 * CaO ) + ( 7.425 * {K}_{2} O )}$$
where each component refers to a concentration in mol % of the constituent on an oxide basis.
